(19) United States
(12) Patent Application Publication
(10) Pub. No.: US 2026/0304240 A1
(43) Pub. Date: Oct. 1, 2026

(54) GENERATION OF A COMPLETE L1/L2-TRIGGERED MOBILITY CANDIDATE CELL CONFIGURATION

(71) Applicant: Telefonaktiebolaget LM Ericsson (publ), Stockholm (SE)

(72) Inventors: Antonino ORSINO, Kirkkonummi (FI); Icaro Leonardo DA SILVA, Solna (SE); Pontus WALLENTIN, Linköping (SE)

(73) Assignee: Telefonaktiebolaget LM Ericsson (publ), Stockholm (SE)

(21) Appl. No.: 19/474,072

(22) PCT Filed: Apr. 8, 2024
(86) PCT No.: PCT/IB2024/053432

§ 371 Date: Oct. 10, 2025

Related U.S. Application Data
(60) Provisional application No. 63/458,546, filed on Apr. 11, 2023.

(51) Int. Cl. H04W 36/00

(52) U.S. Cl. CPC H04W 36/0055

(57) ABSTRACT

A method performed by a user equipment, UE, for a L1/L2-triggered mobility, LTM, cell switch procedure including receiving LTM reference configuration and LTM candidate cell configuration. The method further includes combining the LTM reference configuration and the LTM candidate cell configuration to obtain a complete LTM candidate cell configuration for a LTM candidate cell. The method further includes receiving, from a source network node, a LTM cell switch command. The LTM cell switch command includes at least an indication of a LTM candidate cell configuration. The method further includes applying the complete LTM candidate cell configuration of the indicated LTM candidate cell configuration and sending an uplink signalling to acknowledge completion of the LTM cell switch procedure.

### TECHNICAL FIELD

The present disclosure relates generally to communications, and more particularly to communication methods and related devices and nodes supporting wireless communications.

### BACKGROUND

In 3rd Generation Partnership Project (3GPP) Release 18, a work item known as Further NR mobility enhancements has been agreed. This work item includes a technical area entitled L1/L2 based inter-cell mobility. According to the Work Item Description, WID [1], when the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

Referring to 3GPP Release 18 Further NR mobility enhancements, one objective of the work is to specify mechanism and procedures of L1/L2 based inter-cell mobility for mobility latency reduction.

### SUMMARY

Some embodiments disclosed herein are directed to a method performed by a user equipment, UE, for a L1/L2-triggered mobility, LTM, cell switch procedure. The method includes receiving LTM reference configuration and LTM candidate cell configuration. The method further includes combining the LTM reference configuration and the LTM candidate cell configuration to obtain a complete LTM candidate cell configuration for a LTM candidate cell. The method further includes receiving, from a source network node, a LTM cell switch command. The LTM cell switch command includes at least an indication of a LTM candidate cell configuration. The method further includes applying the complete LTM candidate cell configuration of the indicated LTM candidate cell configuration and sending an uplink signalling to acknowledge completion of the LTM cell switch procedure.

Some other embodiments are directed to a method performed by a source network node for initiating a L1/L2-triggered mobility, LTM, cell switch procedure at a user equipment, UE. The method includes sending a LTM reference configuration and a LTM candidate cell configuration to the UE, and sending a LTM cell switch command for initiating a LTM cell switch procedure to the UE. The LTM cell switch command includes an indication of the LTM candidate cell configuration.

Some other embodiments are directed to a method performed by a target network node for a L1/L2-triggered mobility, LTM, cell switch procedure. The method includes initiating configuration of a LTM candidate cell configuration at a user equipment, UE, through another network node. The method further includes receiving a signalling from the UE which indicates that the LTM cell switch procedure has been successfully completed and that the UE is starting to operate with the target network node according to the LTM candidate cell configuration.

Certain embodiments may provide one or more of the following technical advantage(s). The proposed embodiments may enable the UE as to when and how to generate a complete LTM candidate cell configuration to be used when an LTM cell switch procedure is triggered by the reception of an LTM cell switch command. Even if the LTM cell switch command may include an indication of a LTM candidate cell configuration, in case the UE previously received also an LTM reference configuration, the UE cannot directly use the LTM candidate cell configuration, since the UE should combine the LTM reference configuration and the LTM candidate cell configuration to generate a complete LTM candidate cell configuration. Therefore, when receiving an LTM cell switch command that includes an indication of a LTM candidate cell configuration, the UE should use the complete LTM candidate cell configuration generated from the LTM reference configuration and the LTM candidate cell configuration during the LTM cell switch procedure. This will guarantee that the LTM cell switch procedure will not fails due to a wrong LTM candidate cell configuration applied (or used) by the UE.

Other methods implemented by UEs and network nodes and corresponding UEs and networks will be or become apparent to one with skill in the art upon review of the following drawings and detailed description. It is intended that all such additional methods and corresponding UEs and network nodes be included within this description, be within the scope of the present inventive subject matter, and be protected by the accompanying claims. Moreover, it is intended that all embodiments disclosed herein can be implemented individually or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a system structure including the entities which are involved in some embodiments of inventive concepts;

FIG. 2 illustrates flow charts of operations and associated methods by a UE according to some embodiments;

FIG. 3 illustrates flow charts of operations and associated methods by a source network node according to some embodiments;

FIG. 4 illustrates flow charts of operations and associated methods by a target network node according to some embodiments;

FIG. 5 illustrates the corresponding FIG. 5.3.5.1-1 from 3GPP TS 38.331 V17.4.0 (2023-03) exhibiting RRC reconfiguration, successful;

FIG. 6 illustrates the corresponding FIG. 5.3.5.1-2 from 3GPP TS 38.331 V17.4.0 (2023-03) exhibiting RRC reconfiguration, failure;

FIG. 7 illustrates an example of a communication system in accordance with some embodiments;

FIG. 8 illustrates a UE in accordance with some embodiments of inventive concepts;

FIG. 9 illustrates a network node in accordance with some embodiments;

FIG. 10 is a block diagram of a host, which may be an embodiment of the host of FIG. 7, in accordance with some embodiments;

FIG. 11 is a block diagram illustrating a virtualization environment in which functions implemented by some embodiments may be virtualized; and

FIG. 12 illustrates a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Further to the above description, configuration and maintenance for multiple candidate cells to allow fast application of configurations for candidate cells [RAN2, RAN3] is defined. Additionally, dynamic switch mechanism among candidate serving cells (including SpCell and SCell) for the potential applicable scenarios based on L1/L2 signalling [RAN2, RAN1], is defined. Additionally, L1 enhancements for inter-cell beam management, including L1 measurement and reporting, and beam indication [RAN1, RAN2]. It is noted that early RAN2 involvement is necessary, including the possibility of further clarifying the interaction between this with the previous statement. Additionally, Timing Advance management [RAN1, RAN2] is defined. Additionally, CU-DU interface signaling to support L1/L2 mobility, if needed [RAN3], is defined.

It is also noted that frequency range 2 (FR2) specific enhancements are not precluded, if any.

It is also noted that the procedure of L1/L2 based inter-cell mobility are applicable to the following scenarios: standalone, CA and NR-DC case with serving cell change within one CG; intra-DU case and intra-CU inter-DU case (applicable for Standalone and CA: no new RAN interfaces are expected); both intra-frequency and inter-frequency; both frequency range 1 (FR1) and FR2; and source and target cells may be synchronized or non-synchronized.

In 3GPP, discussions have started on solutions for L1/L2 based inter-cell mobility (sometimes also referred to as LTM, L1/L2-triggered mobility or lower layer-triggered mobility.

A basic principle with L1/L2-triggered mobility (LTM) is that the UE is pre-configured, by the network, with an RRC configuration per LTM candidate cell, sometimes also known as a LTM candidate cell configuration. Such a LTM candidate cell configuration may be an RRCReconfiguration message (e.g. delta signaling associated to a reference configuration or the UE's current configuration) or one or more IEs/fields/parameters such as CellGroupConfig. The UE performs L1 measurements (e.g. CSI measurements, such as SS-RSRP, L1 RSRP per SSB) on these LTM candidate cells and transmits corresponding L1 measurement reports to the network (e.g. on PUCCH and/or PUSCH). The network then triggers the execution of a LTM cell switch in the UE to one of these LTM candidate cells by transmitting an LTM cell switch command (such as a MAC CE), to the UE, which then connects to the particular LTM candidate cell and switches to an RRC configuration of this LTM candidate cell.

There currently exist certain challenge(s). Many details of the procedures for L1/L2-based inter-cell mobility are still open in 3GPP. This applies also for the details of the so called LTM cell switch procedure. So far RAN2 has concluded that the UE, when configured with LTM, receives from the network at least a LTM candidate cell configuration. Further, when the LTM is executed, the UE receives a LTM cell switch command in the form of a MAC Control Element, MAC CE, and triggers the LTM cell switch procedure. This command contains also the necessary information for the UE to perform the cell switch, including an indication of an LTM candidate cell configuration.

Certain aspects of the disclosure and their embodiments may provide solutions to these or other challenges. Related to this, RAN2 has also agreed that, during the configuration of LTM, the UE may receive an LTM reference configuration and an LTM candidate cell configuration. In this case, in order to obtain a complete LTM candidate cell configuration the UE should apply the LTM candidate cell configuration on top of the LTM reference configuration.

One problem that is not yet specified is how in practice the UE should generate a complete LTM candidate cell configuration. It not known what are the UE actions when the UE needs to apply the LTM candidate cell configuration on top of the LTM reference configuration.

In order to address the above challenges, various embodiments of the present disclosure are directed to methods and corresponding operations for a User Equipment (UE), to perform a LTM cell switch procedure. The methods and operations include receiving at least one LTM reference configuration, and at least one LTM candidate cell configuration, and further combining the LTM reference configuration and the LTM candidate cell configuration to obtain a complete LTM candidate cell configuration for a LTM candidate cell. The methods and operations further include receiving from a source network node a LTM cell switch command (e.g. a MAC CE), including an indication of a LTM candidate cell configuration and applying (or start using, switching to) the complete LTM candidate cell configuration of the indicated LTM candidate cell configuration and in response sending an uplink signalling to acknowledge the completion of the LTM cell switch procedure.

In some embodiments, the UE generates a complete LTM candidate cell configuration, by the UE first processing the received LTM reference configuration and then applying on top (to the output of the processing) the received LTM candidate cell configuration.

In some embodiments, the UE generates a complete LTM candidate cell configuration, the UE processes the LTM reference configuration and LTM candidate cell configuration at the same time (e.g., concurrent processing) and performs operations such as ADDITION, INTERSECT, SUBTRACTION, DIVISION in order to combine the LTM reference configuration and LTM candidate cell configuration.

In some embodiments, the UE generates a complete LTM candidate cell configuration when receiving a LTM reference configuration and LTM candidate cell configuration. For example, the UE generate the complete LTM candidate cell configuration during the configuration of LTM.

In some embodiments, the UE generates a complete LTM candidate cell configuration when an LTM cell switch procedure is triggered by the reception of an LTM cell switch command comprising an indication of which LTM candidate cell configuration to use.

Certain embodiments may provide one or more of the following technical advantage(s). The proposed embodiments enable the UE when and how to generate a complete LTM candidate cell configuration to be used when an LTM cell switch procedure is triggered by the reception of an LTM cell switch command. Even if the LTM cell switch command may include an indication of a LTM candidate cell configuration, in case the UE previously received also an LTM reference configuration, the UE cannot directly use the LTM candidate cell configuration, since the UE should combine the LTM reference configuration and the LTM candidate cell configuration to generate a complete LTM candidate cell configuration. Therefore, when receiving an LTM cell switch command that includes an indication of a LTM candidate cell configuration, the UE should use the complete LTM candidate cell configuration generated from the LTM reference configuration and the LTM candidate cell configuration during the LTM cell switch procedure. This will guarantee that the LTM cell switch procedure will not fails due to a wrong LTM candidate cell configuration applied (or used) by the UE.

Some of the embodiments according to inventive concepts are now described more fully with reference to the accompanying drawings. Embodiments are provided by way of example to convey the scope of the subject matter to those skilled in the art. Additional information may also be found in the document provided in the Appendix.

The present disclosure refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle is that the UE receives a lower layer signaling from the network indicating to the UE a change (or switch or activation) of its serving cell (e.g. change of PCell, from a source to a target PCell), wherein a lower layer signaling is a message/signaling of a lower layer protocol, which may be referred as a L1/L2 inter-cell mobility execution command or LTM cell switch command. The change of serving cell (e.g. change of PCell) may also lead to a change in Scell(s) for the same cell group e.g. in case the command triggers the UE to change to another cell group configuration of the same type (e.g. another MCG configuration). Before the UE receives the LTM cell switch command, the UE is configured by the network with one or more LTM candidate cell configurations (e.g. reception of an RRC Reconfiguration message, with at least one LTM candidate cell configuration) A LTM candidate cell configuration may include parameters in the IE CellGroupConfig for an LTM candidate cell and/or an embedded RRC Reconfiguration for an LTM candidate cell.

The term LTM cell switch procedure refers to the process of a UE switching (or changing) its cell from a source cell to a target cell (which may be called here an LTM candidate cell or a neighbour cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of some embodiments, switching to the LTM candidate cell configuration comprises the UE considering that an LTM candidate cell becomes its new special cell (SpCell) e.g. PCell in case of LTM being configured for a Master Cell Group (MCG) and/or PSCell in case of LTM being configured for a Secondary Cell Group (SCG); or, changing its SpCell from the current PCell to an LTM candidate cell.

Even if the term switch or change of cells is used, that may comprise a switch or change of a whole cell group configuration, which includes a change in the SpCell (e.g. change of PCell, or change of PSCell) and a change in SCells of the cell group (e.g. addition, modification and/or release of one or more SCells).

The text refers to a LTM candidate cell, which is a cell the UE is configured with when configured with L1/L2-triggered mobility. That is a cell the UE can move to in a LTM cell switch procedure, upon reception of a LTM cell switch command. Such cells may also be called candidate cell(s), candidates, mobility candidates, non-serving cells, additional cells, target candidate cell, target candidate, etc. A LTM candidate cell is a cell the UE may perform measurements on (e.g. CSI measurements) so that the UE reports these measurements and network may take educated decision on which beam (e.g. TCI state) and/or cell the UE is to be switched to. An LTM candidate cell may be a candidate to be a target PCell or PSCell, or an SCell of a cell group (e.g. MCG SCell or a SCG SCell).

The text refers to at least one LTM candidate cell configuration and that the UE has received at least one LTM candidate cell configuration. This is also sometimes referred to as a configuration of a LTM candidate cell, which may be an RRC configuration, such as encapsulated in an RRC Reconfiguration message, that the UE receives when being configured with L1/L2-Triggered Mobility. A LTM candidate cell configuration comprises the configuration which the UE needs to start to operate accordingly when it performs an LTM cell switch procedure to that LTM candidate cell e.g. upon reception of the LTM cell switch command to that LTM candidate cell, which becomes the target cell and the current (new) SpCell, or an SCell in a serving frequency. The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig, in the case of a Secondary Cell). A LTM candidate cell configuration may in one example comprise one or more of: i) the PCell configuration and one or more SCell configuration(s) of a Master Cell Group (MCG); i) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably when referring to LTM candidate cell configuration.

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration identifier, identity or index (sometimes also denoted candidate configuration ID). The UE may be configured with multiple LTM candidate cell configurations, so a Candidate DU (C-DU) generates and sends to the CU multiple configuration(s). The actual LTM candidate cell configuration the UE receives during the LTM configuration may be a delta signaling to be applied on top of a reference configuration, so that the actual configuration the UE is to use in the LTM candidate cell upon LTM cell switch is the combination of the LTM candidate cell configuration and the reference configuration (e.g. separately signaled by the network to the UE). That combination of the LTM candidate cell configuration and the reference configuration the UE uses may also be called a complete LTM candidate cell configuration. For the context of disclosed embodiments, unless stated otherwise, this complete LTM candidate cell configuration may also be considered as an LTM candidate cell configuration.

The term “beam” may correspond to a spatial direction in which a signal is transmitted (e.g. by a network node) or received (e.g. by the UE), or a spatial filter applied to a signal which is transmitted or received. Thus, transmitting signals different beams could correspond to transmitting signals in different spatial directions. When the text refers to a “beam which is selected” it may refer to a beam index and/or a Reference Signal (RS) index or identifier, such as a Synchronization Signal block (SSB) index, or a CSI-RS resource identifier. Thus, selecting a beam may correspond to selecting an SSB, associated to an SSB index. Or, selecting a beam may correspond to selecting a CSI-RS, associated to a CSI-RS resource identifier.

In the text the term “apply X on top of Y”. This is an action where the UE applies first a configuration (e.g., a LTM reference configuration) that is common for all the LTM candidate cell configured and then applies a second configuration (e.g., a LTM candidate cell configuration) as a delta of this first configuration.

The text refers also to a complete LTM candidate cell configuration. This is a configuration that is obtained by the combination of a first configuration (e.g., a LTM reference configuration) and a second configuration (e.g., a LTM candidate cell configuration). The complete LTM candidate cell configuration is the final configuration that the UE should apply and use when performing an LTM cell switch procedure towards a LTM target candidate cell. Please note that the LTM reference configuration or the LTM candidate cell configuration may not be enough for the UE to operate in the LTM target candidate cell.

The text refers also to a partial complete LTM candidate cell configuration. This may be a configuration that is an intermediate result of what will eventually become a complete LTM candidate cell configuration. For example it may contain only a LTM reference configuration, a subset of the protocol entities, and ASN.1 structures/fields/information elements for each layer of the protocol stack (e.g., a MAC, RLC, PDCP, RRC entity) which will be included in a final complete LTM candidate cell configuration. In some cases a partial complete LTM candidate cell configuration may contain protocol entities, and ASN.1 structures/fields/information elements for each layer of the protocol stack (e.g., a MAC, RLC, PDCP, RRC entity) which are present but empty (e.g. not configured), absent or present but partially configured.

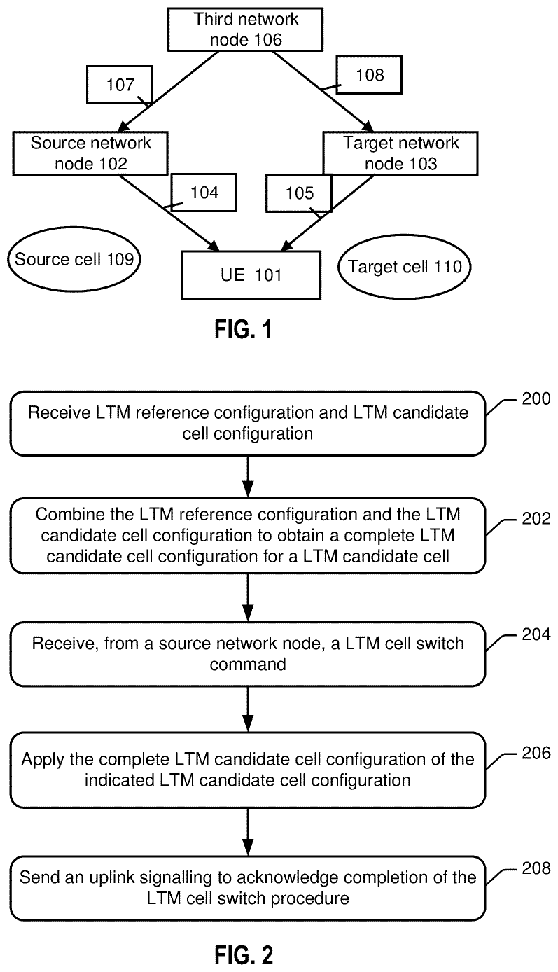

FIG. 1 illustrates a system structure including the entities which are involved in some embodiments. The User Equipment (UE) 101 is a wireless terminal, such as a cellular smartphone, sometimes connected to the source network node 102 over a wireless interface 104 and sometimes connected to a target network node 103, to which the UE 101 is connected over a wireless interface 105.

In the context of a mobility procedure, such as a LTM cell switch procedure, for the UE, the source network node 102, sometimes also referred to as the serving network node, controls a source cell 109 (sometimes called serving cell or Special Cell (SpCell). The target network node 103 controls a target cell 110 (sometimes called neighbour cell, candidate cell or LTM candidate cell). Each of source network node 102 and the target network node 103 may be a base station such as e.g. gNB, or, e.g. in case of a distributed CU/DU (centralized unit/distributed unit) RAN architecture, a distributed unit, sometimes known as either gNB-DU or DU. Hence the source network node 1002 corresponds to a source DU, S-DU, sometimes also known as serving DU, and the target network node 103 corresponds to a target DU. T-DU (sometimes called neighbour DU or candidate DU, C-DU). Both the source network node 102 and the target network node 103 are connected to a third network node 106, sometime also referred to as serving network node. The source network node and the target network node may be the same network node. In some scenarios the source network node 102 and the target network node 103 may be connected to different third network nodes 106.

Further, the third network node 106 may, e.g. in case of a distributed CU/DU RAN architecture, be a central unit (CU) sometimes referred to as the serving CU, known as either a gNB-CU, CU, gNB-CU-CP or gNB-CU-UP, or a core network node such as an User Plane Function, UPF or an Access and Mobility management Function, AMF.

Methods for a user equipment, UE, to perform a LTM cell switch procedure, comprise receiving an LTM reference configuration, and an LTM candidate cell configuration. More than one LTM reference configuration and more than one LTM candidate cell configuration may be received and used for obtaining the complete LTM candidate cell configuration. For brevity, the term “LTM reference configuration” may include more than one LTM reference configuration. Similarly, the term “LTM candidate cell configuration” may include more than one LTM candidate cell configuration. The method further combines an LTM reference configuration and a LTM candidate cell configuration to obtain a complete LTM candidate cell configuration for a LTM candidate cell, further receiving from a source network node a LTM cell switch command (e.g. a MAC CE), including an indication of a LTM candidate cell configuration and apply (or start using, switching to) the complete LTM candidate cell configuration of the indicated LTM candidate cell configuration and in response sending an uplink signalling to acknowledge the completion of the LTM cell switch procedure. It is noted that the step of applying the complete LTM candidate cell configuration and/or the step of sending of the uplink signalling may be optional steps for the broadest embodiment related to the UE operations and methods.

FIG. 2 illustrates flow charts of operations and associated methods by a UE according to some embodiments of inventive concepts.

An example embodiment, based on the above, includes a method performed by a UE for a LTM cell switch procedure. The method includes receiving 200 LTM reference configuration and LTM candidate cell configuration. The method also includes combining 202 the LTM reference configuration and the LTM candidate cell configuration to obtain a complete LTM candidate cell configuration for a LTM candidate cell. The method also includes receiving 204, from a source network node, a LTM cell switch command, wherein the LTM cell switch command comprise at least an indication of a LTM candidate cell configuration. The method also includes applying 206 the complete LTM candidate cell configuration of the indicated LTM candidate cell configuration. The method also includes sending 208 an uplink signalling to acknowledge completion of the LTM cell switch procedure.

In some embodiments, the UE generates the complete LTM candidate cell configuration upon the reception of the LTM reference configuration and the LTM candidate cell configuration from the source network node.

In an example embodiment, based on the above, the combining 202 the LTM reference configuration and the LTM candidate cell configuration to obtain a complete LTM candidate cell configuration for a LTM candidate cell includes generating the complete LTM candidate cell configuration responsive to the reception of one of LTM reference configuration and the at least one LTM candidate cell configuration from the source network node following earlier reception of the other one of the LTM reference configuration and the at least one LTM candidate cell configuration from the source network node.

In one example the UE generates the complete LTM candidate cell configuration when receiving an LTM candidate cell configuration. This means that the UE will not process an LTM reference configuration until it receives an LTM candidate cell configuration (the reception of the LTM candidate cell configuration is the trigger for the generation of the complete LTM candidate cell configuration.

In one example the UE process and store in its memory first the LTM reference configuration (regardless of if at least one LTM candidate cell configuration has been received or not) and when receiving an LTM candidate cell configuration starts the process to generate a complete LTM candidate cell configuration. Here when the UE process and store first the LTM reference configuration it create a sort of “template” that is common to all the received LTM candidate cell configurations.

In some embodiments, the UE generates the complete LTM candidate cell configuration upon the reception of an LTM cell switch command by the source network node.

In an example embodiment, based on the above, the combining 202 the LTM reference configuration and the LTM candidate cell configuration to obtain a complete LTM candidate cell configuration for a LTM candidate cell includes generating the complete LTM candidate cell configuration responsive to the reception of the LTM cell switch command from the source network node.

In one example the UE start to process and combine the LTM reference configuration and the LTM candidate cell configuration to generate a complete LTM candidate cell configuration only when an LTM cell switch command is received by the source node.

In one example the UE process and store in its memory first the LTM reference configuration (regardless of if at least one LTM candidate cell configuration has been received or not) when this is received, but it process the LTM candidate cell configuration to generate a complete LTM candidate cell configuration only when an LTM cell switch command is received by the source node.

In some embodiments, the UE generates the complete LTM candidate cell configuration, by applying the LTM candidate cell configuration on top of the LTM reference configuration according to one or more of the following.

First, the UE may generate the complete LTM candidate cell configuration by performing a set of actions that are common for the LTM reference configuration and the LTM candidate cell configuration. One example of this is for the UE to execute only one time the actions as specified in clause 5.3.5.3 of 3GPP TS 38.331 V17.4.0 (2023-03). In one example, the UE actions are different in case the UE is processing the LTM reference configuration and the LTM candidate cell configuration. This can be achieved, for instance, by clarify in clause 5.3.5.3 of 3GPP TS 38.331 V17.4.0 (2023-03). which UE actions apply to the case when the LTM reference configuration is processed and when the LTM candidate cell configuration is processed.

Second, the UE may generate the complete LTM candidate cell configuration by performing a set of actions that are separate for the LTM reference configuration and the LTM candidate cell configuration. For example, the set of actions performed for the LTM reference configuration may be different from another set of actions performed for the LTM candidate cell configuration. One example of this is for the UE to execute the actions as specified in clause 5.3.5.3 of 3GPP TS 38.331 V17.4.0 (2023-03) independently for the LTM reference configuration and the LTM candidate cell configuration.

Third, the UE may generate the complete LTM candidate cell configuration by performing a set of actions where how to process and combine the LTM reference configuration and the LTM candidate cell configuration in order to generate a complete LTM candidate cell configuration is left to the UE implementation.

Fourth, the UE may generate the complete LTM candidate cell configuration by performing a set of actions for the LTM reference configuration and the LTM candidate cell configuration according to a rule or guideline stating how to handle the ASN.1 structures/fields/information elements in the LTM reference configuration and the LTM candidate cell configuration.

In one example, a rule or guideline may state whether to use the value of an ASN.1 structure/field/information element in the LTM reference configuration or the value in the corresponding ASN.1 structure/field/information element in the LTM candidate cell configuration.

In one example, a rule or guideline may state to use an operation on the value of an ASN.1 structure/field/information element in the LTM reference configuration and/or the value in the corresponding ASN.1 structure/field/information element in the LTM candidate cell configuration. For example, operation may be ADDITION, INTERSECT, SUBTRACTION, DIVISION, MULTIPLICATION, LOGICAL AND, LOGICAL OR, LOGICAL XOR, CONCATENATION, REPLACEMENT.

In one example, a rule or guideline may state how to handle a certain type of an ASN.1 structure/field/information element in the LTM reference configuration and the LTM candidate cell configuration. For example, a type may be one of SEQUENCE, SetupRelease, ToAddModList, ToReleaseList, lists, ENUMERATED, CHOICE, OCTET STRING, INTEGER, BOOLEAN, BIT STRING. For example, how to handle may be to append, concatenate, combine, remove or replace involving individual substructures, subfields/elements part of an ASN.1 structure/field/information element in the LTM reference configuration and individual elements part of an the corresponding ASN.1 structure/field/information element in the LTM candidate cell configuration. For example, when these individual substructures, subfields/elements part of an ASN.1 structure/field/information element are part of lists. For example, how to handle may be in which order to perform a certain operation involving both an ASN.1 structure/field/information element in the LTM reference configuration and the corresponding ASN.1 structure/field/information element in the LTM candidate cell configuration.

In one example, a rule or guideline may state how to handle a certain value of an ASN.1 structure/field/information element in the LTM reference configuration and the LTM candidate cell configuration.

In one example, a rule or guideline may state how to handle presence of an ASN.1 structure/field/information element in the LTM reference configuration and the LTM candidate cell configuration. For example, presence may be absent/present, optional presence, conditional presence. For example, how to handle an optional ASN.1 structure/field/information element when it is absent in the LTM reference configuration and the corresponding ASN.1 structure/field/information element is present in the LTM candidate cell configuration or vice versa. For example, how to handle a conditional ASN.1 structure/field/information element when it is absent in the LTM reference configuration and the corresponding ASN.1 structure/field/information element is present in the LTM candidate cell configuration or vice versa.

In one example, a rule or guideline may state how to handle certain Need codes of an ASN.1 structure/field/information element in the LTM reference configuration and the LTM candidate cell configuration. For example, a Need code may be Specified (S), Maintain (M), No action (N), Release (R). For example, how to handle an ASN.1 structure/field/information element with certain Need code when it is absent in the LTM reference configuration and when the corresponding ASN.1 structure/field/information element is present in the LTM candidate cell configuration or vice versa.

In one example, a rule or guideline may state how to handle conditions of an ASN.1 structure/field/information element in the LTM reference configuration and the LTM candidate cell configuration.

In one example, a rule or guideline may state how to handle extensions of an ASN.1 structure/field/information element in the LTM reference configuration and the LTM candidate cell configuration.

In an example embodiment, based on the above, the combining 202 the LTM reference configuration and the LTM candidate cell configuration to obtain a complete LTM candidate cell configuration for a LTM candidate cell includes applying the LTM candidate cell configuration on top of the LTM reference configuration according to one or more of the following: performing a set of actions that are common for the LTM reference configuration and the LTM candidate cell configuration; performing a set of actions that are separate for the LTM reference configuration and the LTM candidate cell configuration; and performing a set of actions for the LTM reference configuration and/or the LTM candidate cell configuration according to a rule or guideline defining handling of ASN.1 structures, fields, or information elements in the LTM reference configuration and the LTM candidate cell configuration.

In the previous example embodiment, the performing a set of actions for the LTM reference configuration and the LTM candidate cell configuration according to a rule or guideline defining handling of ASN.1 structures, fields, or information elements in the LTM reference configuration and the LTM candidate cell configuration, comprises determining from the rule or guideline at least one of: an operation to use on a value of the ASN.1 structure, field, or information element in the LTM reference configuration and/or the LTM candidate cell configuration; an operation to use based on a type of the ASN.1 structure, field, or information element in the LTM reference configuration and/or the LTM candidate cell configuration; an order in which to perform an operation on a value of the ASN.1 structure, field, or information element in the LTM reference configuration and/or the LTM candidate cell configuration; an operation to use based on a value of the ASN.1 structure, field, or information element in the LTM reference configuration and/or the LTM candidate cell configuration; an operation to use based on presence of the ASN.1 structure, field, or information element in the LTM reference configuration and/or the LTM candidate cell configuration; and an operation to use based on a need code of the ASN.1 structure, field, or information element in the LTM reference configuration and/or the LTM candidate cell configuration.

In some embodiments, the UE prepares a partial complete LTM candidate cell configuration upon the reception of an LTM reference configuration and the LTM candidate cell configuration and upon the reception of a LTM cell switch command the UE generate a complete LTM candidate cell configuration

An example embodiment, based on the above, the method further includes preparing a part of the complete LTM candidate cell configuration based on reception of an LTM reference configuration and the LTM candidate cell configuration. The method also further includes, responsive to the reception of a LTM cell switch command, preparing the complete LTM candidate cell configuration based on the part.

In one example, when the UE receives the LTM reference configuration and the LTM candidate cell configuration, the UE processes only the LTM reference configuration and prepare placeholder for configuration to be completed upon the reception of a LTM cell switch command when also the LTM candidate cell configuration is processed.

In one case, one possible example can be that the UE when processing the LTM reference configuration create (builds, creates, constructs, sets its content) an initial configuration, protocol entities, and ASN.1 structures/fields/information elements for each layer of the protocol stack (e.g., a MAC, RLC, PDCP, RRC entity) then the final configuration of these configurations, protocol entities, and ASN.1 structures/fields/information elements is only obtained when processing the LTM candidate cell configuration (e.g., when the LTM cell switch command is received).

In one case, one possible example can be that the UE processes both the LTM reference configuration and LTM candidate cell configuration by creating configurations, protocol entities, and ASN.1 structures/fields/information elements for each layer of the protocol stack (e.g., a MAC, RLC, PDCP, RRC entity) that will be used when performing an LTM cell switch procedure. However, these configurations, protocol entities, and ASN.1 structures/fields/information only applies (or used, or configured) only upon the reception of a LTM cell switch command.

In some embodiments, the UE generates complete LTM candidate cell configuration is left to the UE implementation. Even if this is left to the UE implementation, still can be specified some high level principle such as that the UE should apply the LTM reference configuration on top of the LTM candidate cell configuration. An indication that can be captured in the specification is whether the UE should generate a complete LTM candidate cell configuration upon the reception of LTM reference configuration and the LTM candidate cell configuration or upon the reception of a LTM cell switch command.

In some embodiments, the UE receives both a LTM reference configuration and a LTM candidate cell configuration but consider the LTM candidate cell configuration as the complete LTM candidate cell configuration. In this case, the UE does not process (or apply) the received LTM reference configuration meaning that the LTM candidate cell configuration comprises all the necessary configuration to operate in a target LTM candidate cell when a LTM cell switch procedure is initiated.

An example embodiment, based on the above, the combining 202 the LTM reference configuration and the LTM candidate cell configuration to obtain a complete LTM candidate cell configuration for a LTM candidate cell includes defining the LTM candidate cell configuration as the complete LTM candidate cell configuration.

In one example, the indication on whether the LTM candidate cell configuration is a complete LTM candidate cell configuration is received by the source network node within the LTM cell switch command.

In one example, the indication on whether the LTM candidate cell configuration is a complete LTM candidate cell configuration is received by the source network node as part of the message (e.g., RRCReconfiguration message) that includes a LTM reference configuration and one or more LTM candidate cell configurations.

In one example, the indication on whether the LTM candidate cell configuration is a complete LTM candidate cell configuration is received within the LTM candidate cell configuration.

In one example, the indication on whether the LTM candidate cell configuration is a complete LTM candidate cell configuration is implicit based on the presence or absence of the LTM reference configuration. For instance, if the LTM reference configuration is present the complete LTM candidate cell configuration should be generated by applying the LTM candidate cell configuration on top of the LTM reference configuration, while if the LTM reference configuration is absent the LTM candidate cell configuration is a complete LTM candidate cell configuration. Here “absent” or “present” can also be mean that the ASN.1 field/structure/information element is “empty” (for the case of absent) or contain some information (for the case of present).

In some embodiments, upon performing a LTM cell switch procedure due to the reception of a LTM cell switch command comprising an indication of a LTM candidate cell configuration, and before the UE applies the corresponding complete LTM candidate cell configuration related to the indicated LTM candidate cell configuration, the UE performs one or more of the following actions.

First, the UE copies such configuration from its current UE configuration to the complete LTM candidate cell configuration if timers, counters, or any other configuration needs to have a continuity also in the target source node indicated within the LTM cell switch command. One example is the handling of timers and counters. In case these timers and counters should not be stopped when performing a LTM cell switch procedure, the UE takes a snapshot of these timer and counter and continue to use the current values in the target source node towards which the LTM cell switch procedure was performed. For instance, it at the time of initiating the LTM cell switch procedure Timer1=5 s and Counter1=10, after performing the LTM cell switch procedure the UE will have an initial value of Timer1=5 s and Counter1=10 when start to operate in the target source cell toward which the LTM cell switch procedure was performed. Please note that in this case the initial value of the timer may be greater than 5 s since also the time for the UE to switch from the source network node to the target network node would be to be taken into account (since the timer is still running during this period). One example is the handling of the PDCP and SDAP layer. Since one assumption of LTM is that PDCP and SDAP are not released during LTM, in such a case the UE can simply copy paste the configuration related to such entity from its current UE configuration to the complete LTM candidate cell configuration before performing an LTM cell switch procedure.

Second, the UE clears all the dedicated configuration from its current UE configuration. These are configuration received by dedicated signalling by the source network node.

Third, the UE clears all the common configuration from its current UE configuration. These are configuration received via system information (broadcast) by the source network node.

An example embodiment, based on the above, after receiving 204 the LTM cell switch command and before applying 206 the complete LTM candidate cell configuration, further comprising at least one of: copying a timer, a counter, and/or a configuration from a current UE configuration to the complete LTM candidate cell configuration; clearing in the current UE configuration, a dedicated configuration earlier received through dedicated signaling from the source network node; clearing in the current UE configuration, a common configuration earlier received through system information from the source network node; and performing an L2 reset.

Additionally, in some embodiments, upon performing a LTM cell switch procedure due to the reception of a LTM cell switch command comprising an indication of a LTM candidate cell configuration, and before the UE applies the corresponding complete LTM candidate cell configuration related to the indicated LTM candidate cell configuration, the UE performs one or more of the following actions

Fourth, the UE performs an L2 reset. Here, L2 reset may imply a MAC reset, a RLC reestablishment, or a PDCP recovery, and any combination of them.

Fifth, the UE applies a default configuration if a dedicated configuration is not present within the complete LTM candidate cell configuration. One example is the MAC entity. Let's assume that the UE has to reset the MAC entity when performing a LTM cell switch procedure but no MAC configuration is provided withing the complete LTM candidate cell configuration, in this case the UE applies the MAC default configuration as specified in 3GPP TS 38.331 V17.4.0 (2023-03).

Sixth, the UE applies the complete LTM candidate cell configuration in the target cell. For example, UE starts using the resources which are added or modified as result of applying the complete LTM candidate cell configuration. For example, UE stops using the resources which are released as result of applying the complete LTM candidate cell configuration.

Seventh, the UE sends an UL signalling to the target network node to acknowledge that the LTM cell switch procedure was successfully completed.

An example embodiment, based on the above, after receiving 204 the LTM cell switch command and before applying 206 the complete LTM candidate cell configuration, further comprising at least one of: applying a default configuration if a dedicated configuration is not present within the complete LTM candidate cell configuration; applying the complete LTM candidate cell configuration in a target cell; and sending the uplink signalling to a target network node to acknowledge the completion of the LTM cell switch procedure.

Now embodiments related to methods performed by a source network node (source DU) are discussed herein.

Various embodiments discuss methods for a source network node (source DU), such as a source gNB, a source DU or a source CU, to initiate a LTM cell switch procedure at the UE, include transmitting at least one LTM reference configuration, and at least one LTM candidate cell configuration. More than one LTM reference configuration and more than one LTM candidate cell configuration may be transmitted. For brevity, the term “LTM reference configuration” may include more than one LTM reference configuration. Similarly, the term “LTM candidate cell configuration” may include more than one LTM candidate cell configuration. The method further includes transmitting a LTM cell switch command (e.g. a MAC CE) for initiating a LTM cell switch procedure, including an indication of a LTM candidate cell configuration.

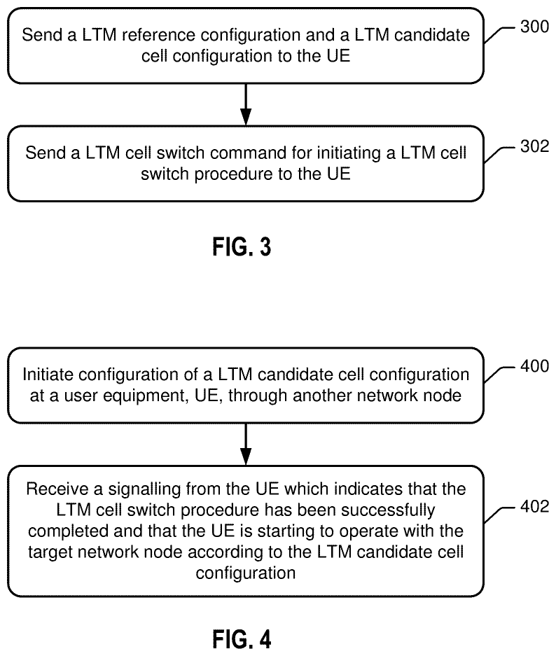

FIG. 3 illustrates flow charts of operations and associated methods by a source network node according to some embodiments of inventive concepts.

In an example embodiment, based on the above, a method performed by a source network node for initiating a LTM cell switch procedure at a UE. The method includes sending 300 a LTM reference configuration and a LTM candidate cell configuration to the UE. The method also includes sending 302 a LTM cell switch command for initiating a LTM cell switch procedure to the UE. The LTM cell switch command comprises an indication of the LTM candidate cell configuration.

In some embodiments, the message containing the LTM candidate cell configuration transmitted to the UE contains an indication of whether the LTM candidate cell configuration is a complete LTM candidate cell configuration.

An example embodiment, based on the above, the LTM candidate cell configuration sent to the UE contains an indication of whether the LTM candidate cell configuration is a complete LTM candidate cell configuration.

In one example, the indication is explicit for the UE to consider the LTM candidate cell configuration as a complete LTM candidate cell configuration.

In one example, the indication is implicit for the UE to consider the LTM candidate cell configuration as a complete LTM candidate cell configuration and indicate to the UE that the transmitted LTM reference configuration should not be considered for the generation of a complete LTM candidate cell configuration related to a LTM candidate cell configuration.

In one example the message where the where the LTM candidate cell configuration is transmitted to the UE is an RRCReconfiguration.

In some embodiments, the indication of whether the LTM candidate cell configuration is a complete LTM candidate cell configuration is transmitted to the UE in a message that is not the same on that one in which the LTM candidate cell configuration is transmitted.

An example embodiment, based on the above, the indication of whether the LTM candidate cell configuration is a complete LTM candidate cell configuration is sent to the UE in a message that is not the same as a message in which the LTM candidate cell configuration is transmitted.

In one example, this message can be a MAC CE, L1 signalling, or RRC message.

Now embodiments related to methods performed by a target network node (target DU) are discussed herein.

Various embodiments discuss a target network node (target DU), such as a target gNB, a target DU, or a target CU, to configure at the UE (e.g., via a third network node or the source network node) a LTM candidate cell configuration and further receiving a signalling from the UE which indicates that an LTM cell switch procedure has been successfully completed and that now the UE is starting to operate in the target network node according to the received LTM candidate cell configuration.

FIG. 4 illustrates flow charts of operations and associated methods by a target network node according to some embodiments of inventive concepts.

In an example embodiment, based on the above, a method is performed by a target network node for a L1/L2-triggered mobility, LTM, cell switch procedure. The method includes initiating 400 configuration of an LTM candidate cell configuration at a user equipment, UE, through another network node. The method also includes receiving 402 a signalling from the UE which indicates that the LTM cell switch procedure has been successfully completed and that the UE is starting to operate with the target network node according to the LTM candidate cell configuration.

In some embodiments, the LTM candidate cell configuration contains an indication on whether the LTM candidate cell configuration is a complete LTM candidate cell configuration.

In an example embodiment, based on the above, the LTM candidate cell configuration contains an indication of whether the LTM candidate cell configuration is a complete LTM candidate cell configuration.

In one example, the indication is explicit for the UE to consider the LTM candidate cell configuration as a complete LTM candidate cell configuration.

In one example, the indication is implicit for the UE to consider the LTM candidate cell configuration as a complete LTM candidate cell configuration and indicate to the UE that the transmitted LTM reference configuration should not be considered for the generation of a complete LTM candidate cell configuration related to a LTM candidate cell configuration.

Further embodiments are now explained in the context of operational implementations that may be used with 3GPP TS 38.331 Rel-18 V17.4.0 (2023-03). Some embodiments which are added to the current 3GPP TS 38.331 Rel-18 V17.4.0 (2023-03) are indicated by underlining.

RRC reconfiguration is now discussed.

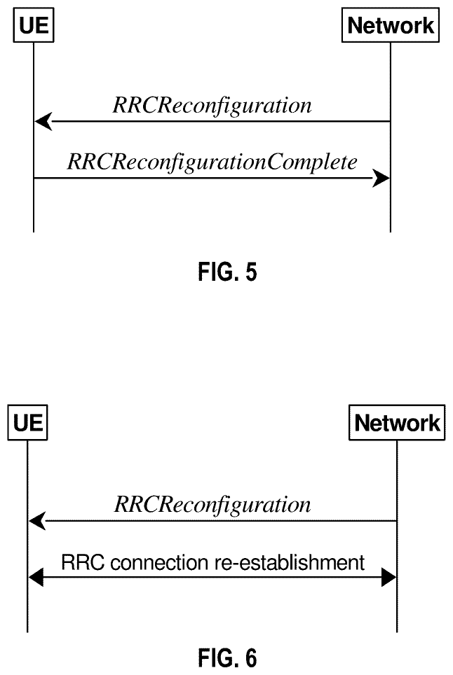

FIG. 5 illustrates the corresponding FIG. 5.3.5.1-1 from 3GPP TS 38.331 V17.4.0 (2023-03) exhibiting RRC reconfiguration, successful.

FIG. 6 illustrates the corresponding FIG. 5.3.5.1-2 from 3GPP TS 38.331 V17.4.0 (2023-03) exhibiting RRC reconfiguration, failure.

The purpose of this procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration, to add/modify/LTM candidate cells. As part of the procedure, NAS dedicated information may be transferred from the Network to the UE.

RRC reconfiguration to perform reconfiguration with sync includes, but is not limited to, the following cases:
reconfiguration with sync and security key refresh, involving RA to the Pcell/PSCell, MAC reset, refresh of security and re-establishment of RLC and PDCP triggered by explicit L2 indicators;
reconfiguration with sync but without security key refresh, involving RA to the Pcell/PSCell, MAC reset and RLC re-establishment and PDCP data recovery (for AM DRB or AM MRB) triggered by explicit L2 indicators.
reconfiguration with sync for DAPS and security key refresh, involving RA to the target Pcell, establishment of target MAC, and
   for non-DAPS bearer: refresh of security and re-establishment of RLC and PDCP triggered by explicit L2 indicators;
   for DAPS bearer: establishment of RLC for the target Pcell, refresh of security and reconfiguration of PDCP to add the ciphering function, the integrity protection function and ROHC function of the target Pcell;
   for SRB: refresh of security and establishment of RLC and PDCP for the target Pcell;
reconfiguration with sync for DAPS but without security key refresh, involving RA to the target Pcell, establishment of target MAC, and
   for non-DAPS bearer: RLC re-establishment and PDCP data recovery (for AM DRB or AM MRB) triggered by explicit L2 indicators.
   for DAPS bearer: establishment of RLC for target Pcell, reconfiguration of PDCP to add the ciphering function, the integrity protection function and ROHC function of the target Pcell;
   for SRB: establishment of RLC and PDCP for the target Pcell.
reconfiguration with sync for direct-to-indirect path switch, not involving RA at target side, involving re-establishment of PDCP/PDCP data recovery (for AM DRB) triggered by explicit L2 indicators.

In (NG)EN-DC and NR-DC, SRB3 can be used for measurement configuration and reporting, for UE assistance (re-)configuration and reporting for power savings, for IP address (re-)configuration and reporting for IAB-nodes, to (re-)configure MAC, RLC, BAP, physical layer and RLF timers and constants of the SCG configuration, and to reconfigure PDCP for DRBs associated with the S-K_{gNB} or SRB3, and to reconfigure SDAP for DRBs associated with S-K_{gNB} in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.

### 5.3.5.2 Initiation

The Network may initiate the RRC reconfiguration procedure to a UE in RRC_CONNECTED. The Network applies the procedure as follows:
the establishment of RBs (other than SRB1, that is established during RRC connection establishment) is performed only when AS security has been activated;
the establishment of BH RLC Channels for IAB is performed only when AS security has been activated;
the establishment of Uu Relay RLC channels and PC5 Relay RLC channels (other than SL-RLC0 and SL-RLC1) for L2 U2N Relay UE is performed only when AS security has been activated, and the establishment of PC5 Relay RLC channels for L2 U2N Remote UE (other than SL-RLC0 and SL-RLC1) is performed only when AS security has been activated;
the addition of Secondary Cell Group and SCells is performed only when AS security has been activated;
the reconfigurationWithSync is included in secondaryCellGroup only when at least one RLC bearer or BH RLC channel is setup in SCG;
the reconfigurationWithSync is included in masterCellGroup only when AS security has been activated, and SRB2 with at least one DRB or multicast MRB or, for IAB, SRB2, are setup and not suspended;
the conditionalReconfiguration for CPC is included only when at least one RLC bearer is setup in SCG;
the conditionalReconfiguration for CHO or CPA is included only when AS security has been activated, and SRB2 with at least one DRB or multicast MRB or, for IAB, SRB2, are setup and not suspended.
the ltm-CandidateConfig for LTM is included only when AS security has been activated, and SRB2 with at least one DRB are setup and not suspended.

Editor's Note: FFS on whether ltm-CandidateConfig applies also for the case of MBS or IAB.

### 5.3.5.3 Reception of an RRCReconfiguration by the UE

The UE shall perform the following actions upon reception of the RRCReconfiguration, or upon execution of the conditional reconfiguration (CHO, CPA or CPC):
1> if the RRCReconfiguration is applied due to a conditional reconfiguration execution upon cell selection performed while timer T311 was running, as defined in 5.3.7.3:
   2> remove all the entries within the MCG and the SCG VarConditionalReconfig, if any;
1> if the RRCReconfiguration includes the daps-SourceRelease:
   2> reset the source MAC and release the source MAC configuration;
   2> for each DAPS bearer:
      3> release the RLC entity or entities as specified in TS 38.322 [4], clause 5.1.3, and the associated logical channel for the source SpCell;
      3> reconfigure the PDCP entity to release DAPS as specified in TS 38.323 [5];
   2> for each SRB:
      3> release the PDCP entity for the source SpCell;
      3> release the RLC entity as specified in TS 38.322 [4], clause 5.1.3, and the associated logical channel for the source SpCell;
   2> release the physical channel configuration for the source SpCell;
   2> discard the keys used in the source SpCell (the K_{gNB} key, the K_{RRCenc} key, the K_{RRCint} key, the K_{Upint} key and the K_{Upenc} key), if any;
1> if the RRCReconfiguration is received via other RAT (i.e., inter-RAT handover to NR):
   2> if the RRCReconfiguration does not include the fullConfig and the UE is connected to 5GC (i.e., delta signalling during intra 5GC handover):
      3> re-use the source RAT SDAP and PDCP configurations if available (i.e., current SDAP/PDCP configurations for all RBs from source E-UTRA RAT prior to the reception of the inter-RAT HO RRCReconfiguration message);
1> else:
   2> if the RRCReconfiguration includes the fullConfig:
      3> perform the full configuration procedure as specified in 5.3.5.11;
1> if the RRCReconfiguration includes the masterCellGroup:
   2> perform the cell group configuration for the received masterCellGroup according to 5.3.5.5;
1> if the RRCReconfiguration includes the masterKeyUpdate:
   2> perform AS security key update procedure as specified in 5.3.5.7;
1> if the RRCReconfiguration includes the sk-Counter:
   2> perform security key update procedure as specified in 5.3.5.7;
1> if the RRCReconfiguration includes the secondaryCellGroup:
   2> perform the cell group configuration for the SCG according to 5.3.5.5;
1> if the RRCReconfiguration includes the mrdc-SecondaryCellGroupConfig:
   2> if the mrdc-SecondaryCellGroupConfig is set to setup:
      3> if the mrdc-SecondaryCellGroupConfig includes mrdc-ReleaseAndAdd:
         4> perform MR-DC release as specified in clause 5.3.5.10; 3> if the received mrdc-SecondaryCellGroup is set to nr-SCG:
         4> perform the RRC reconfiguration according to 5.3.5.3 for the RRCReconfiguration message included in nr-SCG;
      3> if the received mrdc-SecondaryCellGroup is set to eutra-SCG:
         4> perform the RRC connection reconfiguration as specified in TS 36.331 [10], clause 5.3.5.3 for the RRCConnectionReconfiguration message included in eutra-SCG;
   2> else (mrdc-SecondaryCellGroupConfig is set to release):
      3> perform MR-DC release as specified in clause 5.3.5.10;
1> if the RRCReconfiguration message includes the radioBearerConfig:
   2> perform the radio bearer configuration according to 5.3.5.6;
1> if the RRCReconfiguration message includes the radioBearerConfig2:
   2> perform the radio bearer configuration according to 5.3.5.6;
1> if the RRCReconfiguration message includes the measConfig:
   2> perform the measurement configuration procedure as specified in 5.5.2;
1> if the RRCReconfiguration message includes the dedicatedNAS-MessageList:
   2> forward each element of the dedicatedNAS-MessageList to upper layers in the same order as listed;
1> if the RRCReconfiguration message includes the dedicatedSIB1-Delivery:
   2> perform the action upon reception of SIB1 as specified in 5.2.2.4.2;
NOTE 0: If this RRCReconfiguration is associated to the MCG and includes reconfigurationWithSync in spCellConfig and dedicatedSIB1-Delivery, the UE initiates (if needed) the request to acquire required SIBs, according to clause 5.2.2.3.5, only after the random access procedure towards the target SpCell is completed.
1> if the RRCReconfiguration message includes the dedicatedSystemInformationDelivery:
   2> perform the action upon reception of System Information as specified in 5.2.2.4;
1> if the RRCReconfiguration message includes the dedicatedPosSysInfoDelivery:
   2> perform the action upon reception of the contained posSIB(s), as specified in clause 5.2.2.4.16;
1> if the RRCReconfiguration message includes the otherConfig:
   2> perform the other configuration procedure as specified in 5.3.5.9;
1> if the RRCReconfiguration message includes the bap-Config:
   2> perform the BAP configuration procedure as specified in 5.3.5.12;
1> if the RRCReconfiguration message includes the iab-IP-AddressConfigurationList:
   2> if iab-IP-AddressToReleaseList is included:
      3> perform release of IP address as specified in 5.3.5.12a.1.1;
   2> if iab-IP-AddressToAddModList is included:
      3> perform IAB IP address addition/update as specified in 5.3.5.12a.1.2;
1> if the RRCReconfiguration message includes the conditionalReconfiguration:
   2> perform conditional reconfiguration as specified in 5.3.5.13;
1> if the RRCReconfiguration message includes the needForGapsConfigNR:
   2> if needForGapsConfigNR is set to setup:
      3> consider itself to be configured to provide the measurement gap requirement information of NR target bands;
   2> else:
      3> consider itself not to be configured to provide the measurement gap requirement information of NR target bands;
1> if the RRCReconfiguration message includes the needForGapNCSG-ConfigNR:
   2> if needForGapNCSG-ConfigNR is set to setup:
      3> consider itself to be configured to provide the measurement gap and NCSG requirement information of NR target bands;
   2> else:
      3> consider itself not to be configured to provide the measurement gap and NCSG requirement information of NR target bands;
1> if the RRCReconfiguration message includes the needForGapNCSG-ConfigEUTRA:
   2> if needForGapNCSG-ConfigEUTRA is set to setup:
      3> consider itself to be configured to provide the measurement gap and NCSG requirement information of E-UTRA target bands;
   2> else:
      3> consider itself not to be configured to provide the measurement gap and NCSG requirement information of E-UTRA target bands;
1> if the RRCReconfiguration message includes the sl-ConfigDedicatedNR:
   2> perform the sidelink dedicated configuration procedure as specified in 5.3.5.14;
NOTE 0a: If the sl-ConfigDedicatedNR was received embedded within an E-UTRA RRCConnectionReconfiguration message, the UE does not build an NR RRCReconfigurationComplete message for the received sl-ConfigDedicatedNR.
1> if the RRCReconfiguration message includes the sl-L2RelayUE-Config:
   2> perform the L2 U2N Relay UE configuration procedure as specified in 5.3.5.15;
1> if the RRCReconfiguration message includes the sl-L2RemoteUE-Config:
   2> perform the L2 U2N Remote UE configuration procedure as specified in 5.3.5.16;
1> if the RRCReconfiguration message includes the dedicatedPagingDelivery:
   2> perform the Paging message reception procedure as specified in 5.3.2.3;
1> if the RRCReconfiguration message includes the sl-ConfigDedicatedEUTRA-Info:
   2> perform related procedures for V2X sidelink communication in accordance with TS 36.331 [10], clause 5.3.10 and clause 5.5.2;
1> if the RRCReconfiguration message includes the ul-GapFR2-Config:
   2> perform the FR2 UL gap configuration procedure as specified in 5.3.5.13c;
1> if the RRCReconfiguration message includes the musim-GapConfig:
   2> perform the MUSIM gap configuration procedure as specified in 5.3.5.9a;
1> if the RRCReconfiguration message includes the appLayerMeasConfig:
   2> perform the application layer measurement configuration procedure as specified in 5.3.5.13d;
1> if the RRCReconfiguration message includes the ue-TxTEG-RequestUL-TDOA-Config:
   2> if ue-TxTEG-RequestUL-TDOA-Config is set to setup:
      3> perform the UE positioning assistance information procedure as specified in 5.7.14;
   2> else:
      3> release the configuration of UE positioning assistance information;
1> if the RRCReconfiguration message includes the ltm-CandidateConfig:
   2> perform the LTM configuration procedure as specified in 5.3.5.x; 1> set the content of the RRCReconfiurationComplete message as follows:
NOTE X: In case this procedure is initiated due to the generation of a complete LTM candidate cell configuration, the UE should generate only one RRCReconfigurationComplete only after the generation of the complete LTM candidate cell configuration is completed.
   2> if the RRCReconfiguration includes the masterCellGroup containing the reportUplinkTxDirectCurrent:
      3> include the uplinkTxDirectCurrentList for each MCG serving cell with UL;
      3> include uplinkDirectCurrentBWP-SUL for each MCG serving cell configured with SUL carrier, if any, within the uplinkTxDirectCurrentList;
   2> if the RRCReconfiguration includes the masterCellGroup containing the reportUplinkTxDirectCurrentTwoCarrier:
      3> include in the uplinkTxDirectCurrentTwoCarrierList the list of uplink Tx DC locations for the configured intra-band uplink carrier aggregation in the MCG;
   2> if the RRCReconfiguration includes the masterCellGroup containing the reportUplinkTxDirectCurrentMoreCarrier:
      3> include in the uplinkTxDirectCurrentMoreCarrierList the list of uplink Tx DC locations for the configured intra-band uplink carrier aggregation in the MCG;
   2> if the RRCReconfiguration includes the secondaryCellGroup containing the reportUplinkTxDirectCurrent:
      3> include the uplinkTxDirectCurrentList for each SCG serving cell with UL;
      3> include uplinkDirectCurrentBWP-SUL for each SCG serving cell configured with SUL carrier, if any, within the uplinkTxDirectCurrentList;
   2> if the RRCReconfiguration includes the secondaryCellGroup containing the reportUplinkTxDirectCurrentTwoCarrier:
      3> include in the uplinkTxDirectCurrentTwoCarrierList the list of uplink Tx DC locations for the configured intra-band uplink carrier aggregation in the SCG;
   2> if the RRCReconfiguration includes the secondaryCellGroup containing the reportUplinkTxDirectCurrentMoreCarrier:
      3> include in the uplinkTxDirectCurrentMoreCarrierList the list of uplink Tx DC locations for the configured intra-band uplink carrier aggregation in the SCG;
NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
   2> if the RRCReconfiguration message includes the mrdc-SecondaryCellGroupConfig with mrdc-SecondaryCellGroup set to eutra-SCG:
      3> include in the eutra-SCG-Response the E-UTRA RRCConnectionReconfigurationComplete message in accordance with TS 36.331 [10] clause 5.3.5.3;
   2> if the RRCReconfiguration message includes the mrdc-SecondaryCellGroupConfig with mrdc-SecondaryCellGroup set to nr-SCG:
      3> include in the nr-SCG-Response the SCG RRCReconfigurationComplete message;
      3> if the RRCReconfiguration message is applied due to conditional reconfiguration execution and the RRCReconfiguration message does not include the reconfigurationWithSync in the masterCellGroup:
         4> include in the selectedCondRRCReconfig the condReconfigId for the selected cell of conditional reconfiguration execution;
   2> if the RRCReconfiguration includes the reconfigurationWithSync in spCellConfig of an MCG:
      3> if the UE has logged measurements available for NR and if the RPLMN is included in plmn-IdentityList stored in VarLogMeasReport:
         4> include the logMeasAvailable in the RRCReconfigurationComplete message;
         4> if Bluetooth measurement results are included in the logged measurements the UE has available for NR:
         5> include the logMeasAvailableBT in the RRCReconfigurationComplete message;
         4> if WLAN measurement results are included in the logged measurements the UE has available for NR:
         5> include the logMeasAvailableWLAN in the RRCReconfigurationComplete message;
      3> if the sigLoggedMeasType in VarLogMeasReport is included:
         4> if T330 timer is running and the logged measurements configuration is for NR:
         5> set sigLogMeasConfigAvailable to true in the RRCReconfigurationComplete message;
         4> else:
         5> if the UE has logged measurements available for NR:
         6> set sigLogMeasConfigAvailable to false in the RRCReconfigurationComplete message;
      3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
         4> include connEstFailInfoAvailable in the RRCReconfigurationComplete message;
      3> if the UE has radio link failure or handover failure information available in VarRLF-Report and if the RPLMN is included in plmn-IdentityList stored in VarRLF-Report; or
      3> if the UE has radio link failure or handover failure information available in VarRLF-Report of TS 36.331 [10] and if the UE is capable of cross-RAT RLF reporting and if the RPLMN is included in plmn-IdentityList stored in VarRLF-Report of TS 36.331 [10]:
         4> include rlf-InfoAvailable in the RRCReconfigurationComplete message;
      3> if the UE was configured with successHO-Config when connected to the source Pcell; and
      3> if the applied RRCReconfiguration is not due to a conditional reconfiguration execution upon cell selection performed while timer T311 was running, as defined in 5.3.7.3:
         4> perform the actions for the successful handover report determination as specified in clause 5.7.10.6, upon successfully completing the Random Access procedure triggered for the reconfigurationWithSync in spCellConfig of the MCG;
      3> if the UE has successful handover information available in VarSuccessHO-Report and if the RPLMN is included in plmn-IdentityList stored in VarSuccessHO-Report:
         4> include successHO-InfoAvailable in the RRCReconfigurationComplete message;
   2> if the RRCReconfiguration message was received via SRB1, but not within mrdc-SecondaryCellGroup or E-UTRA RRCConnectionReconfiguration or E-UTRA RRCConnectionResume:
      3> if the UE is configured to provide the measurement gap requirement information of NR target bands:
         4> if the RRCReconfiguration message includes the needForGapsConfigNR; or
         4> if the NeedForGapsInfoNR information is changed compared to last time the UE reported this information:
         5> include the NeedForGapsInfoNR and set the contents as follows:
         6> include intraFreq-needForGap and set the gap requirement information of intra-frequency measurement for each NR serving cell;
         6> if requestedTargetBandFilterNR is configured:
         7> for each supported NR band that is also included in requestedTargetBandFilterNR, include an entry in interFreq-needForGap and set the gap requirement information for that band;
         6> else:
         7> include an entry in interFreq-needForGap and set the corresponding gap requirement information for each supported NR band;
      3> if the UE is configured to provide the measurement gap and NCSG requirement information of NR target bands:
         4> if the RRCReconfiguration message includes the needForGapNCSG-ConfigNR; or
         4> if the needForGapNCSG-InfoNR information is changed compared to last time the UE reported this information:
         5> include the NeedForGapNCSG-InfoNR and set the contents as follows:
         6> include intraFreq-needForNCSG and set the gap and NCSG requirement information of intra-frequency measurement for each NR serving cell;
         6> if requestedTargetBandFilterNCSG-NR is configured:
         7> for each supported NR band included in requestedTargetBandFilterNCSG-NR, include an entry in interFreq-needForNCSG and set the NCSG requirement information for that band;
         6> else:
         7> include an entry for each supported NR band in interFreq-needForNCSG and set the corresponding NCSG requirement information;
      3> if the UE is configured to provide the measurement gap and NCSG requirement information of E-UTRA target bands:
         4> if the RRCReconfiguration message includes the needForGapNCSG-ConfigEUTRA; or
         4> if the needForGapNCSG-InfoEUTRA information is changed compared to last time the UE reported this information:
         5> include the NeedForGapNCSG-InfoEUTRA and set the contents as follows:
         6> if requestedTargetBandFilterNCSG-EUTRA is configured, for each supported E-UTRA band included in requestedTarketBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
   2> if this procedure is initiated due to the generation of a complete LTM candidate cell configuration:
      3> the procedure ends;
1> if the UE is configured with E-UTRA nr-SecondaryCellGroupConfig (UE in (NG)EN-DC):
   2> if the RRCReconfiguration message was received via E-UTRA SRB1 as specified in TS 36.331 [10]; or
   2> if the RRCReconfiguration message was received via E-UTRA RRC message RRCConnectionReconfiguration within MobilityFromNRCommand (handover from NR standalone to (NG)EN-DC);
      3> if the RRCReconfiguration is applied due to a conditional reconfiguration execution for CPC which is configured via conditionalReconfiguration contained in nr-SecondaryCellGroupConfig specified in TS 36.331 [10]:
         4> submit the RRCReconfigurationComplete message via the E-UTRA MCG embedded in E-UTRA RRC message ULInformationTransferMRDC as specified in TS 36.331 [10], clause 5.6.2a.
      3> else if the RRCReconfiguration message was included in E-UTRA RRCConnectionResume message:
         4> submit the RRCReconfigurationComplete message via E-UTRA embedded in E-UTRA RRC message RRCConnectionResumeComplete as specified in TS 36.331 [10], clause 5.3.3.4a;
      3> else:
         4> submit the RRCReconfigurationComplete via E-UTRA embedded in E-UTRA RRC message RRCConnectionReconfigurationComplete as specified in TS 36.331 [10], clause 5.3.5.3/5.3.5.4/5.4.2.3;
      3> if the scg-State is not included in the E-UTRA message (RRCConnectionReconfiguration or RRCConnectionResume) containing the RRCReconfiguration message:
         4> perform SCG activation as specified in 5.3.5.13a;
         4> if reconfigurationWithSync was included in spCellConfig of an SCG:
         5> initiate the Random Access procedure on the PSCell, as specified in TS 38.321 [3];
         4> else if the SCG was deactivated before the reception of the E-UTRA RRC message containing the RRCReconfiguration message:
         5> if bfd-and-RLM was not configured to true before the reception of the E-UTRA RRCConnectionReconfiguration or RRCConnectionResume message containing the RRCReconfiguration message or if lower layers indicate that a Random Access procedure is needed for SCG activation:
         6> initiate the Random Access procedure on the SpCell, as specified in TS 38.321 [3];
         5> else the procedure ends;
         4> else the procedure ends;
      3> else:
         4> perform SCG deactivation as specified in 5.3.5.13b;
         4> the procedure ends;
   2> if the RRCReconfiguration message was received within nr-SecondaryCellGroupConfig in RRCConnectionReconfiguration message received via SRB3 within DLInformationTransferMRDC:
      3> submit the RRCReconfigurationComplete via E-UTRA embedded in E-UTRA RRC message RRCConnectionReconfigurationComplete as specified in TS 36.331 [10], clause 5.3.5.3/5.3.5.4;
      3> if the scg-State is not included in the RRCConnectionReconfiguration:
         4> if reconfigurationWithSync was included in spCellConfig of an SCG:
         5> initiate the Random Access procedure on the SpCell, as specified in TS 38.321 [3];
         4> else the procedure ends;
      3> else:
         4> perform SCG deactivation as specified in 5.3.5.13b;
         4> the procedure ends;
NOTE 1: The order the UE sends the RRCConnectionReconfigurationComplete message and performs the Random Access procedure towards the SCG is left to UE implementation.
   2> else (RRCReconfiguration was received via SRB3) but not within DLInformationTransferMRDC:
      3> submit the RRCReconfigurationComplete message via SRB3 to lower layers for transmission using the new configuration;
NOTE 2: In (NG)EN-DC and NR-DC, in the case RRCReconfiguration is received via SRB1 or within DLInformationTransferMRDC via SRB3, the random access is triggered by RRC layer itself as there is not necessarily other UL transmission. In the case RRCReconfiguration is received via SRB3 but not within DLInformationTransferMRDC, the random access is triggered by the MAC layer due to arrival of RRCReconfigurationComplete.
1> else if the RRCReconfiguration message was received via SRB1 within the nr-SCG within mrdc-SecondaryCellGroup (UE in NR-DC, mrdc-SecondaryCellGroup was received in RRCReconfiguration or RRCResume via SRB1):
   2> if the RRCReconfiguration is applied due to a conditional reconfiguration execution for CPC which is configured via conditionalReconfiguration contained in nr-SCG within mrdc-SecondaryCellGroup:
      3> submit the RRCReconfigurationComplete message via the NR MCG embedded in NR RRC message ULInformationTransferMRDC as specified in clause 5.7.2a.3.
   2> if the scg-State is not included in the RRCReconfiguration or RRCResume message containing the RRCReconfiguration message:
      3> perform SCG activation as specified in 5.3.5.13a;
      3> if reconfigurationWithSync was included in spCellConfig in nr-SCG:
         4> initiate the Random Access procedure on the PSCell, as specified in TS 38.321 [3];
      3> else if the SCG was deactivated before the reception of the NR RRC message containing the RRCReconfiguration message:
         4> if bfd-and-RLM was not configured to true before the reception of the RRCReconfiguration or RRCResume message containing the RRCReconfiguration message; or
         4> if lower layers indicate that a Random Access procedure is needed for SCG activation:
         5> initiate the Random Access procedure on the PSCell, as specified in TS 38.321 [3];
         4> else the procedure ends;
      3> else the procedure ends;
   2> else
      3> perform SCG deactivation as specified in 5.3.5.13b;
      3> the procedure ends;
NOTE 2a: The order in which the UE sends the RRCReconfigurationComplete message and performs the Random Access procedure towards the SCG is left to UE implementation.
1> else if the RRCReconfiguration message was received via SRB3 (UE in NR-DC):
   2> if the RRCReconfiguration message was received within DLInformationTransferMRDC:
      3> if the RRCReconfiguration message was received within the nr-SCG within mrdc-SecondaryCellGroup (NR SCG RRC Reconfiguration):
         4> if the scg-State is not included in the RRCReconfiguration message containing the RRCReconfiguration message:
         5> if reconfigurationWithSync was included in spCellConfig in nr-SCG:
         6> initiate the Random Access procedure on the PSCell, as specified in TS 38.321 [3];
         5> else:
         6> the procedure ends;
         4> else:
         5> perform SCG deactivation as specified in 5.3.5.13b;
         5> the procedure ends;
      3> else:
         4> if the RRCReconfiguration does not include the mrdc-SecondaryCellGroupConfig:
         5> if the RRCReconfiguration includes the scg-State:
         6> perform SCG deactivation as specified in 5.3.5.13b;
         4> submit the RRCReconfigurationComplete message via SRB1 to lower layers for transmission using the new configuration;
   2> else:
      3> if this procedure is initiated due to the processing of ltm-Candidate received within ltm-CandidateConfig;
         4> submit the RRCReconfigurationComplete message via SRB3 to lower layers for transmission using the new configuration only upon the execution of an LTM cell switch procedure as specified in 5.3.5.x.5;
      3> else:
         4> submit the RRCReconfiurationComplete message via SRB3 to lower layers for transmission using the new configuration;
1> else (RRCReconfiguration was received via SRB1):
   2> if the UE is in NR-DC and;
   2> if the RRCReconfiguration does not include the mrdc-SecondaryCellGroupConfig:
      3> if the RRCReconfiguration includes the scg-State:
         4> perform SCG deactivation as specified in 5.3.5.13b;
      3> else:
         4> perform SCG activation without SN message as specified in 5.3.5.13b1;
   2> if the reconfigurationWithSync was included in spCellConfig of an MCG:
      3> if ta-Report is configured with value enabled and the UE supports TA reporting:
         4> indicate TA report initiation to lower layers;
   2> if this procedure is initiated due to the processing of ltm-Candidate received within ltm-CandidateConfig;
      3> submit the RRCReconfigurationComplete message via SRB1 to lower layers for transmission using the new configuration upon the execution of an LTM cell switch procedure as specified in 5.3.5.x.5;
   2> else:
      3> submit the RRCReconfigurationComplete message via SRB1 to lower layers for transmission using the new configuration;
   2> if this is the first RRCReconfiguration message after successful completion of the RRC re-establishment procedure:
      3> resume SRB2, SRB4, DRBs, multicast MRB, and BH RLC channels for IAB-MT, and Uu Relay RLC channels for L2 U2N Relay UE, that are suspended;
1> if reconfigurationWithSync was included in spCellConfig of an MCG or SCG and when MAC of an NR cell group successfully completes a Random Access procedure triggered above; or,
1> if sl-PathSwitchConfig was included in reconfigurationWithSync included in spCellConfig of an MCG, and when successfully sending RRCReconfigurationComplete message (i.e., PC5 RLC acknowledgement is received from target L2 U2N Relay UE):
   2> stop timer T304 for that cell group if running;
   2> if sl-PathSwitchConfig was included in reconfigurationWithSync:
      3> stop timer T420;
      3> release all radio resources, including release of the RLC entities and the MAC configuration at the source side;
      3> reset MAC used in the source cell;
NOTE 2b: PDCP and SDAP configured by the source prior to the path switch that are reconfigured and re-used by target when delta signalling is used, are not released as part of this procedure.
   2> stop timer T310 for source SpCell if running;
   2> apply the parts of the CSI reporting configuration, the scheduling request configuration and the sounding RS configuration that do not require the UE to know the SFN of the respective target SpCell, if any;
   2> apply the parts of the measurement and the radio resource configuration that require the UE to know the SFN of the respective target SpCell (e.g. measurement gaps, periodic CQI reporting, scheduling request configuration, sounding RS configuration), if any, upon acquiring the SFN of that target SpCell;
   2> for each DRB configured as DAPS bearer, request uplink data switching to the PDCP entity, as specified in TS 38.323 [5];
   2> if the reconfigurationWithSync was included in spCellConfig of an MCG:
      3> if T390 is running:
         4> stop timer T390 for all access categories;
         4> perform the actions as specified in 5.3.14.4.
      3> if T350 is running:
         4> stop timer T350;
      3> if RRCReconfiguration does not include dedicatedSIB1-Delivery and
      3> if the active downlink BWP, which is indicated by thefirstActiveDownlinkBWP-Id for the target SpCell of the MCG, has a common search space configured by searchSpaceSIB1:
         4> acquire the SIB1, which is scheduled as specified in TS 38.213 [13], of the target SpCell of the MCG;
         4> upon acquiring SIB1, perform the actions specified in clause 5.2.2.4.2;
   2> if the reconfigurationWithSync was included in spCellConfig of an MCG; or
   2> if the reconfigurationWithSync was included in spCellConfig of an SCG and the CPA or CPC was configured:
      3> remove all the entries within the MCG and the SCG VarConditionalReconfig, if any;
      3> remove all the entries within VarConditionalReconfiguration as specified in TS 36.331 [10], clause 5.3.5.9.6, if any;
      3> for each measId of the MCG measConfig, if configured, and for each measId of the SCG measConfig, if configured, if the associated reportConfig has a reportType set to condTriggerConfig:
         4> for the associated reportConfigId:
         5> remove the entry with the matching reportConfigId from the reportConfigList within the VarMeasConfig;
         4> if the associated measObjectId is only associated to a reportConfig with reportType set to condTriggerConfig:
         5> remove the entry with the matching measObjectId from the measObjectList within the VarMeasConfig;
         4> remove the entry with the matching measId from the measIdList within the VarMeasConfig;
   2> if reconfigurationWithSync was included in masterCellGroup or secondaryCellGroup:
      3> if the UE initiated transmission of a UEAssistanceInformation message for the corresponding cell group during the last 1 second, and the UE is still configured to provide the concerned UE assistance information for the corresponding cell group; or
      3> if the RRCReconfiguration message is applied due to a conditional reconfiguration execution, and the UE is configured to provide UE assistance information for the corresponding cell group, and the UE has initiated transmission of a UEAssistanceInformation message for the corresponding cell group since it was configured to do so in accordance with 5.7.4.2:
         4> initiate transmission of a UEAssistanceInformation message for the corresponding cell group in accordance with clause 5.7.4.3 to provide the concerned UE assistance information;
         4> start or restart the prohibit timer (if exists) or the leave without response timer for the MUSIM associated with the concerned UE assistance information with the timer value set to the value in corresponding configuration;
      3> if SIB12 is provided by the target Pcell, and the UE initiated transmission of a SidelinkUEInformationNR message indicating a change of NR sidelink communication/discovery related parameters relevant in target Pcell (i.e. change of sl-RxInterestedFreqList or sl-TxResourceReqList) during the last 1 second preceding reception of the RRCReconfiguration message including reconfigurationWithSync in spCellConfig of an MCG; or
      3> if the RRCReconfiguration message is applied due to a conditional reconfiguration execution and the UE is capable of NR sidelink communication/discovery and SIB12 is provided by the target Pcell, and the UE has initiated transmission of a SidelinkUEInformationNR message since it was configured to do so in accordance with 5.8.3.2:
         4> initiate transmission of the SidelinkUEInformationNR message in accordance with 5.8.3.3;
   2> if reconfigurationWithSync was included in masterCellGroup:
      3> if configured with application layer measurements and if application layer measurement report container has been received from upper layers for which the successful transmission of the message or at least one segment of the message has not been confirmed by lower layers:
         4> re-submit the MeasurementReportAppLayer message or all segments of the MeasurementReportAppLayer message to lower layers for transmission via SRB4;
   2> if reconfigurationWithSync was included in masterCellGroup and the target cell provides SIB21:
      3> if the UE initiated transmission of an MBSInterestIndication message during the last 1 second preceding reception of this RRCReconfiguration message; or
      3> if the RRCReconfiguration message is applied due to a conditional reconfiguration execution, and the UE has initiated transmission of an MBSInterestIndication message after having received this RRCReconfiguration message:
         4> initiate transmission of an MBSInterestIndication message in accordance with clause 5.9.4;
   2> the procedure ends.
NOTE 3: The UE is only required to acquire broadcasted SIB1 if the UE can acquire it without disrupting unicast or MBS multicast data reception, i.e. the broadcast and unicast/MBS multicast beams are quasi co-located.
NOTE 4: The UE sets the content of UEAssistanceInformation according to latest configuration (i.e. the configuration after applying the RRCReconfiguration message) and latest UE preference. The UE may include more than the concerned UE assistance information within the UEAssistanceInformation according to 5.7.4.2. Therefore, the content of UEAssistanceInformation message might not be the same as the content of the previous UEAssistanceInformation message.

### 5.3.5.5 Cell Group Configuration

### 5.3.5.5.1 General

The network configures the UE with Master Cell Group (MCG), and zero or one Secondary Cell Group (SCG). In (NG)EN-DC, the MCG is configured as specified in TS 36.331 [10], and for NE-DC, the SCG is configured as specified in TS 36.331 [10]. The network provides the configuration parameters for a cell group in the CellGroupConfig IE.

The UE performs the following actions based on a received CellGroupConfig IE:
1> if the CellGroupConfig contains the spCellConfig with reconfigurationWithSync; and
1> if this procedure is not initiated due to the generation of a complete LTM candidate cell configuration:
   2> perform Reconfiguration with sync according to 5.3.5.5.2;
   2> resume all suspended radio bearers except the SRBs for the source cell group, and resume SCG transmission for all radio bearers, and resume BH RLC channels and resume SCG transmission for BH RLC channels for IAB-MT, if suspended; NOTE: If the SCG is deactivated, resuming SCG transmission for all radio bearers does not imply that PDCP PDUs can be transmitted or received on SCG RLC bearers.
1> if the CellGroupConfig contains the rlc-BearerToReleaseList or rlc-BearerToReleaseListExt:
   2> perform RLC bearer release as specified in 5.3.5.5.3;
1> if the CellGroupConfig contains the rlc-BearerToAddModList:
   2> perform the RLC bearer addition/modification as specified in 5.3.5.5.4;
1> if the CellGroupConfig contains the mac-CellGroupConfig:
   2> configure the MAC entity of this cell group as specified in 5.3.5.5.5;
1> if the CellGroupConfig contains the sCellToReleaseList:
   2> perform SCell release as specified in 5.3.5.5.8;
1> if the CellGroupConfig contains the spCellConfig:
   2> configure the SpCell as specified in 5.3.5.5.7;
1> if the CellGroupConfig contains the sCellToAddModList:
   2> perform SCell addition/modification as specified in 5.3.5.5.9;
1> if the CellGroupConfig contains the bh-RLC-ChannelToReleaseList:
   2> perform BH RLC channel release as specified in 5.3.5.5.10;
1> if the CellGroupConfig contains the bh-RLC-ChannelToAddModList:
   2> perform the BH RLC channel addition/modification as specified in 5.3.5.5.11;
1> if the CellGroupConfig contains the uu-RelayRLC-ChannelToReleaseList:
   2> perform Uu Relay RLC channel release as specified in 5.3.5.5.12;
1> if the CellGroupConfig contains the uu-RelayRLC-ChannelToAddModList:
   2> perform the Uu Relay RLC channel addition/modification as specified in 5.3.5.5.13;

### 5.3.5.5.3 RLC Bearer Release

The UE shall:
1> for each logicalChannelIdentity/LogicalChannelIdentityExt value included in the rlc-BearerToReleaseList/rlc-BearerToReleaseListExt that is part of the current UE configuration within the same cell group (LCH release); or
1> for each logicalChannelIdentity value that is to be released as the result of an SCG release according to 5.3.5.4:
   2> release the RLC entity or entities as specified in TS 38.322 [4], clause 5.1.3;
   2> release the corresponding logical channel.

### 5.3.5.5.4 RLC Bearer Addition/Modification

For each RLC-BearerConfig received in the rlc-BearerToAddModList IE the UE shall:
1> if the UE's current configuration contains an RLC bearer with the received logicalChannelIdentity/LogicalChannelIdentityExt within the same cell group:
NOTE X: This case does not apply when this procedure is initiated due to the generation of an LTM candidate cell configuration.
   2> if the RLC bearer is associated with an DAPS bearer, or
   2> if any DAPS bearer is configured and the RLC bearer is associated with an SRB:
      3> reconfigure the RLC entity or entities for the target cell group in accordance with the received rlc-Config;
      3> reconfigure the logical channel for the target cell group in accordance with the received mac-LogicalChannelConfig;
   2> else:
      3> if reestablishRLC is received:
         4> re-establish the RLC entity as specified in TS 38.322 [4];
      3> reconfigure the RLC entity or entities in accordance with the received rlc-Config;
      3> reconfigure the logical channel in accordance with the received mac-LogicalChannelConfig;
      3> if servedMBS-RadioBearer is received:
         4> associate this logical channel with the PDCP entity identified by servedMBS-RadioBearer;
NOTE 1: For DRB and SRB, the network does not re-associate an already configured logical channel with another radio bearer. Hence, servedRadioBearer is not present in this case. For MRB, the network does not re-associate an already configured logical channel with DRB or SRB or another MRB (i.e. MRB with another PDCP entity). Hence multicastRLC-BearerConfig is not present in this case.
NOTE 2: In DAPS handover, the UE may perform RLC entity re-establishment (if reestablishRLC is set) for an RLC bearer associated with a non-DAPS bearer when indication of successful completion of random access towards target cell is received from lower layers as specified in TS 38.321 [3].
1> else if a logical channel with the given logicalChannelIdentity/LogicalChannelIdentityExt is not configured within the same cell group, including the case when full configuration option is used:
   2> if the servedRadioBearer associates the logical channel with an SRB and rlc-Config is not included:
      3> establish an RLC entity in accordance with the default configuration defined in 9.2 for the corresponding SRB;
   2> else:
      3> establish an RLC entity in accordance with the received rlc-Config;
   2> if the servedRadioBearer associates the logical channel with an SRB and if mac-LogicalChannelConfig is not included:
      3> configure this MAC entity with a logical channel in accordance to the default configuration defined in 9.2 for the corresponding SRB;
   2> else:
      3> configure this MAC entity with a logical channel in accordance to the received mac-LogicalChannelConfig;
   2> associate this logical channel with the PDCP entity identified by servedRadioBearer or servedMBS-RadioBearer.

### 5.3.5.5.5 MAC Entity Configuration

The UE shall:
1> if SCG MAC is not part of the current UE configuration (i.e. SCG establishment):
   2> create an SCG MAC entity;
1> if any DAPS bearer is configured:
   2> reconfigure the MAC main configuration for the target cell group in accordance with the received mac-CellGroupConfig excluding tag-ToReleaseList and tag-ToAddModList;
1> if this procedure is initiated due to the generation of a complete LTM candidate cell configuration:
   2> create a MAC entity for the LTM candidate cell configuration for which a complete configuration needs to be generated excluding tag-ToReleaseList and tag-ToAddModList;
1> else:
   2> reconfigure the MAC main configuration of the cell group in accordance with the received mac-CellGroupConfig excluding tag-ToReleaseList and tag-ToAddModList;
1> if the received mac-CellGroupConfig includes the tag-ToReleaseList:
   2> for each TAG-Id value included in the tag-ToReleaseList that is part of the current UE configuration:
      3> release the TAG indicated by TAG-Id;
1> if the received mac-CellGroupConfig includes the tag-ToAddModList:
   2> for each tag-Id value included in tag-ToAddModList that is not part of the current UE configuration (TAG addition):
      3> add the TAG, corresponding to the tag-Id, in accordance with the received timeAlignmentTimer;
   2> for each tag-Id value included in tag-ToAddModList that is part of the current UE configuration (TAG modification):
      3> reconfigure the TAG, corresponding to the tag-Id, in accordance with the received timeAlignmentTimer.

### 5.3.5.5.6 RLF Timers & Constants Configuration

The UE shall:
1> if the received rlf-TimersAndConstants is set to release:
   2> if any DAPS bearer is configured:
      3> use values for timers T301, T310, T311 and constants N310, N311 for the target cell group, as included in ue-TimersAndConstants received in SIB1;
   2> else:
      3> use values for timers T301, T310, T311 and constants N310, N311, as included in ue-TimersAndConstants received in SIB1;
1> else:
   2> if any DAPS bearer is configured:
      3> configure the value of timers and constants for the target cell group in accordance with received rlf-TimersAndConstants;
   2> else:
      3> (re-)configure the value of timers and constants in accordance with received rlf-TimersAndConstants;
      3> if this procedure is not initiated due to the generation of a complete LTM candidate cell configuration:
         4> stop timer T310 for this cell group, if running;
         4> stop timer T312 for this cell group, if running;
         4> reset the counters N310 and N311.

### 5.3.5.5.7 SpCell Configuration

The UE shall:
1> if the UE is acting as L2 U2N Remote UE:
   2> if the SpCellConfig contains the rlf-TimersAndConstants which is set to setup:
      3> use value for timers T311 as received in rlf-TimersAndConstants;
   2> else if rlf-TimersAndConstants is not configured for this cell group or SpCellConfig contains the rlf-TimersAndConstants which is set to release:
      3> use value for timers T311, as included in ue-TimersAndConstants received in SIB1;
1> else
   2> if the SpCellConfig contains the rlf-TimersAndConstants:
      3> configure the RLF timers and constants for this cell group as specified in 5.3.5.5.6;
   2> else if rlf-TimersAndConstants is not configured for this cell group:
      3> if any DAPS bearer is configured:
         4> use values for timers T301, T310, T311 and constants N310, N311 for the target cell group, as included in ue-TimersAndConstants received in SIB1;
      3> else
         4> use values for timers T301, T310, T311 and constants N310, N311, as included in ue-TimersAndConstants received in SIB1;
   2> if the SpCellConfig contains spCellConfigDedicated:
      3> configure the SpCell in accordance with the spCellConfigDedicated;
      3> consider the bandwidth part indicated infirstActiveUplinkBWP-Id, if included in the spCellConfigDedicated, to be the active uplink bandwidth part;
      3> if the firstActiveDownlinkBWP-Id is included in the spCellConfigDedicated:
         4> if the SpCellConfig is included in an RRCReconfiguration message contained in an NR or E-UTRA RRC message indicating that the SCG is deactivated:
         5> consider the bandwidth part indicated in firstActiveDownlinkBWP-Id to be the bandwidth part for Radio Link Monitoring, Beam Failure Detection and measurements;
         4> else:
         5> consider the bandwidth part indicated in firstActiveDownlinkBWP-Id to be the active downlink bandwidth part;
      3> if any of the reference signal(s) that are used for radio link monitoring are reconfigured by the received spCellConfigDedicated; and
      1> if this procedure is not initiated due to the generation of a complete LTM candidate cell configuration:
         4> stop timer T310 for the corresponding SpCell, if running;
         4> stop timer T312 for the corresponding SpCell, if running;
         4> reset the counters N310 and N311.
1> if the SpCellConfig contains the lowMobilityEvaluationConnected:
   2> the UE may perform the evaluation of the low mobility criterion for this cell group as specified in 5.7.13.1;
1> if the SpCellConfig contains the goodServingCellEvaluationRLM:
   2> the UE may perform the evaluation of the good serving cell quality criterion for this SpCell as specified in 5.7.13.2;
1> if the SpCellConfig contains the goodServingCellEvaluationBFD:
   2> the UE may perform the evaluation of the good serving cell quality criterion for this serving cell as specified in 5.7.13.2;

### 5.3.5.5.8 SCell Release

The UE shall:
1> if the release is triggered by reception of the sCellToReleaseList:
   2> for each sCellIndex value included in the sCellToReleaseList:
      3> if the current UE configuration includes an SCell with value sCellIndex:
         4> release the SCell.
Editor's Note: FFS on whether the release of an SCell by an LTM candidate cell configuration is a valid case.

### 5.3.5.5.9 SCell Addition/Modification

The UE shall:
1> for each sCellIndex value included in the sCellToAddModList that is not part of the current UE configuration (SCell addition):
   2> add the SCell, corresponding to the sCellIndex, in accordance with the sCellConfigCommon and sCellConfigDedicated;
   2> if the sCellState is included:
      3> configure lower layers to consider the SCell to be in activated state;
   2> else:
      3> configure lower layers to consider the SCell to be in deactivated state;
   2> for each measId included in the measIdList within VarMeasConfig:
      3> if SCells are not applicable for the associated measurement; and
      3> if the concerned SCell is included in cellsTriggeredList defined within the VarMeasReportList for this measId; and
      3> if this procedure is not initiated due to the generation of a complete LTM candidate cell configuration:
         4> remove the concerned SCell from cellsTriggeredList defined within the VarMeasReportList for this measId;
   2> if the SCellConfig contains the goodServingCellEvaluationBFD:
      3> the UE may perform the evaluation of the good serving cell quality criterion for this serving cell as specified in 5.7.13.2.
1> for each sCellIndex value included in the sCellToAddModList that is part of the current UE configuration (SCell modification):
NOTE X: This case does not apply when this procedure is initiated due to the generation of an LTM candidate cell configuration.
   2> modify the SCell configuration in accordance with the sCellConfigDedicated;
   2> if the sCellState is included:
      3> configure lower layers to consider the SCell to be in activated state;
   2> else:
      3> configure lower layers to consider the SCell to be in deactivated state.
   2> if the SCellConfig contains the goodServingCellEvaluationBFD:
      3> the UE may perform the evaluation of the good serving cell quality criterion for this serving cell as specified in 5.7.13.2.
         5.3.5.6 Radio Bearer configuration

### 5.3.5.6.1 General

The UE shall perform the following actions based on a received RadioBearerConfig IE:
1> if the RadioBearerConfig includes the srb3-ToRelease or srb4-ToRelease:
   2> perform the SRB release as specified in 5.3.5.6.2;
1> if the RadioBearerConfig includes the srb-ToAddModList or if any DAPS bearer is configured:
   2> perform the SRB addition or reconfiguration as specified in 5.3.5.6.3;
1> if the RadioBearerConfig includes the drb-ToReleaseList:
   2> perform DRB release as specified in 5.3.5.6.4;
1> if the RadioBearerConfig includes the drb-ToAddModList:
   2> perform DRB addition or reconfiguration as specified in 5.3.5.6.5;
1> if the RadioBearerConfig includes the mrb-ToReleaseList:
   2> perform multicast MRB release as specified in 5.3.5.6.6;
1> if the RadioBearerConfig includes the mrb-ToAddModList:
   2> perform multicast MRB addition or reconfiguration as specified in 5.3.5.6.7;
1> if this procedure is not initiated due to the generation of a complete LTM candidate cell configuration:
   2> release all SDAP entities, if any, that have no associated DRB as specified in TS 37.324 [24] clause 5.1.2, and indicate the release of the user plane resources for PDU Sessions associated with the released SDAP entities to upper layers;
1> release all SDAP entities that have no associated multicast MRB as specified in TS 37.324 [24] clause 5.1.2, and indicate the release of user plane resources for these MBS multicast sessions to upper layers.

### 5.3.5.6.2 SRB Release

The UE shall:
1> if srb3-ToRelease is included:
   2> release the PDCP entity and the srb-Identity of the SRB3;
1> if srb4-ToRelease is included
   2> release the PDCP entity and the srb-Identity of the SRB4.

### 5.3.5.6.3 SRB Addition/Modification

The UE shall:
1> If any DAPS bearer is configured, for each SRB:
   2> establish a PDCP entity for the target cell group as specified in TS 38.323 [5], with the same configuration as the PDCP entity for the source cell group;
   2> if the masterKey Update is received:
      3> configure the PDCP entity with the security algorithms according to securityConfig and apply the keys (K_{RRCenc} and K_{RRCint}) associated with the master key (K_{gNB});
   2> else:
      3> configure the PDCP entity for the target cell group with state variables continuation as specified in TS 38.323 [5], and with the same security configuration as the PDCP entity for the source cell group;
1> for each srb-Identity value included in the srb-ToAddModList that is not part of the current UE configuration (SRB establishment or reconfiguration from E-UTRA PDCP to NR PDCP):
   2> establish a PDCP entity;
   2> if AS security has been activated:
      3> if target RAT of handover is E-UTRA/5GC; or
      3> if the UE is connected to E-UTRA/5GC:
         4> if the UE is capable of E-UTRA/5GC, but not capable of NGEN-DC:
         5> configure the PDCP entity with the security algorithms and keys (K_{RRCenc} and K_{RRCint}) configured/derived as specified in TS 36.331 [10];
         4> else (i.e., UE capable of NGEN-DC):
         5> configure the PDCP entity with the security algorithms according to securityConfig and apply the keys (K_{RRCenc} and K_{RRCint}) associated with the master key (K_{eNB}) or secondary key (S-K_{gNB}) as indicated in keyToUse, if applicable;
      3> else (i.e., UE connected to NR or UE connected to E-UTRA/EPC):
         4> configure the PDCP entity with the security algorithms according to securityConfig and apply the keys (K_{RRCenc} and K_{RRCint}) associated with the master key (K_{eNB}/K_{gNB}) or secondary key (S-K_{gNB}) as indicated in keyToUse, if applicable;
   2> if the current UE configuration as configured by E-UTRA in TS 36.331 [10] includes an SRB identified with the same srb-Identity value:
      3> associate the E-UTRA RLC entity and DCCH of this SRB with the NR PDCP entity;
      3> release the E-UTRA PDCP entity of this SRB;
   2> if the pdcp-Config is included:
      3> configure the PDCP entity in accordance with the received pdcp-Config;
   2> else:
      3> configure the PDCP entity in accordance with the default configuration defined in 9.2.1 for the corresponding SRB;
1> if any DAPS bearer is configured, for each srb-Identity value included in the srb-ToAddModList that is part of the current UE configuration:
   2> if the pdcp-Config is included:
      3> reconfigure the PDCP entity for the target cell group in accordance with the received pdcp-Config;
1> else, for each srb-Identity value included in the srb-ToAddModList that is part of the current UE configuration:
NOTE X: This case does not apply when this procedure is initiated due to the generation of an LTM candidate cell configuration.
   2> if the reestablishPDCP is set:
      3> if target RAT of handover is E-UTRA/5GC; or
      3> if the UE is connected to E-UTRA/5GC:
         4> if the UE is capable of E-UTRA/5GC, but not capable of NGEN-DC:
         5> configure the PDCP entity to apply the integrity protection algorithm and K_{RRCint} key configured/derived as specified in TS 36.331 [10], i.e. the integrity protection configuration shall be applied to all subsequent messages received and sent by the UE, including the message used to indicate the successful completion of the procedure;
         5> configure the PDCP entity to apply the ciphering algorithm and K_{RRCenc} key configured/derived as specified in TS 36.331 [10], i.e. the ciphering configuration shall be applied to all subsequent messages received and sent by the UE, including the message used to indicate the successful completion of the procedure;
         4> else (i.e., a UE capable of NGEN-DC):
         5> configure the PDCP entity to apply the integrity protection algorithm and K_{RRCint} key associated with the master key (K_{eNB}) or secondary key (S-K_{gNB}), as indicated in keyToUse, i.e. the integrity protection configuration shall be applied to all subsequent messages received and sent by the UE, including the message used to indicate the successful completion of the procedure;
         5> configure the PDCP entity to apply the ciphering algorithm and K_{RRCenc} key associated with the master key (K_{eNB}) or secondary key (S-K_{gNB}) as indicated in keyToUse, i.e. the ciphering configuration shall be applied to all subsequent messages received and sent by the UE, including the message used to indicate the successful completion of the procedure;
      3> else (i.e., UE connected to NR or UE in EN-DC):
         4> configure the PDCP entity to apply the integrity protection algorithm and K_{RRCint} key associated with the master key (K_{eNB}/K_{gNB}) or secondary key (S-K_{gNB}), as indicated in keyToUse, i.e. the integrity protection configuration shall be applied to all subsequent messages received and sent by the UE, including the message used to indicate the successful completion of the procedure;
         4> configure the PDCP entity to apply the ciphering algorithm and K_{RRCenc} key associated with the master key (K_{eNB}/K_{gNB}) or secondary key (S-K_{gNB}) as indicated in keyToUse, i.e. the ciphering configuration shall be applied to all subsequent messages received and sent by the UE, including the message used to indicate the successful completion of the procedure;
      3> re-establish the PDCP entity of this SRB as specified in TS 38.323 [5];
   2> else, if the discardOnPDCP is set:
      3> trigger the PDCP entity to perform SDU discard as specified in TS 38.323 [5];
   2> if the pdcp-Config is included:
      3> reconfigure the PDCP entity in accordance with the received pdcp-Config.

### 5.3.5.6.4 DRB Release

The UE shall:
1> for each drb-Identity value included in the drb-ToReleaseList that is part of the current UE configuration; or
1> for each drb-Identity value that is to be released as the result of full configuration according to 5.3.5.11:
   2> release the PDCP entity and the drb-Identity;
   2> if SDAP entity associated with this DRB is configured:
      3> indicate the release of the DRB to SDAP entity associated with this DRB (TS 37.324 [24], clause 5.3.3);
   2> if the DRB is associated with an eps-BearerIdentity:
      3> if a new bearer is not added either with NR or E-UTRA with same eps-BearerIdentity:
         4> indicate the release of the DRB and the eps-BearerIdentity of the released DRB to upper layers.
NOTE 1: The UE does not consider the message as erroneous if the drb-ToReleaseList includes any drb-Identity value that is not part of the current UE configuration.
NOTE 2: Whether or not the RLC and MAC entities associated with this PDCP entity are reset or released is determined by the CellGroupConfig.

### 5.3.5.6.5 DRB Addition/Modification

The UE shall:
1> for each drb-Identity value included in the drb-ToAddModList that is not part of the current UE configuration (DRB establishment including the case when full configuration option is used):
   2> if this procedure is not initiated due to the generation of a complete LTM candidate cell configuration:
      3> establish a PDCP entity and configure it in accordance with the received pdcp-Config;
   2> if the PDCP entity of this DRB is not configured with cipheringDisabled:
      3> if target RAT of handover is E-UTRA/5GC; or
      3> if the UE is connected to E-UTRA/5GC:
         4> if the UE is capable of E-UTRA/5GC but not capable of NGEN-DC:
         5> configure the PDCP entity with the ciphering algorithm and K_{UPenc} key configured/derived as specified in TS 36.331 [10];
         4> else (i.e., a UE capable of NGEN-DC):
         5> configure the PDCP entity with the ciphering algorithms according to securityConfig and apply the key (K_{UPenc}) associated with the master key (K_{eNB}) or secondary key (S-K_{gNB}) as indicated in keyToUse, if applicable;
      3> else (i.e., UE connected to NR or UE connected to E-UTRA/EPC):
         4> configure the PDCP entity with the ciphering algorithms according to securityConfig and apply the K_{Upenc} key associated with the master key (K_{eNB}/K_{gNB}) or the secondary key (S-K_{gNB}/S-K_{eNB}) as indicated in keyToUse;
   2> if the PDCP entity of this DRB is configured with integrityProtection:
      3> configure the PDCP entity with the integrity protection algorithms according to securityConfig and apply the K_{UPint} key associated with the master (K_{eNB}/K_{gNB}) or the secondary key (S-K_{gNB}) as indicated in keyToUse;
   2> if an sdap-Config is included:
      3> if an SDAP entity with the received pdu-Session does not exist:
         4> establish an SDAP entity as specified in TS 37.324 [24] clause 5.1.1;
         4> if an SDAP entity with the received pdu-Session did not exist prior to receiving this reconfiguration:
         5> indicate the establishment of the user plane resources for the pdu-Session to upper layers;
      3> configure the SDAP entity in accordance with the received sdap-Config as specified in TS 37.324 [24] and associate the DRB with the SDAP entity;
      3> for each QFI value added in mappedQoS-FlowsToAdd, if the QFI value is previously configured, the QFI value is released from the old DRB;
   2> if the DRB is associated with an eps-BearerIdentity:
      3> if the DRB was configured with the same eps-BearerIdentity either by NR or E-UTRA prior to receiving this reconfiguration:
         4> associate the established DRB with the corresponding eps-BearerIdentity;
      3> else:
         4> indicate the establishment of the DRB(s) and the eps-BearerIdentity of the established DRB(s) to upper layers;
1> for each drb-Identity value included in the drb-ToAddModList that is part of the current UE configuration and configured as DAPS bearer:
NOTE X: This case does not apply when this procedure is initiated due to the generation of an LTM candidate cell configuration.
   2> reconfigure the PDCP entity to configure DAPS with the ciphering function, integrity protection function and ROHC function of the target cell group as specified in TS 38.323 [5] and configure it in accordance with the received pdcp-Config;
   2> if the masterKey Update is received:
      3> if the ciphering function of the target cell group PDCP entity is not configured with cipheringDisabled:
         4> configure the ciphering function of the target cell group PDCP entity with the ciphering algorithm according to securityConfig and apply the K_{UPenc} key associated with the master key (K_{gNB}), as indicated in keyToUse, i.e. the ciphering configuration shall be applied to all subsequent PDCP PDUs received from the target cell group and sent to the target cell group by the UE;
      3> if the integrity protection function of the target cell group PDCP entity is configured with integrityProtection:
         4> configure the integrity protection function of the target cell group PDCP entity with the integrity protection algorithms according to securityConfig and apply the K_{UPint} key associated with the master key (K_{gNB}) as indicated in keyToUse;
   2> else:
      3> configure the ciphering function and the integrity protection function of the target cell group PDCP entity with the same security configuration as the PDCP entity for the source cell group;
   2> if the sdap-Config is included and when indication of successful completion of random access towards target cell is received from lower layers as specified in [3]:
      3> reconfigure the SDAP entity in accordance with the received sdap-Config as specified in TS 37.324 [24];
      3> for each QFI value added in mappedQoS-FlowsToAdd, if the QFI value is previously configured, the QFI value is released from the old DRB;
1> for each drb-Identity value included in the drb-ToAddModList that is part of the current UE configuration and not configured as DAPS bearer:
   2> if the reestablishPDCP is set:
      3> if target RAT of handover is E-UTRA/5GC; or
      3> if the UE is connected to E-UTRA/5GC:
         4> if the UE is capable of E-UTRA/5GC but not capable of NGEN-DC:
         5> if the PDCP entity of this DRB is not configured with cipheringDisabled:
         6> configure the PDCP entity with the ciphering algorithm and K_{UPenc} key configured/derived as specified in TS 36.331 [10], clause 5.4.2.3, i.e. the ciphering configuration shall be applied to all subsequent PDCP PDUs received and sent by the UE;
         4> else (i.e., a UE capable of NGEN-DC):
         5> if the PDCP entity of this DRB is not configured with cipheringDisabled:
         6> configure the PDCP entity with the ciphering algorithm and K_{UPenc} key associated with the master key (K_{eNB}) or the secondary key (S-K_{gNB}), as indicated in keyToUse, i.e. the ciphering configuration shall be applied to all subsequent PDCP PDUs received and sent by the UE;
      3> else (i.e., UE connected to NR or UE connected to E-UTRA/EPC (in EN-DC or capable of EN-DC)):
         4> if the PDCP entity of this DRB is not configured with cipheringDisabled.
         5> configure the PDCP entity with the ciphering algorithm and K_{Upenc} key associated with the master key (K_{eNB}/K_{gNB}) or the secondary key (S-K_{gNB}/S-K_{eNB}), as indicated in keyToUse, i.e. the ciphering configuration shall be applied to all subsequent PDCP PDUs received and sent by the UE;
         4> if the PDCP entity of this DRB is configured with integrityProtection:
         5> configure the PDCP entity with the integrity protection algorithms according to securityConfig and apply the K_{UPint} key associated with the master key (K_{eNB}/K_{gNB}) or the secondary key (S-K_{gNB}) as indicated in keyToUse;
      3> if drb-ContinueROHC is included in pdcp-Config:
         4> indicate to lower layer that drb-ContinueROHC is configured;
      3> if drb-ContinueEHC-DL is included in pdcp-Config:
         4> indicate to lower layer that drb-ContinueEHC-DL is configured;
      3> if drb-ContinueEHC-UL is included in pdcp-Config:
         4> indicate to lower layer that drb-ContinueEHC-UL is configured;
      3> if drb-ContinueUDC is included in pdcp-Config:
         4> indicate to lower layer that drb-ContinueUDC is configured;
      3> re-establish the PDCP entity of this DRB as specified in TS 38.323 [5], clause 5.1.2;
   2> else, if the recoverPDCP is set:
      3> trigger the PDCP entity of this DRB to perform data recovery as specified in TS 38.323 [5];
   2> if the pdcp-Config is included:
      3> reconfigure the PDCP entity in accordance with the received pdcp-Config.
   2> if the sdap-Config is included:
      3> reconfigure the SDAP entity in accordance with the received sdap-Config as specified in TS37.324 [24];
      3> for each QFI value added in mappedQoS-FlowsToAdd, if the QFI value is previously configured, the QFI value is released from the old DRB;
NOTE 1: Void.
NOTE 2: When determining whether a drb-Identity value is part of the current UE configuration, the UE does not distinguish which RadioBearerConfig and DRB-ToAddModList that DRB was originally configured in. To re-associate a DRB with a different key (K_{eNB} to S-K_{gNB}, K_{gNB} to S-K_{eNB}, K_{gNB} to S-K_{gNB}, or vice versa), the network provides the drb-Identity value in the (target) drb-ToAddModList and sets the reestablishPDCP flag. The network does not list the drb-Identity in the (source) drb-ToReleaseList.
NOTE 3: When setting the reestablishPDCP flag for a radio bearer, the network ensures that the RLC receiver entities do not deliver old PDCP PDUs to the re-established PDCP entity. It does that e.g. by triggering a reconfiguration with sync of the cell group hosting the old RLC entity or by releasing the old RLC entity.
NOTE 4: In this specification, UE configuration refers to the parameters configured by NR RRC unless otherwise stated.
NOTE 5: Ciphering and integrity protection can be enabled or disabled for a DRB. The enabling/disabling of ciphering or integrity protection can be changed only by releasing and adding the DRB.
NOTE 6: In DAPS handover, the UE may perform PDCP entity re-establishment (if reestablishPDCP is set) or the PDCP data recovery (if recoverPDCP is set) for a non-DAPS bearer when indication of successful completion of random access towards target cell is received from lower layers as specified in TS 38.321 [3]. In this case, the UE suspends data transmission and reception for all non-DAPS bearers in the source MCG for duration of the DAPS handover.

### 5.3.5.x LTM Configuration and Execution

### 5.3.5.x.1 General

The UE shall perform the following actions based on a received LTM-CandidateConfig IE:
1> store the received ltm-ReferenceConfiguration in VarLTM-Config, if present;
1> if the LTM-CandidateConfig includes the ltm-CandidateToReleaseList:
   2> perform the LTM candidate cell release as specified in 5.3.5.x.2;
1> if the LTM-CandidateConfig includes the ltm-CandidateResetL2-List:
   2> add the received ltm-CandidateResetL2-List to VarLTM-Config;
1> if the LTM-CandidateConfig includes the ltm-CandidateToAddModList:
   2> perform the LTM candidate cell addition or reconfiguration as specified in 5.3.5.x.3;
1> perform the actions to generate a complete LTM configuration as specified in 5.3.5.x.4;
NOTE X: It is up to the UE implementation to postpone the generation of a complete LTM configuration until the executing of an LTM cell switch.
Editor's Note: FFS on whether the UE performs the compliance check of the reference and LTM candidate cell configuration upon their reception of upon the execution of the LTM cell switch.
Editor's Note: FFS on how and whether to indicate that no RACH is needed for an LTM candidate cell.
Editor's Note: FFS on how UE should establish the TA for a LTM candidate cell.

### 5.3.5.x.2 LTM Candidate Cell Release

The UE shall:
1> for each ltm-CandidateId in the ltm-CandidateToReleaseList:
   2> if the current VarLTM-Config includes an ltm-Candidate with the given ltm-CandidateId:
      3> release the ltm-Candidate from VarLTM-Config;

### 5.3.5.x.3 LTM Candidate Cell Addition/Modification

The UE shall:
1> for each ltm-CandidateId in the ltm-CandidateToAddModList:
   2> if the current VarLTM-Config includes an ltm-Candidate with the given ltm-CandidateId:
      3> modify the ltm-Candidate within VarLTM-Config in accordance with the received ltm-Candidate;
   2> else:
      3> add the received ltm-Candidate to VarLTM-Config.

### 5.3.5.x.4 Generation of UE LTM Configuration

The purpose of this procedure is for the UE to generate a complete LTM candidate cell configuration to be stored and applied only when an indication of an LTM cell switch is received by lower layers. During the generation of a complete LTM candidate cell configuration, the current UE configuration is not modified.

The UE shall:
1> for each ltm-Candidate in ltm-CandidateConfigList within VarLTM-Config;
   2> store the ltm-CandidateId included in ltm-Candidate within VarLTM-UE-Config;
   2> if ltm-Candidate includes ltm-ConfigComplete;
      3> generate a complete LTM candidate cell configuration for the received ltm-Candidate according to the actions described in clause 5.3.5.3 and store it in ue-LTM-Config within VarLTM-UE-Config.
   2> else:
      3> generate a complete LTM candidate cell configuration by applying ltm-Candidate on top of referenceConfiguration according to the actions described in clause 5.3.5.3 and store it in ue-LTM-Config within VarLTM-UE-Config.
Editor's Note: FFS on the need of ltm-ConfigComplete to indicate to the UE that the LTM candidate cell configuration in ltm-Candidate is a full configuration.
Editor's Note: FFS on whether we need to rely on the full configuration procedure or a new procedure for LTM is created when the UE generates a complete LTM candidate cell configuration.

### 5.3.5.x.5 LTM Cell Switch Execution

Upon the indication by lower layers that an LTM cell switch procedure is triggered, the UE shall:
1> release/clear all current dedicated radio configuration except for the following:
   2> if the LTM cell switch is triggered on the MCG:
      the MCG C-RNTI;
      the AS security configurations associated with the master key;
   2> else, if the LTM cell switch is triggered on the SCG:
      the SCG C-RNTI;
      the AS security configurations associated with the secondary key;
      the SRB1/SRB2 configurations and DRB configurations as configured by radioBearerConfig or radioBearerConfig2;
Editor's Note: FFS on whether the radio bearer needs to be kept when execution the LTM cell switch.
   the UE variables VarLTM-Config and VarLTM-UE-Config.
1> release/clear all current common radio configuration;
1> use the default values specified in 9.2.3 for timers T310, T311 and constants N310, N311;
1> apply the default L1 parameter values as specified in corresponding physical layer specifications except for the following:
   parameters for which values are provided in SIB1;
1> apply the value of the new UE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> apply the default MAC Cell Group configuration as specified in 9.2.2;
1> configure the PDCP entity for LTM candidate cell configuration indicated by lower layers with state variables continuation as specified in TS 38.323 [5], and with the same security configuration as the PDCP entity for the source cell group;
1> stop timer T310 for the corresponding SpCell, if running;
1> if this procedure is executed for the MCG:
   2> if timer T316 is running;
      3> stop timer T316;
1> stop timer T312 for the corresponding SpCell, if running;
1> apply the specified BCCH configuration defined in 9.1.1.1 for the target SpCell;
1> acquire the MIB of the target SpCell as indicated in the LTM candidate cell configuration indicated by lower layers, which is scheduled as specified in TS 38.213 [13], if applicable;
1> apply the LTM configuration in UE-LTM-Config within VarLTM-UE-Config related to the LTM candidate cell configuration identity as received by lower layers.
1> submit the RRCReconfigurationComplete message lower layers for transmission using the new configuration.
Editor's Note: FFS on whether the sending of the RRCReconfigurationComplete message should be triggered in this section or in section 5.3.5.3 (i.e., Reception of an RRCReconfiguration by the UE).
Editor's Note: FFS on whether further UE actions need to be specified for e.g., subsequent LTM cell switch or interaction with lower layers.
Editor's Note: FFS on the UE actions (for no L2 reset) based on ltm-CandidateNoResetL2-List.
Editor's Note: FFS on how and whether to indicate that no RACH is needed for an LTM candidate cell.
Editor's Note: FFS on how to handle the TA (and when the UE has no TA) in the source cell (in case no RACH is performed) upon an LTM cell switch and whether this should be specified in RRC or MAC.
Editor's Note: FFS on the supervision timer for the LTM cell switch.
Editor's Note: FFS on how to provide the UL grant to the UE in case no RACH is performed during the LTM cell switch.

### 6.2 RRC Messages

### 6.2.2 Message Definitions

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

-- ASN1START
-- TAG-RRCRECONFIGURATION-START

| RRCReconfiguration ::= | SEQUENCE { | |
|---|---|---|
| rrc-TransactionIdentifier | RRC-TransactionIdentifier, | |
| criticalExtensions | CHOICE { | |
| rrcReconfiguration | RRCReconfiguration-IEs, | |
| criticalExtensionsFuture | SEQUENCE { } | |
| } | | |
| } | | |
| RRCReconfiguration-Ies ::= | SEQUENCE { | |
| radioBearerConfig | RadioBearerConfig | |
| OPTIONAL, -- Need M | | |
| secondaryCellGroup | OCTET STRING (CONTAINING CellGroupConfig) | |
| OPTIONAL, -- Cond SCG | | |
| measConfig | MeasConfig | OPTIONAL, -- |
| Need M | | |
| lateNonCriticalExtension | OCTET STRING | |
| OPTIONAL, | | |
| nonCriticalExtension | RRCReconfiguration-v1530-Ies | |
| OPTIONAL | | |

}

| RRCReconfiguration-v1530-Ies ::= | SEQUENCE { | |
|---|---|---|
| masterCellGroup | OCTET STRING (CONTAINING CellGroupConfig) | |
| OPTIONAL, -- Need M | | |
| fullConfig | ENUMERATED { true } | |
| OPTIONAL, -- Cond FullConfig | | |
| dedicatedNAS-MessageList | SEQUENCE (SIZE(1..maxDRB)) OF DedicatedNAS- | |
| Message OPTIONAL, -- Cond nonHO | | |
| masterKeyUpdate | MasterKeyUpdate | |
| OPTIONAL, -- Cond MasterKeyChange | | |
| dedicatedSIB1-Delivery | OCTET STRING (CONTAINING SIB1) | |
| OPTIONAL, -- Need N | | |
| dedicatedSystemInformationDelivery | OCTET STRING (CONTAINING SystemInformation) | |
| OPTIONAL, -- Need N | | |
| otherConfig | OtherConfig | OPTIONAL, -- |
| Need M | | |
| nonCriticalExtension | RRCReconfiguration-v1540-Ies | |
| OPTIONAL | | |
| } | | |
| RRCReconfiguration-v1540-Ies ::= | SEQUENCE { | |
| otherConfig-v1540 | OtherConfig-v1540 | |
| OPTIONAL, -- Need M | | |
| nonCriticalExtension | RRCReconfiguration-v1560-Ies | |
| OPTIONAL | | |
| } | | |
| RRCReconfiguration-v1560-Ies ::= | SEQUENCE { | |
| mrdc-SecondaryCellGroupConfig | SetupRelease { MRDC-SecondaryCellGroupConfig } | |
| OPTIONAL, -- Need M | | |
| radioBearerConfig2 | OCTET STRING (CONTAINING RadioBearerConfig) | |
| OPTIONAL, -- Need M | | |
| sk-Counter | SK-Counter | OPTIONAL, -- |
| Need N | | |
| nonCriticalExtension | RRCReconfiguration-v1610-Ies | |
| OPTIONAL | | |
| } | | |
| RRCReconfiguration-v1610-Ies ::= | SEQUENCE { | |
| otherConfig-v1610 | OtherConfig-v1610 | |
| OPTIONAL, -- Need M | | |
| bap-Config-r16 | SetupRelease { BAP-Config-r16 } | |
| OPTIONAL, -- Need M | | |
| iab-IP-AddressConfigurationList-r16 | IAB-IP-AddressConfigurationList-r16 | |
| OPTIONAL, -- Need M | | |
| conditionalReconfiguration-r16 | ConditionalReconfiguration-r16 | |
| OPTIONAL, -- Need M | | |
| daps-SourceRelease-r16 | ENUMERATED { true } | |
| OPTIONAL, -- Need N | | |
| t316-r16 | SetupRelease {T316-r16} | OPTIONAL, - |
| - Need M | | |
| needForGapsConfigNR-r16 | SetupRelease {NeedForGapsConfigNR-r16} | |
| OPTIONAL, -- Need M | | |
| onDemandSIB-Request-r16 | SetupRelease { OnDemandSIB-Request-r16 } | |
| OPTIONAL, -- Need M | | |
| dedicatedPosSysInfoDelivery-r16 | OCTET STRING (CONTAINING | |
| PosSystemInformation-r16-Ies) | OPTIONAL, -- Need N | |
| sl-ConfigDedicatedNR-r16 | SetupRelease {SL-ConfigDedicatedNR-r16} | |
| OPTIONAL, -- Need M | | |
| sl-ConfigDedicatedEUTRA-Info-r16 | SetupRelease {SL-ConfigDedicatedEUTRA-Info-r16} | |
| OPTIONAL, -- Need M | | |
| targetCellSMTC-SCG-r16 | SSB-MTC | |
| OPTIONAL, -- Need S | | |
| nonCriticalExtension | RRCReconfiguration-v1700-Ies | |
| OPTIONAL | | |
| } | | |
| RRCReconfiguration-v1700-Ies ::= | SEQUENCE { | |
| otherConfig-v1700 | OtherConfig-v1700 | OPTIONAL, -- |
| Need M | | |
| sl-L2RelayUE-Config-r17 | SetupRelease { SL-L2RelayUE-Config-r17 } | |
| OPTIONAL, -- Need M | | |
| sl-L2RemoteUE-Config-r17 | SetupRelease { SL-L2RemoteUE-Config-r17 } | |
| OPTIONAL, -- Need M | | |
| dedicatedPagingDelivery-r17 | OCTET STRING (CONTAINING Paging) | |
| OPTIONAL, -- Cond PagingRelay | | |
| needForGapNCSG-ConfigNR-r17 | SetupRelease {NeedForGapNCSG-ConfigNR-r17} | |
| OPTIONAL, -- Need M | | |
| needForGapNCSG-ConfigEUTRA-r17 | SetupRelease {NeedForGapNCSG-ConfigEUTRA- | |
| r17} OPTIONAL, -- Need M | | |
| musim-GapConfig-r17 | SetupRelease {MUSIM-GapConfig-r17} | |
| OPTIONAL, -- Need M | | |
| ul-GapFR2-Config-r17 | SetupRelease { UL-GapFR2-Config-r17 } | |
| OPTIONAL, -- Need M | | |
| scg-State-r17 | ENUMERATED { deactivated } | |
| OPTIONAL, -- Need N | | |
| appLayerMeasConfig-r17 | AppLayerMeasConfig-r17 | |
| OPTIONAL, -- Need M | | |
| ue-TxTEG-RequestUL-TDOA-Config-r17 | SetupRelease {UE-TxTEG-RequestUL-TDOA- | |
| Config-r17} OPTIONAL, -- Need M | | |
| nonCriticalExtension | RRCReconfiguration-v18xy | |
| OPTIONAL | | |
| } | | |
| RRCReconfiguration-v18xy-Ies ::= | SEQUENCE { | |
| ltm-CandidateConfig-r18 | SetupRelease {LTM-CandidateConfig-r18} | |
| OPTIONAL, -- Need M | | |
| nonCriticalExtension | SEQUENCE { } | OPTIONAL |
| } | | |
| MRDC-SecondaryCellGroupConfig ::= | SEQUENCE { | |
| mrdc-ReleaseAndAdd | ENUMERATED { true } | |
| OPTIONAL, -- Need N | | |
| mrdc-SecondaryCellGroup | CHOICE { | |
| nr-SCG | OCTET STRING (CONTAINING RRCReconfiguration), | |
| eutra-SCG | OCTET STRING | |
| } | | |
| } | | |
| BAP-Config-r16 ::= | SEQUENCE { | |
| bap-Address-r16 | BIT STRING (SIZE (10)) | OPTIONAL, -- |
| Need M | | |
| defaultUL-BAP-RoutingID-r16 | BAP-RoutingID-r16 | |
| OPTIONAL, -- Need M | | |
| defaultUL-BH-RLC-Channel-r16 | BH-RLC-ChannelID-r16 | |
| OPTIONAL, -- Need M | | |
| flowControlFeedbackType-r16 | ENUMERATED {perBH-RLC-Channel, perRoutingID, | |
| both } OPTIONAL, -- Need R | | |
| ... | | |
| } | | |
| MasterKey Update ::= | SEQUENCE { | |
| keySetChangeIndicator | BOOLEAN, | |
| nextHopChainingCount | NextHopChainingCount, | |
| nas-Container | OCTET STRING | OPTIONAL, -- |

| | |
|---|---|
| Cond securityNASC | |
| ... | |
| } | |
| OnDemandSIB-Request-r16 ::= | SEQUENCE { |
| onDemandSIB-RequestProhibitTimer-r16 | ENUMERATED {s0, s0dot5, s1, s2, s5, s10, s20, |

```
s30}
}
T316-r16 ::=  ENUMERATED {ms50, ms100, ms200, ms300, ms400, ms500, ms600, ms1000,
ms1500, ms2000}
IAB-IP-AddressConfigurationList-r16 ::= SEQUENCE {
  iab-IP-AddressToAddModList-r16  SEQUENCE (SIZE(1..maxIAB-IP-Address-r16)) OF
IAB-IP-AddressConfiguration-r16 OPTIONAL, -- Need N
  iab-IP-AddressToReleaseList-r16  SEQUENCE (SIZE(1..maxIAB-IP-Address-r16)) OF IAB-
IP-AddressIndex-r16  OPTIONAL, -- Need N
  ...
}
```

| IAB-IP-AddressConfiguration-r16 ::= | SEQUENCE { | |
|---|---|---|
| iab-IP-AddressIndex-r16 | IAB-IP-AddressIndex-r16, | |
| iab-IP-Address-r16 | IAB-IP-Address-r16 | OPTIONAL, |
| -- Need M | | |
| iab-IP-Usage-r16 | IAB-IP-Usage-r16 | OPTIONAL, - |

| | |
|---|---|
| - Need M | |
| iab-donor-DU-BAP-Address-r16 | BIT STRING (SIZE(10)) |
| OPTIONAL, -- Need M | |
| ... | |
| } | |
| SL-ConfigDedicatedEUTRA-Info-r16 ::= | SEQUENCE { |
| sl-ConfigDedicatedEUTRA-r16 | OCTET STRING |
| OPTIONAL, -- Need M | |
| sl-TimeOffsetEUTRA-List-r16 | SEQUENCE (SIZE (8)) OF SL-TimeOffsetEUTRA- |
| r16 OPTIONAL -- Need M | |
| } | |
| SL-TimeOffsetEUTRA-r16 ::= | ENUMERATED {ms0, ms0dot25, ms0dot5, ms0dot625, |

```
ms0dot75, ms1, ms1dot25, ms1dot5, ms1dot75,
                    ms2, ms2dot5, ms3, ms4, ms5, ms6, ms8, ms10, ms20}
UE-TxTEG-RequestUL-TDOA-Config-r17 ::= CHOICE {
  oneShot-r17  NULL,
  periodicReporting-r17  ENUMERATED { ms160, ms320, ms1280, ms2560, ms61440,
ms81920, ms368640, ms737280 }
}
-- TAG-RRCRECONFIGURATION-STOP
-- ASN1STOP
```

RRCReconfiguration-Ies field descriptions

appLayerMeasConfig
This field is used to configure application layer measurements. This field is absent when the UE
is configured to operate with shared spectrum channel access.
Bap-Config
This field is used to configure the BAP entity for IAB nodes.
Bap-Address
Indicates the BAP address of an IAB-node. The BAP address of an IAB-node cannot be changed
once configured for the cell group to the BAP entity.
conditionalReconfiguration
Configuration of candidate target SpCell(s) and execution condition(s) for conditional handover,
conditional PSCell addition or conditional PSCell change. The field is absent if any DAPS bearer
is configured or if the masterCellGroup includes ReconfigurationWithSync or if the sl-
L2RemoteUE-Config or sl-L2RelayUE-Config is configured. For conditional PSCell change, the
field is absent if the secondaryCellGroup includes ReconfigurationWithSync. The
RRCReconfiguration message contained in DLInformationTransferMRDC cannot contain the
field conditionalReconfiguration for conditional PSCell change or for conditional PSCell
addition.
Daps-SourceRelease
Indicates to UE that the source cell part of DAPS operation is to be stopped and the source cell
part of DAPS configuration is to be released.
dedicatedNAS-MessageList
This field is used to transfer UE specific NAS layer information between the network and the UE.
The RRC layer is transparent for each PDU in the list.
dedicatedPagingDelivery
This field is used to transfer Paging message for the associated L2 U2N Remote UE to the L2
U2N Relay UE in RRC_CONNECTED.
dedicatedPosSysInfoDelivery
This field is used to transfer SIBPos to the UE in RRC_CONNECTED.
dedicatedSIB1-Delivery
This field is used to transfer SIBI to the UE (including L2 U2N Remote UE). The field has the
same values as the corresponding configuration in servingCellConfigCommon.
dedicatedSystemInformationDelivery
This field is used to transfer SIB6, SIB7, SIB8, SIB19, SIB21 to the UE with an active BWP with
no common search space configured or the L2 U2N Remote UE in RRC_CONNECTED. For Ues
in RRC_CONNECTED (including L2 U2N Remote UE), this field is also used to transfer the
SIBs requested on-demand.
defaultUL-BAP-RoutingID
This field is used for IAB-node to configure the default uplink Routing ID, which is used by IAB-
node during IAB-node bootstrapping, migration, IAB-MT RRC resume and IAB-MT RRC re-
establishment for F1-C and non-F1 traffic. The defaultUL-BAP-RoutingID can be (re-)configured
when IAB-node IP address for F1-C related traffic changes. This field is mandatory only for
IAB-node bootstrapping.
defaultUL-BH-RLC-Channel
This field is used for IAB-nodes to configure the default uplink BH RLC channel, which is used
by IAB-node during IAB-node bootstrapping, migration, IAB-MT RRC resume and IAB-MT
RRC re-establishment for F1-C and non-F1 traffic. The defaultUL-BH-RLC-Channel can be
(re-)configured when IAB-node IP address for F1-C related traffic changes, and the new IP
address is anchored at a different IAB-donor-DU. This field is mandatory for IAB-node
bootstrapping. If the IAB-MT is operating in EN-DC, the default uplink BH RLC channel is
referring to an RLC channel on the SCG; Otherwise, it is referring to an RLC channel either on
the MCG or on the SCG depending on whether the MN or the SN configures this field.
flowControlFeedbackType
This field is only used for IAB-node that support hop-by-hop flow control to configure the type
of flow control feedback. Value perBH-RLC-Channel indicates that the IAB-node shall provide
flow control feedback per BH RLC channel, value perRoutingID indicates that the IAB-node
shall provide flow control feedback per routing ID, and value both indicates that the IAB-node
shall provide flow control feedback both per BH RLC channel and per routing ID.
fullConfig
Indicates that the full configuration option is applicable for the RRCReconfiguration message for
intra-system intra-RAT HO. For inter-RAT HO from E-UTRA to NR, fullConfig indicates
whether or not delta signalling of SDAP/PDCP from source RAT is applicable. This field is
absent if any DAPS bearer is configured or when the RRCReconfiguration message is transmitted
on SRB3, and in an RRCReconfiguration message for SCG contained in another
RRCReconfiguration message (or RRCConnectionReconfiguration message, see TS 36.331 [10])
transmitted on SRB1.
Iab-IP-Address
This field is used to provide the IP address information for IAB-node.
Iab-IP-AddressIndex
This field is used to identify a configuration of an IP address.
Iab-IP-AddressToAddModList
List of IP addresses allocated for IAB-node to be added and modified.
Iab-IP-AddressToReleaseList
List of IP address allocated for IAB-node to be released.
Iab-IP-Usage
This field is used to indicate the usage of the assigned IP address. If this field is not configured,
the assigned IP address is used for all traffic.
Iab-donor-DU-BAP-Address
This field is used to indicate the BAP address of the IAB-donor-DU where the IP address is
anchored.
keySetChangeIndicator
Indicates whether UE shall derive a new K_{gNB}. If reconfigurationWithSync is included, value true
indicates that a K_{gNB} key is derived from a K_{AMF} key taken into use through the latest successful
NAS SMC procedure, or N2 handover procedure with K_{AMF} change, as described in TS 33.501
[11] for K_{gNB} re-keying. Value false indicates that the new K_{gNB} key is obtained from the current
K_{gNB} key or from the NH as described in TS 33.501 [11].
Ltm-CandidateConfig
Configuration of LTM candidate cell(s), reference configuration for LTM cell(s) and sets of cells
in which full L2 reset is applied upon an LTM cell switch.
masterCellGroup
Configuration of master cell group.
Mrdc-ReleaseAndAdd
This field indicates that the current SCG configuration is released and a new SCG is added at the
same time.
Mrdc-SecondaryCellGroup
Includes an RRC message for SCG configuration in NR-DC or NE-DC.
For NR-DC (nr-SCG), mrdc-SecondaryCellGroup contains the RRCReconfiguration message as
generated (entirely) by SN gNB. In this version of the specification, the RRC message can only
include fields secondaryCellGroup, otherConfig, conditionalReconfiguration, measConfig, bap-
Config and IAB-IP-AddressConfigurationList.
For NE-DC (eutra-SCG), mrdc-SecondaryCellGroup includes the E-UTRA
RRCConnectionReconfiguration message as specified in TS 36.331 [10]. In this version of the
specification, the E-UTRA RRC message can only include the field scg-Configuration.
Musim-GapConfig
Indicates the MUSIM gap configuration and controls setup/release of MUSIM gaps. In this
version of the specification, the network does not configure MUSIM gap together with concurrent
measurement gap or preconfigured measurement gap for positioning.
Nas-Container
This field is used to transfer UE specific NAS layer information between the network and the UE.
The RRC layer is transparent for this field, although it affects activation of AS security after
inter-system handover to NR. The content is defined in TS 24.501 [23].
needForGapsConfigNR
Configuration for the UE to report measurement gap requirement information of NR target bands
in the RRCReconfigurationComplete and RRCResumeComplete message.
needForGapNCSG-ConfigEUTRA
Configuration for the UE to report measurement gap and NCSG requirement information of
E-UTRA target bands in the RRCReconfigurationComplete and RRCResumeComplete message.
needForGapNCSG-ConfigNR
Configuration for the UE to report measurement gap and NCSG requirement information of NR
target bands in the RRCReconfigurationComplete and RRCResumeComplete message.
nextHopChainingCount
Parameter NCC: See TS 33.501 [11]
onDemandSIB-Request
If the field is present, the UE is allowed to request SIB(s) on-demand while in
RRC_CONNECTED according to clause 5.2.2.3.5.
onDemandSIB-RequestProhibitTimer
Prohibit timer for requesting SIB(s) on-demand while in RRC_CONNECTED according to
clause 5.2.2.3.5. Value in seconds. Value s0 means prohibit timer is set to 0 seconds, value
s0dot5 means prohibit timer is set to 0.5 seconds, value s1 means prohibit timer is set to 1 second
and so on.
otherConfig
Contains configuration related to other configurations. When configured for the SCG, only fields
drx-PreferenceConfig, maxBW-PreferenceConfig, maxBW-PreferenceConfigFR2-2, maxCC-
PreferenceConfig, maxMIMO-LayerPreferenceConfig, maxMIMO-LayerPreferenceConfigFR2-
2, minSchedulingOffsetPreferenceConfig, minSchedulingOffsetPreferenceConfigExt, rlm-
RelaxationReportingConfig, bfd-RelaxationReportingConfig, btNameList, wlanNameList,
sensorNameList and obtainCommonLocation can be included.
radioBearerConfig
Configuration of Radio Bearers (DRBs, SRBs, multicast MRBs) including SDAP/PDCP. In
(NG)EN-DC this field may only be present if the RRCReconfiguration is transmitted over SRB3.
radioBearerConfig2
Configuration of Radio Bearers (DRBs, SRBs) including SDAP/PDCP. This field can only be
used if the UE supports NR-DC or NE-DC.
Scg-State
Indicates that the SCG is in deactivated state.
This field is not used

| | |
|---|---|
| - | in an RRCReconfiguration message received: |
| | - within mrdc-SecondaryCellGroup, or |
| | - in an E-UTRA RRCConnectionReconfiguration message, or |
| | - in an E-UTRA RRCConnectionResume message or |
| - | in an RRCReconfiguration message received via SRB3, except if the RRCReconfiguration |
| | message is included in DLInformationTransferMRDC. |

The field is absent if CPA or CPC is configured for the UE, or if the RRCReconfiguration
message is contained in CondRRCReconfig.
Sl-L2RelayUE-Config
Contains L2 U2N relay operation related configurations used by a UE acting as or to be acting as
a L2 U2N Relay UE. The field is absent if conditionalReconfiguration is configured for CHO.
Sl-L2Remote UE-Config
Contains L2 U2N relay operation related configurations used by a UE acting as or to be acting as
a L2 U2N Remote UE. The field is absent if conditionalReconfiguration is configured for CHO,
or if appLayerMeasConfig or SRB4 is configured/not released.
secondaryCellGroup
Configuration of secondary cell group ((NG)EN-DC or NR-DC).
Sk-Counter
A counter used upon initial configuration of S-K_{gNB} or S-K_{eNB}, as well as upon refresh of S-K_{gNB}
or S-K_{eNB}. This field is always included either upon initial configuration of an NR SCG or upon
configuration of the first RB with keyToUse set to secondary, whichever happens first. This field
is absent if there is neither any NR SCG nor any RB with keyToUse set to secondary.
Sl-ConfigDedicatedNR
This field is used to provide the dedicated configurations for NR sidelink
communication/discovery.
Sl-ConfigDedicatedEUTRA-Info
This field includes the E-UTRA RRCConnectionReconfiguration as specified in TS 36.331 [10].
In this version of the specification, the E-UTRA RRCConnectionReconfiguration can only
includes sidelink related fields for V2X sidelink communication, i.e. sl-V2X-ConfigDedicated, sl-
V2X-SPS-Config, measConfig and/or otherConfig.
Sl-TimeOffsetEUTRA
This field indicates the possible time offset to (de)activation of V2X sidelink transmission after
receiving DCI format 3_1 used for scheduling V2X sidelink communication. Value ms0dpt75
corresponds to 0.75ms, ms1 corresponds to 1ms and so on. The network includes this field only
when sl-ConfigDedicatedEUTRA is configured.
targetCellSMTC-SCG
The SSB periodicity/offset/duration configuration of target cell for NR PSCell addition and SN
change. When UE receives this field, UE applies the configuration based on the timing reference
of NR Pcell for PSCell addition and PSCell change for the case of no reconfiguration with sync
of MCG, and UE applies the configuration based on the timing reference of target NR Pcell for
the case of reconfiguration with sync of MCG. If both this field and the smtc in
secondaryCellGroup -> SpCellConfig -> reconfigurationWithSync are absent, the UE uses the
SMTC in the measObjectNR having the same SSB frequency and subcarrier spacing, as
configured before the reception of the RRC message.
T316
Indicates the value for timer T316 as described in clause 7.1. Value ms50 corresponds to 50 ms,
value ms100 corresponds to 100 ms and so on. This field can be configured only if the UE is
configured with split SRB1 or SRB3.
Ue-TxTEG-RequestUL-TDOA-Config
Configures the periodicity of UE reporting for the association between Tx TEG and SRS
Positioning resources. When configured with oneShot UE reports the association only one time.
When configured with periodicReporting UE reports the association periodically and the
periodicReporting indicates the periodicity. Value ms160 corresponds to 160ms, value ms320
corresponds to 320ms and so on.
Ul-GapFR2-Config
Indicates the FR2 UL gap configuration to UE. In EN-DC and NGEN-DC, the SN decides and
configures the FR2 UL gap pattern. In NE-DC, the MN decides and configures the FR2 UL gap
pattern. In NR-DC without FR2-FR2 band combination, the network entity which is configured
with FR2 serving cell(s) decides and configures the FR2 UL gap pattern.

| Conditional Presence | Explanation | |
|---|---|---|
| nonHO | The field is absent in case of reconfiguration with sync within NR or | |
| | to NR; otherwise it is optionally present, need N. | |
| securityNASC | This field is mandatory present in case of inter system handover. | |
| | Otherwise the field is optionally present, need N. | |
| MasterKeyChange | This field is mandatory present in case masterCellGroup includes | |
| | ReconfigurationWithSync and RadioBearerConfig includes | |
| | SecurityConfig with SecurityAlgorithmConfig, indicating a change of | |
| | the AS security algorithms associated to the master key. If | |
| | ReconfigurationWithSync is included for other cases, this field is | |
| | optionally present, need N. Otherwise the field is absent. | |
| FullConfig | The field is mandatory present in case of inter-system handover from | |
| | E-UTRA/EPC to NR. It is optionally present, Need N, during | |
| | reconfiguration with sync and also in first reconfiguration after | |
| | reestablishment; or for intra-system handover from E-UTRA/5GC to | |
| | NR. It is absent otherwise. | |
| SCG | The field is mandatory present in: | |
| | - | an RRCReconfiguration message contained in an RRCResume |
| | | message (or in an RRCConnectionResume message, see TS |
| | | 36.331 [10]), |
| | - | an RRCReconfiguration message contained in an |
| | | RRCConnectionReconfiguration message, see TS 36.331 [10], |
| | | which is contained in DLInformationTransferMRDC |
| | | transmitted on SRB3 (as a response to |
| | | ULInformationTransferMRDC including an |
| | | MCGFailureInformation). |
| | The field is optional present, Need M, in: | |
| | - | an RRCReconfiguration message transmitted on SRB3, |
| | - | an RRCReconfiguration message contained in another |
| | | RRCReconfiguration message (or in an |
| | | RRCConnectionReconfiguration message, see TS 36.331 [10]) |
| | | transmitted on SRB1 |
| | - | an RRCReconfiguration message contained in another |

RRCReconfiguration message which is contained in
DLInformationTransferMRDC transmitted on SRB3 (as a
response to ULInformationTransferMRDC including an
MCGFailureInformation)

| | |
|---|---|
| | Otherwise, the field is absent |
| PagingRelay | For L2 U2N Relay UE, the field is optionally present, Need N. |
| | Otherwise, it is absent. |

6.3 RRC information elements
6.3.2 Radio resource control information elements

### LTM-CandidateConfig

The IE LTM-CandidateConfig is used to provide LTM candidate cell configuration.

LTM-Candidate Config information element

```
-- ASN1START
-- TAG-LTM-CANDIDATECONFIG-START
LTM-CandidateConfig-r18 ::= SEQUENCE {
  lte-ReferenceConfiguration-r18  OCTET STRING (CONTAINING RRCReconfiguration),
OPTIONAL, -- Cond FirstLTM-Candidate
  ltm-CandidateToReleaseList-r18  LTM-CandidateToReleaseList-r18
OPTIONAL, -- Need N
  ltm-CandidateToAddModList-r18  LTM-CandidateToAddModList-r18
OPTIONAL, -- Need N
  ltm-CandidateResetL2-List-r18  SetupRelease { LTM-CandidateResetL2-List-r18 }
OPTIONAL -- Need M
  ...
}
LTM-CandidateToReleaseList-r18 ::= SEQUENCE (SIZE (1..maxNrofCellsLTM-r18)) OF LTM-
CandidateId-r18  OPTIONAL  -- Need N
LTM-CandidateToAddModList-r18 ::= SEQUENCE (SIZE (1..maxNrofCellsLTM-r18)) OF LTM-
Candidate-r18
LTM-Candidate-r18 ::=  SEQUENCE {
  ltm-CandidateId-r18  LTM-CandidateId-r18,
  ltm-Config-r18  OCTET STRING (CONTAINING RRCReconfiguration),
  ltm-ConfigComplete-r18  ENUMERATED {true}
OPTIONAL  -- Need R
  ...
}
LTM-CandidateResetL2-List-r18 ::= SEQUENCE (SIZE (1..maxNrofCellsLTM-r18)) OF LTM-
CandidateId-r18
Editor's Note: FFS on whether the LTM-CandidateNoResetL2-List field should include separate
reset flags for MAC, RLC, and PDCP recovery.
-- TAG-LTM-CANDIDATECONFIG-STOP
-- ASN1STOP
```

LTM-CandidateConfig field descriptions

ltm-Config
This field includes an RRCReconfiguration message used to configure an LTM candidate cell.
This field shall include the CellGroupConfig IE, and it may also include the RadioBearerConfig
IE, and MeasConfig IE.
ltm-ConfigComplete
This field indicates whether the LTM candidate cell configuration within ltm-Config is a
complete configuration and thus the UE shall not use the LTM reference configuration within the
field lte-ReferenceConfiguration.
ltm-CandidateNoResetL2-List
This field includes a list of LTM candidate cell identifiers for which the full L2 reset is needed
upon an LTM cell switch.
ltm-ReferenceConfiguration
This field includes an RRCReconfiguration message used to configure a reference configuration
for LTM.

| Conditional Presence | Explanation |
|---|---|
| FirstLTM-Candidate | This field is mandatory present upon the first configuration of LTM- |
| | CandidateConfig. Otherwise, the field is optionally present, Need M. |

6.4 RRC Multiplicity and Type Constraint Values

### 7.4 UE Variables

### VarLTM-Config

The IE VarLTM-Config is used to store the reference configuration and the LTM candidate cell configurations.

```
VarLTM-Config UE variable
-- ASN1START
-- TAG-VARLTM-CONFIG-START
VarLTM-Config-r18-IEs ::= SEQUENCE {
  ltm-ReferenceConfiguration-r18 OCTET STRING (CONTAINING RRCReconfiguration),
  ltm-CandidateList-r18 LTM-CandidateList-r18
  Itm-CandidateResetL2-List-r18 LTM-CandidateResetL2-List-r18
}
LTM-CandidateList-r18 ::= SEQUENCE (SIZE (1..maxNrofCellsLTM-r18)) OF LTM-Candidate-
r18
LTM-CandidateResetL2-List-r18 ::= SEQUENCE (SIZE (1..maxNrofCellsLTM-r18)) OF LTM-
Candidate-r18
-- TAG-VARLTM-CONFIG-STOP
-- ASN1STOP
- VarLTM-UE-Config
The IE VarLTM-UE-Config is used to store the generated UE configuration related to the received
LTM candidate cell configurations.
VarLTM-UE-Config UE variable
-- ASN1START
-- TAG-VARLTM-CONFIG-START
VarLTM-UE-Config-r18-IEs ::= SEQUENCE {
  Ue-ltm-ConfigCandidateList-r18 UE-LTM-ConfigCandidateList-r18
}
UE-LTM-ConfigCandidateList-r18 ::= SEQUENCE (SIZE (1..maxNrofCellsLTM-r18)) OF UE-
LTM-Config-r18
UE-LTM-Candidate-r18 ::= SEQUENCE {
Itm-CandidateId-r18 LTM-CandidateId-r18,
ue-LTM-Config-r18 OCTET STRING,
}
-- TAG-VARLTM-CONFIG-STOP
-- ASN1STOP
```

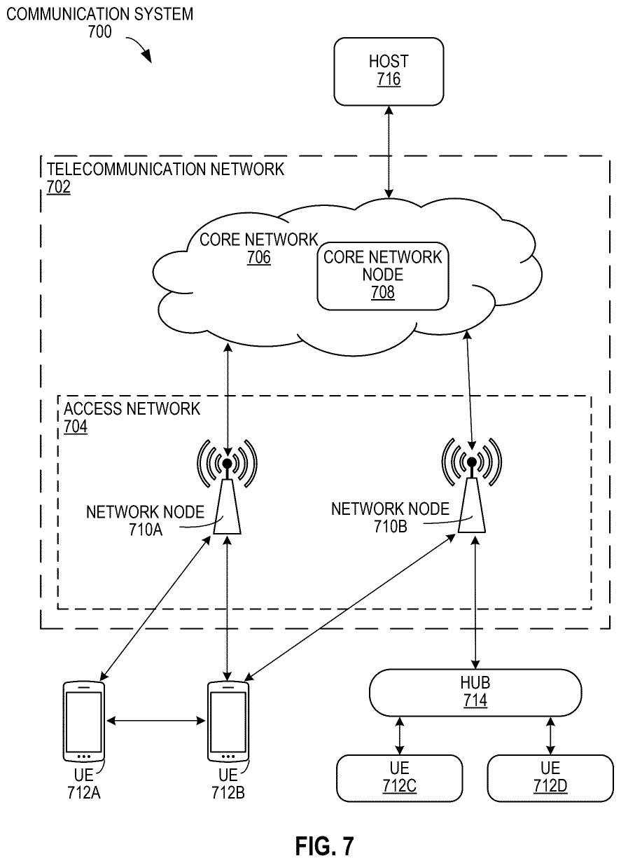

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

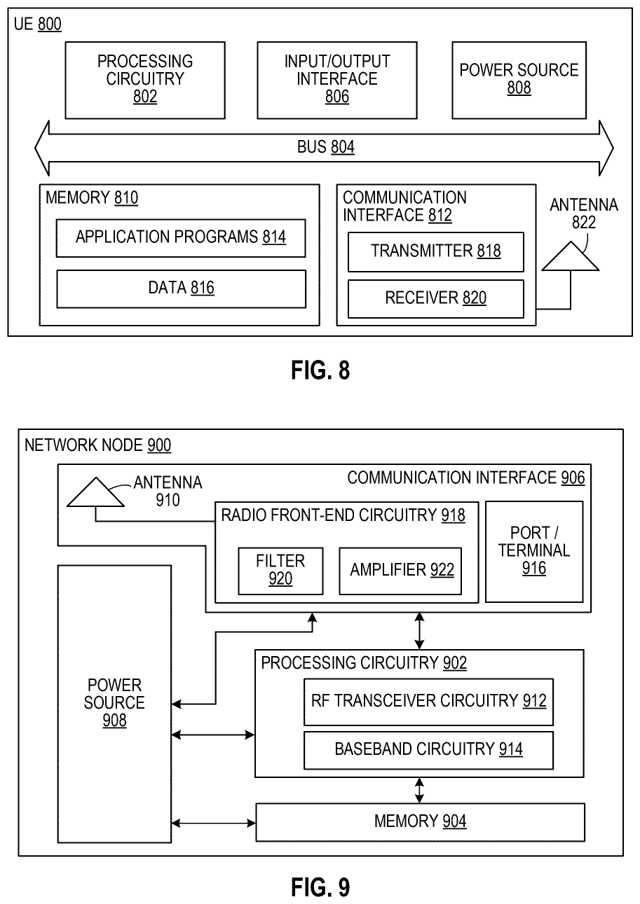

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

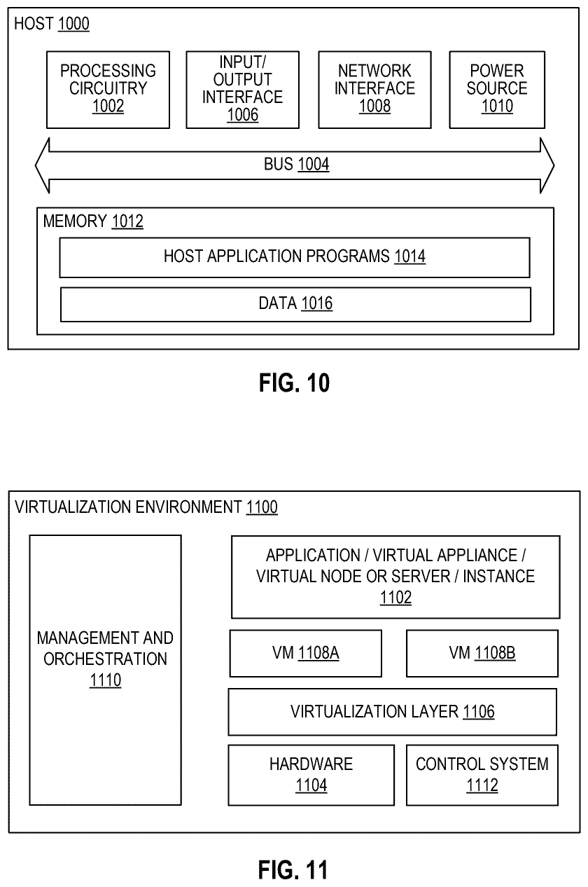

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

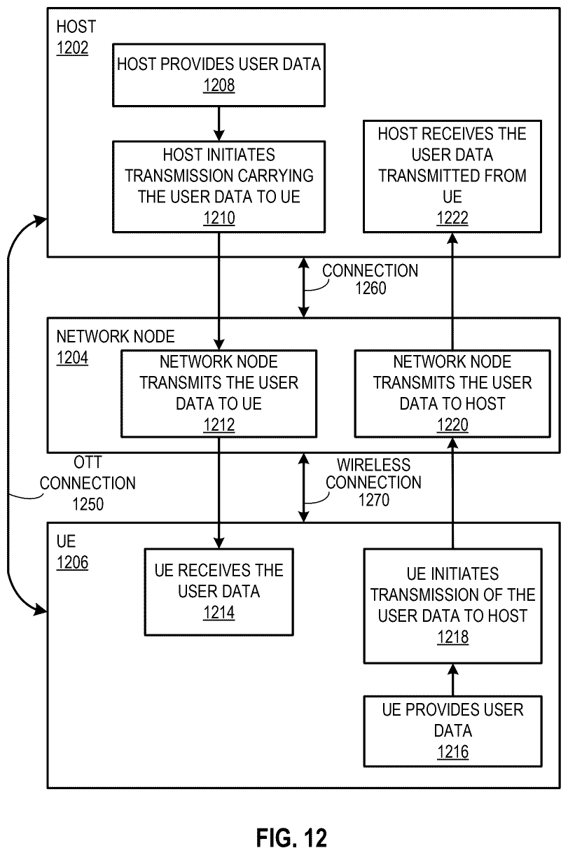

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. For example, the signalling between the UE and network nodes according to teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

A listing of example Embodiments according to some other embodiments of the present disclosure is provided below:

### Group A Embodiments

1. A method performed by a user equipment, UE, for a L1/L2-triggered mobility, LTM, cell switch procedure, the method comprising:
   receiving (200) LTM reference configuration and LTM candidate cell configuration;
   combining (202) the LTM reference configuration and the LTM candidate cell configuration to obtain a complete LTM candidate cell configuration for a LTM candidate cell;
   receiving (204), from a source network node, a LTM cell switch command, wherein the LTM cell switch command comprise at least an indication of a LTM candidate cell configuration;
   applying (206) the complete LTM candidate cell configuration of the indicated LTM candidate cell configuration; and
   sending (208) an uplink signalling to acknowledge completion of the LTM cell switch procedure.
2. The method of Embodiment 1, wherein the combining (202) the LTM reference configuration and the LTM candidate cell configuration to obtain a complete LTM candidate cell configuration for a LTM candidate cell, comprises:
   generating the complete LTM candidate cell configuration responsive to the reception of one of LTM reference configuration and the at least one LTM candidate cell configuration from the source network node following earlier reception of the other one of the LTM reference configuration and the at least one LTM candidate cell configuration from the source network node.
3. The method of any of Embodiments 1 to 2, wherein the combining (202) the LTM reference configuration and the LTM candidate cell configuration to obtain a complete LTM candidate cell configuration for a LTM candidate cell, comprises:
   generating the complete LTM candidate cell configuration responsive to the reception of the LTM cell switch command from the source network node.
4. The method of any of Embodiments 1 to 3, wherein the combining (202) the LTM reference configuration and the LTM candidate cell configuration to obtain a complete LTM candidate cell configuration for a LTM candidate cell, comprises:
   applying the LTM candidate cell configuration on top of the LTM reference configuration according to one or more of the following:
      performing a set of actions that are common for the LTM reference configuration and the LTM candidate cell configuration;
      performing a set of actions that are separate for the LTM reference configuration and the LTM candidate cell configuration; and
      performing a set of actions for the LTM reference configuration and/or the LTM candidate cell configuration according to a rule or guideline defining handling of ASN.1 structures, fields, or information elements in the LTM reference configuration and the LTM candidate cell configuration.
5. The method of Embodiment 4, wherein the performing a set of actions for the LTM reference configuration and the LTM candidate cell configuration according to a rule or guideline defining handling of ASN.1 structures, fields, or information elements in the LTM reference configuration and the LTM candidate cell configuration, comprises determining from the rule or guideline at least one of:
   an operation to use on a value of the ASN.1 structure, field, or information element in the LTM reference configuration and/or the LTM candidate cell configuration;
   an operation to use based on a type of the ASN.1 structure, field, or information element in the LTM reference configuration and/or the LTM candidate cell configuration;
   an order in which to perform an operation on a value of the ASN.1 structure, field, or information element in the LTM reference configuration and/or the LTM candidate cell configuration;
   an operation to use based on a value of the ASN.1 structure, field, or information element in the LTM reference configuration and/or the LTM candidate cell configuration;
   an operation to use based on presence of the ASN.1 structure, field, or information element in the LTM reference configuration and/or the LTM candidate cell configuration; and
   an operation to use based on a need code of the ASN.1 structure, field, or information element in the LTM reference configuration and/or the LTM candidate cell configuration.
6. The method of any of Embodiments 1 to 3, further comprising:
   preparing a part of the complete LTM candidate cell configuration based on reception of an LTM reference configuration and the LTM candidate cell configuration; and
   responsive to the reception of a LTM cell switch command, preparing the complete LTM candidate cell configuration based on the part.
7. The method of any of Embodiments 1 to 6, wherein the combining (202) the LTM reference configuration and the LTM candidate cell configuration to obtain a complete LTM candidate cell configuration for a LTM candidate cell, comprises:
   defining the LTM candidate cell configuration as the complete LTM candidate cell configuration.
8. The method of any of Embodiments 1 to 7, after receiving (204) the LTM cell switch command and before applying (206) the complete LTM candidate cell configuration, further comprising at least one of:
   copying a timer, a counter, and/or a configuration from a current UE configuration to the complete LTM candidate cell configuration;
   clearing in the current UE configuration, a dedicated configuration earlier received through dedicated signaling from the source network node;
   clearing in the current UE configuration, a common configuration earlier received through system information from the source network node; and
   performing an L2 reset.
9. The method of any of Embodiments 1 to 8, after receiving (204) the LTM cell switch command and before applying (206) the complete LTM candidate cell configuration, further comprising at least one of:
   applying a default configuration if a dedicated configuration is not present within the complete LTM candidate cell configuration;
   applying the complete LTM candidate cell configuration in a target cell; and
   sending the uplink signalling to a target network node to acknowledge the completion of the LTM cell switch procedure.

### Group B Embodiments

10. A method performed by a source network node for initiating a L1/L2-triggered mobility, LTM, cell switch procedure at a user equipment, UE, the method comprising:
   sending (300) a LTM reference configuration and a LTM candidate cell configuration to the UE; and
   sending (302) a LTM cell switch command for initiating a LTM cell switch procedure to the UE, wherein the LTM cell switch command comprises an indication of the LTM candidate cell configuration;
11. The method of Embodiment 10, wherein the LTM candidate cell configuration sent to the UE contains an indication of whether the LTM candidate cell configuration is a complete LTM candidate cell configuration.
12. The method of Embodiment 11, wherein the indication of whether the LTM candidate cell configuration is a complete LTM candidate cell configuration is sent to the UE in a message that is not the same as a message in which the LTM candidate cell configuration is transmitted.
13. A method performed by a target network node for a L1/L2-triggered mobility, LTM, cell switch procedure, the method comprising:
   initiating (400) configuration of a LTM candidate cell configuration at a user equipment, UE, through another network node; and
   receiving (402) a signalling from the UE which indicates that the LTM cell switch procedure has been successfully completed and that the UE is starting to operate with the target network node according to the LTM candidate cell configuration.
14. The method of Embodiment 13, wherein the LTM candidate cell configuration contains an indication of whether the LTM candidate cell configuration is a complete LTM candidate cell configuration.

### Group C Embodiments

15. A user equipment for a L1/L2-triggered mobility, LTM, cell switch procedure, comprising:
   processing circuitry configured to perform any of the steps of any of the Group A Embodiments; and
   power supply circuitry configured to supply power to the processing circuitry.
16. A source network node for a L1/L2-triggered mobility, LTM, cell switch procedure, the source network node comprising:
   processing circuitry configured to perform any of the steps of any of the Group B Embodiments;
   power supply circuitry configured to supply power to the processing circuitry.
17. A target network node for a L1/L2-triggered mobility, LTM, cell switch procedure, the target network node comprising:
   processing circuitry configured to perform any of the steps of any of the Group B Embodiments;
   power supply circuitry configured to supply power to the processing circuitry.
18. A user equipment (UE) for a L1/L2-triggered mobility, LTM, cell switch procedure, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A Embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
19. A host configured to operate in a communication system to provide an over-the-top (OTT) service, the host comprising:
   processing circuitry configured to provide user data; and
   a network interface configured to initiate transmission of the user data to a source network node in a cellular network for transmission to a user equipment (UE), the source network node having a communication interface and processing circuitry, the processing circuitry of the source network node configured to perform any of the operations of any of the Group B Embodiments to transmit the user data from the host to the UE.
20. A host configured to operate in a communication system to provide an over-the-top (OTT) service, the host comprising:
   processing circuitry configured to provide user data; and
   a network interface configured to initiate transmission of the user data to a target network node in a cellular network for transmission to a user equipment (UE), the target network node having a communication interface and processing circuitry, the processing circuitry of the target network node configured to perform any of the operations of any of the Group B Embodiments to transmit the user data from the host to the UE.
21. The host of the previous Embodiment, wherein:
   the processing circuitry of the host is configured to execute a host application that provides the user data; and
   the UE comprises processing circuitry configured to execute a client application associated with the host application to receive the transmission of user data from the host.
22. A method implemented in a host configured to operate in a communication system that further includes a source network node and a user equipment (UE), the method comprising:
   providing user data for the UE; and
   initiating a transmission carrying the user data to the UE via a cellular network comprising the source network node, wherein the source network node performs any of the operations of any of the Group B Embodiments to transmit the user data from the host to the UE.
23. The method of the previous Embodiment, further comprising, at the source network node, transmitting the user data provided by the host for the UE.
24. A method implemented in a host configured to operate in a communication system that further includes a target network node and a user equipment (UE), the method comprising: providing user data for the UE; and
   initiating a transmission carrying the user data to the UE via a cellular network comprising
   the target network node, wherein the target network node performs any of the operations of any of the Group B Embodiments to transmit the user data from the host to the UE.
25. The method of the previous Embodiment, further comprising, at the target network node, transmitting the user data provided by the host for the UE.
26. The method of any of the previous 2 Embodiments, wherein the user data is provided at the host by executing a host application that interacts with a client application executing on the UE, the client application being associated with the host application.
27. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular source network node for transmission to the UE, the source network node having a communication interface and processing circuitry, the processing circuitry of the source network node configured to perform any of the operations of any of the Group B Embodiments to transmit the user data from the host to the UE.
28. The communication system of the previous Embodiment, further comprising:
   the source network node; and/or
   the UE.
29. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular target network node for transmission to the UE, the target network node having a communication interface and processing circuitry, the processing circuitry of the target network node configured to perform any of the operations of any of the Group B Embodiments to transmit the user data from the host to the UE.
30. The communication system of the previous Embodiment, further comprising:
   the target network node; and/or
   the UE.
31. A host configured to operate in a communication system to provide an over-the-top (OTT) service, the host comprising:
   processing circuitry configured to initiate receipt of user data; and
   a network interface configured to receive the user data from a source network node in a cellular network, the source network node having a communication interface and processing circuitry, the processing circuitry of the source network node configured to perform any of the operations of any of the Group B Embodiments to receive the user data from a user equipment (UE) for the host.
32. A host configured to operate in a communication system to provide an over-the-top (OTT) service, the host comprising:
   processing circuitry configured to initiate receipt of user data; and
   a network interface configured to receive the user data from a target network node in a cellular network, the target network node having a communication interface and processing circuitry, the processing circuitry of the target network node configured to perform any of the operations of any of the Group B Embodiments to receive the user data from a user equipment (UE) for the host.
33. The host of the previous 2 Embodiments, wherein:
   the processing circuitry of the host is configured to execute a host application that receives the user data; and
   the host application is configured to interact with a client application executing on the UE, the client application being associated with the host application.
34. The host of the any of the previous 2 Embodiments, wherein the initiating receipt of the user data comprises requesting the user data. 35. A method implemented by a host configured to operate in a communication system that further includes a source network node and a user equipment (UE), the method comprising:
   at the host, initiating receipt of user data from the UE, the user data originating from a transmission which the source network node has received from the UE, wherein the source network node performs any of the steps of any of the Group B Embodiments to receive the user data from the UE for the host.
36. The method of the previous Embodiment, further comprising at the source network node, transmitting the received user data to the host.
37. A method implemented by a host configured to operate in a communication system that further includes a target network node and a user equipment (UE), the method comprising:
   at the host, initiating receipt of user data from the UE, the user data originating from a transmission which the target network node has received from the UE, wherein the target network node performs any of the steps of any of the Group B Embodiments to receive the user data from the UE for the host.
38. The method of the previous Embodiment, further comprising at the target network node, transmitting the received user data to the host.
39. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A Embodiments to receive the user data from the host.
40. The host of the previous Embodiment, wherein the cellular network further includes a source network node configured to communicate with the UE to transmit the user data to the UE from the host.
41. The host of the previous two Embodiments, wherein the cellular network further includes a target network node configured to communicate with the UE to transmit the user data to the UE from the host.
42. The host of the previous 2 Embodiments, wherein:
   the processing circuitry of the host is configured to execute a host application, thereby providing the user data; and
   the host application is configured to interact with a client application executing on the UE, the client application being associated with the host application.
43. A method implemented by a host operating in a communication system that further includes a source network node and a user equipment (UE), the method comprising:
   providing user data for the UE; and
   initiating a transmission carrying the user data to the UE via a cellular network comprising the source network node, wherein the UE performs any of the operations of any of the Group A Embodiments to receive the user data from the host.
34. The method of the previous Embodiment, further comprising:
   at the host, executing a host application associated with a client application executing on the UE to receive the user data from the host application.
35. The method of the previous Embodiment, further comprising:
   at the host, transmitting input data to the client application executing on the UE, the input data being provided by executing the host application,
   wherein the user data is provided by the client application in response to the input data from the host application.
36. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Embodiments to transmit the user data to the host.
37. The host of the previous Embodiment, wherein the cellular network further includes a source network node configured to communicate with the UE to transmit the user data from the UE to the host.
38. The host of the previous 2 Embodiments, wherein:
   the processing circuitry of the host is configured to execute a host application, thereby providing the user data; and
   the host application is configured to interact with a client application executing on the UE, the client application being associated with the host application.
39. A method implemented by a host configured to operate in a communication system that further includes a source network node and a user equipment (UE), the method comprising:
   at the host, receiving user data transmitted to the host via the source network node by the UE, wherein the UE performs any of the steps of any of the Group A Embodiments to transmit the user data to the host.
40. The method of the previous Embodiment, further comprising:
   at the host, executing a host application associated with a client application executing on the UE to receive the user data from the UE.
41. The method of the previous 2 Embodiments, further comprising:
   at the host, transmitting input data to the client application executing on the UE, the input data being provided by executing the host application,
   wherein the user data is provided by the client application in response to the input data from the host application.

### REFERENCES

[1] RP-223520, 3GPP work item description: Further NR mobility enhancements, MediaTek Inc, Apple, 3GPP TSG RAN Meeting #98-e, Electronic Meeting, Dec. 12-16, 2022.
[2] 3GPP TS 38.331 V17.4.0 (2023-03)

### 5.3.5.x.1 General

The UE shall perform the following actions based on a received LTM-CandidateConfig IE:

1> store the received ltm-ReferenceConfiguration in VarLTM-Config, if present;
1> if the LTM-CandidateConfig includes the ltm-CandidateToReleaseList:
   2> perform the LTM candidate cell release as specified in 5.3.5.x.2;
1> if the LTM-CandidateConfig includes the ltm-CandidateResetL2-List:
   2> add the received ltm-CandidateResetL2-List to VarLTM-Config;
1> if the LTM-CandidateConfig includes the ltm-CandidateToAddModList:
   2> perform the LTM candidate cell addition or reconfiguration as specified in 5.3.5.x.3;
1> perform the actions to generate a complete LTM configuration as specified in 5.3.5.x.4;
NOTE X: It is up to the UE implementation to postpone the generation of a complete LTM configuration until the executing of an LTM cell switch.
Editor's Note: FFS on whether the UE performs the compliance check of the reference and LTM candidate cell configuration upon their reception of upon the execution of the LTM cell switch.
Editor's Note: FFS on how and whether to indicate that no RACH is needed for an LTM candidate cell.
Editor's Note: FFS on how UE should establish the TA for a LTM candidate cell.

### 5.3.5.x.2 LTM Candidate Cell Release

The UE shall:
1> for each ltm-CandidateId in the ltm-CandidateToReleaseList:
   2> if the current VarLTM-Config includes an ltm-Candidate with the given ltm-CandidateId:
      3> release the ltm-Candidate from VarLTM-Config;

### 5.3.5.x.3 LTM Candidate Cell Addition/Modification

The UE shall:
1> for each ltm-CandidateId in the ltm-CandidateToAddModList:
   2> if the current VarLTM-Config includes an ltm-Candidate with the given ltm-CandidateId:
      3> modify the ltm-Candidate within VarLTM-Config in accordance with the received ltm-Candidate;
   2> else:
      3> add the received ltm-Candidate to VarLTM-Config.

### 5.3.5.x.4 Generation of UE LTM Configuration

The purpose of this procedure is for the UE to generate a complete LTM candidate cell configuration to be stored and applied only when an indication of an LTM cell switch is received by lower layers. During the generation of a complete LTM candidate cell configuration, the current UE configuration shall not be modified.

The UE shall:
1> for each ltm-Candidate in ltm-CandidateConfigList within VarLTM-Config;
   2> store the ltm-CandidateId included in ltm-Candidate within VarLTM-UE-Config;
   2> if ltm-Candidate includes ltm-ConfigComplete;
      3> generate a complete LTM candidate cell configuration for the received ltm-Candidate according to the actions described in clause 5.3.5.3 and store it in ue-LTM-Config within VarLTM-UE-Config.
   2> else:
      3> generate a complete LTM candidate cell configuration by applying ltm-Candidate on top of referenceConfiguration according to the actions described in clause 5.3.5.3 and store it in ue-LTM-Config within VarLTM-UE-Config.
Editor's Note: FFS on the need of ltm-ConfigComplete to indicate to the UE that the LTM candidate cell configuration in ltm-Candidate is a full configuration.
Editor's Note: FFS on whether we need to rely on the full configuration procedure or a new procedure for LTM is created when the UE generates a complete LTM candidate cell configuration.

### 5.3.5.x.5 LTM Cell Switch Execution

Upon the indication by lower layers that an LTM cell switch procedure is triggered, the UE shall:
1> release/clear all current dedicated radio configuration except for the following:
   2> if the LTM cell switch is triggered on the MCG:
      the MCG C-RNTI;
      the AS security configurations associated with the master key;
   2> else, if the LTM cell switch is triggered on the SCG:
      the SCG C-RNTI;
      the AS security configurations associated with the secondary key;
   the SRB1/SRB2 configurations and DRB configurations as configured by radioBearerConfig or radioBearerConfig2;
Editor's Note: FFS on whether the radio bearer needs to be kept when execution the LTM cell switch.
   the UE variables VarLTM-Config and VarLTM-UE-Config.
1> release/clear all current common radio configuration;
Editor's Note: FFS on whether ServingCellConfigCommon is always provided in a LTM candidate cell configuration or whether can be optional.
1> use the default values specified in 9.2.3 for timers T310, T311 and constants N310, N311;
1> apply the default L1 parameter values as specified in corresponding physical layer specifications except for the following:
   parameters for which values are provided in SIB1;
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation as specified in TS 38.323 [5], and with the same security configuration as the PDCP entity for the source cell group;
1> stop timer T310 for the corresponding SpCell, if running;
1> if this procedure is executed for the MCG:
   2> if timer T316 is running;
      3> stop timer T316;
1> stop timer T312 for the corresponding SpCell, if running;
1> apply the specified BCCH configuration defined in 9.1.1.1 for the target LTM candidate cell configuration;
1> acquire the MIB of the target SpCell as indicated in the LTM candidate cell configuration indicated by lower layers, which is scheduled as specified in TS 38.213 [13], if applicable;
1> apply the LTM configuration in UE-LTM-Config within VarLTM-UE-Config related to the LTM candidate cell configuration identity as received by lower layers.
1> submit the RRCReconfigurationComplete message to lower layers for transmission using the new configuration.
Editor's Note: FFS on whether the sending of the RRCReconfigurationComplete message should be triggered in this section or in section 5.3.5.3 (i.e., Reception of an RRCReconfiguration by the UE).
Editor's Note: FFS on whether further UE actions need to be specified for e.g., subsequent LTM cell switch or interaction with lower layers.
Editor's Note: FFS on the UE actions (for no L2 reset) based on ltm-CandidateNoResetL2-List.
Editor's Note: FFS on how and whether to indicate that no RACH is needed for an LTM candidate cell.
Editor's Note: FFS on how to handle the TA (and when the UE has no TA) in the source cell (in case no RACH is performed) upon an LTM cell switch and whether this should be specified in RRC or MAC.
Editor's Note: FFS on the supervision timer for the LTM cell switch.
Editor's Note: FFS on how to provide the UL grant to the UE in case no RACH is performed during the LTM cell switch.

### 6.2 RRC Messages

### 6.2.2 Message Definitions

The RRCReconfiguration message is the command to modify an RRC connection. It may convey information for measurement configuration, w mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message
-- ASN1START
-- TAG-RRCRECONFIGURATION-START

| RRCReconfiguration ::= | SEQUENCE { | |
|---|---|---|
| rrc-TransactionIdentifier | RRC-TransactionIdentifier, | |
| criticalExtensions | CHOICE { | |
| rrcReconfiguration | RRCReconfiguration-IEs, | |
| criticalExtensionsFuture | SEQUENCE { } | |
| } | | |
| } | | |
| RRCReconfiguration-Ies ::= | SEQUENCE { | |
| radioBearerConfig | RadioBearerConfig | OPTIONAL, --Need M |
| secondaryCriticalGroup | OCTET STRING (CONTAINING CellGroupConfig) | OPTIONAL, -- Cond SCG |
| measConfig | MeasConfig | OPTIONAL, -- Need M |
| lateNonCriticalExtension | OCTET STRING | OPTIONAL, |
| nonCriticalExtension | RRCReconfiguration-v1530-Ies | OPTIONAL |
| } | | |
| RRCReconfiguration-v1530-Ies ::= | SEQUENCE { | |
| masterCellGroup | OCTET STRING (CONTAINING CellGroupConfig) | OPTIONAL, -- Need M |
| fullConfig | ENUMERATED {true} | OPTIONAL, -- Cond FullConfig |
| dedicatedNAS-MessageList | SEQUENCE (SIZE(1..maxDRB)) OF DedicatedNAS-Message | OPTIONAL, -- Cond nonHO |
| masterKeyUpdate | MassterKeyUpdate | OPTIONAL, -- Cond |
| MasterKeyChange | | |
| dedicatedSIB1-Delivery | OCTET STRING (CONTAINING SIB1) | OPTIONAL, -- Need N |
| dedicatedSystemInformationDelivery | OCTET STRING (CONTAINING SystemInformation) | OPTIONAL, -- Need N |
| otherConfig | OtherConfig | OPTIONAL, -- Need M |
| nonCriticalExtension | RRCReconfiguration-v1540-Ies | OPTIONAL |
| } | | |
| RRCReconfiguration-v1540-Ies ::= | SEQUENCE { | |
| otherConfig-v1540 | OtherConfig-v1540 | OPTIONAL, -- Need M |
| nonCriticalExtension | RRCReconfiguration-v1560-Ies | OPTIONAL |
| } | | |
| RRCReconfiguration-v1560-Ies ::= | SEQUENCE { | |
| mrdc-SecondaryCellGroupConfig | SetupRelease { MRDC-SecondaryCellGroupConfig } | OPTIONAL, -- Need M |
| radioBearerConfig2 | OCTET STRING (CONTAINING RadioBearerConfig} | OPTIONAL, -- Need M |
| sk-Counter | SK-Counter | OPTIONAL, -- Need N |
| nonCriticalExtension | RRCReconfiguration-v1610-Ies | |
| } | | |
| RRCReconfiguration-v1610-Ies ::= | SEQUENCE { | |
| otherConfig-v1610 | OtherConfig-v1610 | OPTIONAL, -- Need M |
| bap-Config-r16 | SetupRelease { BAP-Config-r16 } | OPTIONAL, -- Need M |
| iab-IP-AddressConfigurationList-r16 | IAB-IP-AddressConfigurationLiist-r16 | OPTIONAL, -- Need M |
| conditionalReconfiguration-r16 | ConditionalReconfiguration-r16 | OPTIONAL, -- Need M |
| daps-SourceRelease-r16 | ENUMERATED{true} | OPTIONAL, -- Need N |
| t316-r16 | SetupRelease {T3316-r16} | OPTIONAL, -- Need M |
| needForGapsConfigNR-r16 | SetupRelease {NeedForGapsConfigNR-r16} | OPTIONAL, -- Need M |
| onDemandSIB-Request-r16 | SetupRelease { OnDemandSIB-Request-r16 } | OPTIONAL, -- Need M |
| dedicatedPosSysInfoDelivery-r16 | OCTET STRING (CONTAINING PosSystemInformation-r16-Ies) | OPTIONAL, -- Need N |
| sl-ConfigDedicatedNR-r16 | SetupRelease {SL-ConfigDedicatedNR-r16} | OPTIONAL, -- Need M |
| sl-ConfigDedicatedEUTRA-Info-r16 | SetupRelease {SL-ConfigDedicatedEUTRA-Info-r16} | OPTIONAL, -- Need M |
| targetCellSMTC-SCG-r16 | SSB-MTC | OPTIONAL, -- Need S |
| nonCriticalExtension | RRCReconfiguration-v1700-Ies | OPTIONAL |
| } | | |
| RRCReconfiguration-v1700-Ies ::= | SEQUENCE { | |
| otherConfig-v1700 | OtherConfig-v1700 | OPTIONAL, -- Need M |
| sl-L2RelayUE-Config-r17 | SetupRelease { SL-L2RelayUE-Config-r17 } | OPTIONAL, -- Need M |
| sl-L2RemoteUE-Config-r17 | SetupRelease { SL-L2RemoteUE-Config-r17 } | OPTIONAL, -- Need M |
| dedicatedPagingDelivery-r17 | OCTET STRING (CONTAINING Paging) | OPTIONAL, -- Cond PagingRelay |
| needForGapNCSG-ConfigNR-r17 | SetupRelease {NeedForGapNCSG-ConfigNR-r17} | OPTIONAL, -- Need M |
| needForGapNCSG-CongidEUTRA-r17 | SetupRelease {NeedForGapNCSG-ConfigEUTRA-r17} | OPTIONAL, -- Need M |
| musim-GapConfig-r17 | SetupRelease {MUSIM-GapConfig-r17} | OPTIONAL, -- Need M |
| ul-GapFR2-Config-r17 | SetupRelease { UL-GapFR2-Config-r17 } | OPTIONAL, -- Need M |
| scg-State-r17 | ENUMERATED { deactivated } | OPTIONAL, -- Need N |
| appLayerMeasConfig-r17 | AppLayerMeasConfig-r17 | OPTIONAL, -- Need M |
| ue-TxTEG-RequestUL-TDOA-Config-r17 | SetupRelease {UE-TxTEG-RequestUL-TDOA-Config-r17} | OPTIONAL, -- Need M |
| nonCriticalExtension | RRCReconfiguration-v18xy [symbol] | OPTIONAL |
| } | | |
| RRCReconfiguration-v18xy-Ies ::= | SEQUENCE { | |
| ltm-CandidateConfig-r18 | SetupRelease {LTM-CandidateConfig-r18} | OPTIONAL, -- Need M |
| nonCriticalExtension | SEQUENCE { } | OPTIONAL |
| } | | |
| MRDC-SecondaryCellGroupConfig ::= | SEQUENCE { | |
| mrdc-ReleaseAndAdd | ENUMERATED {true} | OPTIONAL, -- Need M |
| mrdc-SecondaryCellGroup | CHOICE { | |
| nr-SCG | OCTET STRING (CONTAINING RRCReconfiguration), | |
| eutra-SCG | OCTET STRING | |
| } | | |
| } | | |
| BAP-Config-r16 ::= | SEQUENCE { | |
| bap-Address-r16 | BIT STRING (SIZE (10)) | OPTIONAL, -- Need M |
| defaultUL-BAP-RoutingID-r16 | BAP-RoutingID-r16 | OPTIONAL, -- Need M |
| defaultUL-BH-RLC-Channel-r16 | BH-RLC-ChannelID-r16 | OPTIONAL, -- Need M |
| flowControlFeedbackType-r16 | ENUMERATED {perBH-RLC-Channel, perRoutingID, both} | OPTIONAL, -- Need M |
| ... | | |
| } | | |
| MasterKeyUpdate ::= | SEQUENCE { | |
| keySetChangeIndicator | BOOLEAN, | |
| nextHopChainingCount | NextHopChainingCount, | |
| nas-Container | OCTET STRING | OPTIONAL, -- Cond securityNASC |
| ... | | |
| } | | |
| OnDemandSIB-Request-r16 ::= | SEQUENCE { | |
| onDemandSIB-RequestProhibitTimer-r16 | ENUMERATED {s0, s0dot5, s1, s2, s5, s10, s20, s30) | |
| } | | |
| T316-r16 ::= | ENUMERATED {ms50, ms100, ms200, ms300, ms400, ms500, ms600, ms1000, ms1500, ms2000} | |
| IAB-IP-AddressConfigurationList-r16 ::= | SEQUENCE { | |
| iab-IP-AddressToAddModList-r16 | SEQUENCE (SIZE(1..maxIAB-IP-Address-r16)) OF IAB-IP- | |
| | AddressConfiguration-r16 OPTIONAL, --NEED N | |
| iab-IP-AddressToReleaseList-r16 | SEQUENCE (SIZE(1..maxIAB-IP-Address-r16)) OF IAB-IP- | |
| ... | AddressIndex-r16 OPTIONAL, --NEED N | |
| } | | |
| IAB-IP-AddressConfigurationList-r16 ::= | SEQUENCE { | |
| iab-IP-AddressIndex-r16 | IAB-IP-AddressIndex-r16, | |
| iab-IP-Address-r16 | IAB-IP-Address-r16 | OPTIONAL, -- Need M |
| iab-IP-Usage-r16 | IAB-IP-Usage-r16 | OPTIONAL, -- Need M |
| iab-donor-DU-BAP-Address-r16 | BIT STRING (SIZE (10)) | OPTIONAL, -- Need M |
| ... | | |
| } | | |
| SL-ConfigDedicatedEUTRA-Info-r16 ::= | SEQUENCE { | |
| sl-ConfigDedicatedEUTRA-r16 | OCTET STRING | OPTIONAL, -- Need M |
| sl-TimeOffsetEUTRA-List-r16 | SEQUENCE (SIZE (8)) OF SL-TimeOffsetEUTRA-r16 | OPTIONAL, -- Need M |
| } | | |

SL-TimeOffsetEUTRA-r16 ::= ENUMERATED {ms0, ms0dot25, ms0dot5, ms0dot625, ms0dot75, ms1, ms1dot25, ms1dot5, ms1dot75,

| | ms2, ms2dot5, ms3, ms4, ms5, ms6, ms8, ms10, ms20} |
|---|---|
| UE-TxTEG-RequestUL-TDOA-Config-r17 ::= | CHOICE { |
| oneShot-r17 | NULL, |
| periodicReporting-r17 | ENUMERATED { ms160, ms320, ms1280, ms2560, ms61440, ms81920, ms368640, ms737280 } |
| } | |
| -- TAG-RRCRECONFIGURATION-STOP | |
| -- ASN1STOP | |

RRCReconfiguration-les field descriptions

| appLayerMeasConfig | |
|---|---|
| This field is used to configure application layer measurements. This field is absent when the UE is configured to operate with shared spectrum channel access. | |
| Bap-Config | |
| This field is used to configure the BAP entity for IAB nodes. | |
| Bap-Address | |
| Indicates the BAP address of an IAB-node. The BAP address of an IAB-node cannot be changed once configured for the cell group to the BAP entity. | |
| conditionalReconfiguration | |
| Configuration of candidate target SpCell(s) and execution condition(s) for conditional handover, conditional PSCell addition or conditional PSCell change. The field is absent if | |
| any DAPS bearer is configured or if the masterCellGroup includes ReconfigurationWithSync or if the sl-L2RemoteUE-Config or sl-L2RelayUE-Config is configured. For | |
| conditional PSCell change, the field is absent if the secondaryCellGroup includes ReconfigurationWithSync. The RRCReconfiguration message contained in | |
| DLInformationTransferMRDC cannot contain the field conditionalReconfiguration for conditional PSCell change or for conditional PSCell addition. | |
| Daps-SourceRelease | |
| Indicates to UE that the source cell part of DAPS operation is to be stopped and the source cell part of DAPS configuration is to be released. | |
| dedicatedNAS-MessageList | |
| This field is used to transfer UE specific NAS layer information between the network and the UE. The RRC layer is transparent for each PDU in the list. | |
| dedicatedPagingDelivery | |
| This field is used to transfer Paging message for the associated L2 U2N Remote UE to the L2 U2N Relay UE in RRC_CONNECTED. | |
| dedicatedPosSysInfoDelivery | |
| This field is used to transfer SIBPos to the UE in RRC_CONNECTED. | |
| dedicatedSIB1-Delivery | |
| This field is used to transfer SIB1 to the UE (including L2 U2N Remote UE). The field has the same values as the corresponding configuration in servingCellConfigCommon. | |
| dedicatedSystemInformationDelivery | |
| This field is used to transfer SIB6, SIB7, SIB8, SIB19, SIB21 to the UE with an active BWP with no common search space configured or the L2 U2N Remote UE in | |
| RRC_CONNECTED. For Ues in RRC_CONNECTED (including L2 U2N Remote UE), this field is also used to transfer the SIBs requested on-demand. | |
| defaultUL-BAP-RoutingID | |
| This field is used for IAB-node to configure the default uplink Routing ID, which is used by IAB-node during IAB-node bootstrapping, migration, IAB-MT RRC resume and IAB- | |
| MT RRC re-establishment for F1-C and non-F1 traffic. The defaultUL-BAP-RoutingID can be (re-)configured when IAB-node IP address for F1-C related traffic changes. This | |
| field is mandatory only for IAB-node bootstrapping. | |
| defaultUL-BH-RLC-Channel | |
| This field is used for IAB-nodes to configure the default uplink BH RLC channel, which is used by IAB-node during IAB-node bootstrapping, migration, IAB-MT RRC resume | |
| and IAB-MT RRC re-establishment for F1-C and non-F1 traffic. The defaultUL-BH-RLC-Channel can be (re-)configured when IAB-node IP address for F1-C related traffic | |
| changes, and the new IP address is anchored at a different IAB-donor-DU. This field is mandatory for IAB-node bootstrapping. If the IAB-MT is operating in EN-DC, the default | |
| uplink BH RLC channel is referring to an RLC channel on the SCG; Otherwise, it is referring to an RLC channel either on the MCG or on the SCG depending on whether the | |
| MN or the SN configures this field. | |
| flowControlFeedbackType | |
| This field is only used for IAB-node that support hop-by-hop flow control to configure the type of flow control feedback. Value perBH-RLC-Channel indicates that the IAB-node | |
| shall provide flow control feedback per BH RLC channel, value perRoutingID indicates that the IAB-node shall provide flow control feedback per routing ID, and value both | |
| indicates that the IAB-node shall provide flow control feedback both per BH RLC channel and per routing ID. | |
| fullConfig | |
| Indicates that the full configuration option is applicable for the RRCReconfiguration message for intra-system intra-RAT HO. For inter-RAT HO from E-UTRA to NR, fullConfig | |
| indicates whether or not delta signalling of SDAP/PDCP from source RAT is applicable. This field is absent if any DAPS bearer is configured or when the RRCReconfiguration | |
| message is transmitted on SRB3, and in an RRCReconfiguration message for SCG contained in another RRCReconfiguration message (or RRCConnectionReconfiguration | |
| message, see TS 36.331 [10]) transmitted on SRB1. | |
| lab-IP-Address | |
| This field is used to provide the IP address information for IAB-node. | |
| lab-IP-AddressIndex | |
| This field is used to identify a configuration of an IP address. | |
| lab-IP-AddressToAddModList | |
| List of IP addresses allocated for IAB-node to be added and modified. | |
| lab-IP-AddressToReleaseList | |
| List of IP address allocated for IAB-node to be released. | |
| lab-IP-Usage | |
| This field is used to indicate the usage of the assigned IP address. If this field is not configured, the assigned IP address is used for all traffic. | |
| lab-donor-DU-BAP-Address | |
| This field is used to indicate the BAP address of the IAB-donor-DU where the IP address is anchored. | |
| keySetChangeIndicator | |
| Indicates whether UE shall derive a new K_{gNB}. If reconfigurationWithSync is included, value true indicates that a K_{gNB} key is derived from a K_{AMF} key taken into use through the | |
| latest successful NAS SMC procedure, or N2 handover procedure with K_{AMF} change, as described in TS 33.501 [11] for K_{gNB} re-keying. Value false indicates that the new K_{gNB} | |
| key is obtained from the current K_{gNB} key or from the NH as described in TS 33.501 [11]. | |
| Ltm-CandidateConfig | |
| Configuration of LTM candidate cell(s), reference configuration for LTM cell(s) and sets of cells in which full L2 reset is applied upon an LTM cell switch. | |
| masterCellGroup | |
| Configuration of master cell group. | |
| Mrdc-ReleaseAndAdd | |
| This field indicates that the current SCG configuration is released and a new SCG is added at the same time. | |
| Mrdc-SecondaryCellGroup | |
| Includes an RRC message for SCG configuration in NR-DC or NE-DC. | |
| For NR-DC (nr-SCG), mrdc-SecondaryCellGroup contains the RRCReconfiguration message as generated (entirely) by SN gNB. In this version of the specification, the RRC | |
| message can only include fields secondaryCellGroup, otherConfig, conditionalReconfiguration, measConfig, bap-Config and IAB-IP-AddressConfigurationList. | |
| For NE-DC (eutra-SCG), mrdc-SecondaryCellGroup includes the E-UTRA RRCConnectionReconfiguration message as specified in TS 36.331 [10]. In this version of the | |
| specification, the E-UTRA RRC message can only include the field scg-Configuration. | |
| Musim-GapConfig | |
| Indicates the MUSIM gap configuration and controls setup/release of MUSIM gaps. In this version of the specification, the network does not configure MUSIM gap together | |
| with concurrent measurement gap or preconfigured measurement gap for positioning. | |
| Nas-Container | |
| This field is used to transfer UE specific NAS layer information between the network and the UE. The RRC layer is transparent for this field, although it affects activation of AS | |
| security after inter-system handover to NR. The content is defined in TS 24.501 [23]. | |
| needForGapsConfigNR | |
| Configuration for the UE to report measurement gap requirement information of NR target bands in the RRCReconfigurationComplete and RRCResumeComplete message. | |
| needForGapNCSG-ConfigEUTRA | |
| Configuration for the UE to report measurement gap and NCSG requirement information of E-UTRA target bands in the RRCReconfigurationComplete and | |
| RRCResumeComplete message. | |
| needForGapNCSG-ConfigNR | |
| Configuration for the UE to report measurement gap and NCSG requirement information of NR target bands in the RRCReconfigurationComplete and RRCResumeComplete | |
| message. | |
| nextHopChainingCount | |
| Parameter NCC: See TS 33.501 [11] | |
| onDemandSIB-Request | |
| If the field is present, the UE is allowed to request SIB(s) on-demand while in RRC_CONNECTED according to clause 5.2.2.3.5. | |
| onDemandSIB-RequestProhibitTimer | |
| Prohibit timer for requesting SIB(s) on-demand while in RRC_CONNECTED according to clause 5.2.2.3.5. Value in seconds. Value s0 means prohibit timer is set to 0 | |
| seconds, value sodot5 means prohibit timer is set to 0.5 seconds, value s1 means prohibit timer is set to 1 second and so on. | |
| otherConfig | |
| Contains configuration related to other configurations. When configured for the SCG, only fields drx-PreferenceConfig, maxBW-PreferenceConfig, maxBW- | |
| PreferenceConfigFR2-2, maxCC-PreferenceConfig, maxMIMO-LayerPreferenceConfig, maxMIMO-LayerPreferenceConfigFR2-2, minSchedulingOffsetPreferenceConfig, | |
| minSchedulingOffsetPreferenceConfigExt, rim-RelaxationReportingConfig, bfd-RelaxationReportingConfig, btNameList, wlanNameList, sensorNameList and | |
| obtainCommonLocation can be included. | |
| radioBearerConfig | |
| Configuration of Radio Bearers (DRBs, SRBs, multicast MRBs) including SDAP/PDCP. In (NG)EN-DC this field may only be present if the RRCReconfiguration is transmitted | |
| over SRB3. | |
| radioBearerConfig2 | |
| Configuration of Radio Bearers (DRBs, SRBs) including SDAP/PDCP. This field can only be used if the UE supports NR-DC or NE-DC. | |
| Scg-State | |
| Indicates that the SCG is in deactivated state. | |
| This field is not used | |
| - | in an RRCReconfiguration message received: |
| | - within mrdc-SecondaryCellGroup, or |
| | - in an E-UTRA RRCConnectionReconfiguration message, or |
| | - in an E-UTRA RRCConnectionResume message or |
| - | in an RRCReconfiguration message received via SRB3, except if the RRCReconfiguration message is included in DLInformationTransferMRDC. |

The field is absent if CPA or CPC is configured for the UE, or if the RRCReconfiguration message is contained in CondRRCReconfig.
Sl-L2RelayUE-Config
Contains L2 U2N relay operation related configurations used by a UE acting as or to be acting as a L2 U2N Relay UE. The field is absent if conditionalReconfiguration is
configured for CHO.
Sl-L2RemoteUE-Config
Contains L2 U2N relay operation related configurations used by a UE acting as or to be acting as a L2 U2N Remote UE. The field is absent if conditionalReconfiguration is
configured for CHO, or if appLayerMeasConfig or SRB4 is configured/not released.
Configuration of secondary cell group ((NG)EN-DC or NR-DC).
secondaryCellGroup
Sk-Counter
A counter used upon initial configuration of S-K_{gNB} or S-K_{eNB}, as well as upon refresh of S-K_{gNB} or S-K_{eNB}. This field is always included either upon initial configuration of an NR
SCG or upon configuration of the first RB with keyToUse set to secondary, whichever happens first. This field is absent if there is neither any NR SCG nor any RB with
keyToUse set to secondary.
Sl-ConfigDedicatedNR
This field is used to provide the dedicated configurations for NR sidelink communication/discovery.
Sl-ConfigDedicatedEUTRA-Info
This field includes the E-UTRA RRCConnectionReconfiguration as specified in TS 36.331 [10]. In this version of the specification, the E-UTRA RRCConnectionReconfiguration
can only includes sidelink related fields for V2X sidelink communication, i.e. sl-V2X-ConfigDedicated, sl-V2X-SPS-Config, measConfig and/or otherConfig.
Sl-TimeOffsetEUTRA
This field indicates the possible time offset to (de)activation of V2X sidelink transmission after receiving DCI format 3_1 used for scheduling V2X sidelink communication. Value
ms0dpt75 corresponds to 0.75ms, ms1 corresponds to 1ms and so on. The network includes this field only when sl-ConfigDedicatedEUTRA is configured.
targetCelISMTC-SCG
The SSB periodicity/offset/duration configuration of target cell for NR PSCell addition and SN change. When UE receives this field, UE applies the configuration based on the
timing reference of NR Pcell for PSCell addition and PSCell change for the case of no reconfiguration with sync of MCG, and UE applies the configuration based on the timing
reference of target NR Pcell for the case of reconfiguration with sync of MCG. If both this field and the smtc in secondaryCellGroup -> SpCellConfig -> reconfigurationWithSync
are absent, the UE uses the SMTC in the measObjectNR having the same SSB frequency and subcarrier spacing, as configured before the reception of the RRC message.
T316
Indicates the value for timer T316 as described in clause 7.1. Value ms50 corresponds to 50 ms, value ms 100 corresponds to 100 ms and so on. This field can be configured
only if the UE is configured with split SRB1 or SRB3.
Ue-TxTEG-RequestUL-TDOA-Config
Configures the periodicity of UE reporting for the association between Tx TEG and SRS Positioning resources. When configured with oneShot UE reports the association only
one time. When configured with periodicReporting UE reports the association periodically and the periodicReporting indicates the periodicity. Value ms160 corresponds to
160ms, value ms320 corresponds to 320ms and so on.
Ul-GapFR2-Config
Indicates the FR2 UL gap configuration to UE. In EN-DC and NGEN-DC, the SN decides and configures the FR2 UL gap pattern. In NE-DC, the MN decides and configures
the FR2 UL gap pattern. In NR-DC without FR2-FR2 band combination, the network entity which is configured with FR2 serving cell(s) decides and configures the FR2 UL gap
pattern.

| Conditional Presence | Explanation | |
|---|---|---|
| nonHO | The field is absent in case of reconfiguration with sync within NR or to NR; otherwise it is optionally present, need N. | |
| securityNASC | This field is mandatory present in case of inter system handover. Otherwise the field is optionally present, need N. | |
| MasterKeyChange | This field is mandatory present in case masterCellGroup includes ReconfigurationWithSync and RadioBearerConfig includes | |
| | SecurityConfig with SecurityAlgorithmConfig, indicating a change of the AS security algorithms associated to the master key. | |
| | If ReconfigurationWithSync is included for other cases, this field is optionally present, need N. Otherwise the field is absent. | |
| FullConfig | The field is mandatory present in case of inter-system handover from E-UTRA/EPC to NR. It is optionally present, Need N, | |
| | during reconfiguration with sync and also in first reconfiguration after reestablishment; or for intra-system handover from E- | |
| | UTRA/5GC to NR. It is absent otherwise. | |
| SCG | The field is mandatory present in: | |
| | - | an RRCReconfiguration message contained in an RRCResume message (or in an RRCConnectionResume |
| | | message, see TS 36.331 [10]), |
| | - | an RRCReconfiguration message contained in an RRCConnectionReconfiguration message, see TS 36.331 [10], |
| | | which is contained in DLInformationTransferMRDC transmitted on SRB3 (as a response to |
| | | ULInformationTransferMRDC including an MCGFailureInformation). |
| | The field is optional present, Need M, in: | |
| | - | an RRCReconfiguration message transmitted on SRB3, |
| | - | an RRCReconfiguration message contained in another RRCReconfiguration message (or in an |
| | | RRCConnectionReconfiguration message, see TS 36.331 [10]) transmitted on SRB1 |
| | - | an RRCReconfiguration message contained in another RRCReconfiguration message which is contained in |

DLInformationTransferMRDC transmitted on SRB3 (as a response to ULInformationTransferMRDC including an
MCGFailureInformation)

| | |
|---|---|
| | Otherwise, the field is absent |
| PagingRelay | For L2 U2N Relay UE, the field is optionally present, Need N. Otherwise, it is absent. |

### 6.3 RRC Information Elements

### 6.3.2 Radio Resource Control Information Elements

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element

| -- ASN1START | | | |
|---|---|---|---|
| -- TAG-CELLGROUPCONFIG-START | | | |
| -- Configuration of one Cell-Group: | | | |
| CellGroupConfig ::= | SEQUENCE { | | |
| cellGroupID | CellGroupId, | | |
| rlc-BearerToAddModList | SEQUENCE (SIZE(1..maxLC-ID)) OF RLC-BearerConfig | OPTIONAL, | -- Need N |
| rlc-BearerToReleaseList | SEQUENCE (SIZE(1..maxLC-ID)) OF LogicalChannelIdentity | OPTIONAL, | -- Need N |
| mac-CellGroupConfig | MAC-CellGroupConfig | OPTIONAL, | -- Need M |
| physicalCellGroupConfig | PhysicalCellGroupConfig | OPTIONAL, | -- Need M |
| spCellConfig | SpCellConfig | OPTIONAL, | -- Need M |
| sCellToAddModList | SEQUENCE (SIZE (1..maxNrofSCells)) OF SCellConfig | | |
| sCellToReleaseList | SEQUENCE (SIZE (1..maxNrofSCells)) OF SCellIndex | | |
| ..., | | | |
| [[ | | | |
| reportUplinkTxDirectCurrent | ENUMERATED {true} | OPTIONAL, | -- Cond BWP- |
| Reconfig | | | |
| ]], | | | |
| [[ | | | |
| bap-Address-r16 | BIT STRING (SIZE (10)) | OPTIONAL, | -- Need M |
| bh-RLC-ChannelToAddModList-r16 | SEQUENCE (SIZE(1..maxBH-RLC-ChannelID-r16)) OF BH-RLC-ChannelConfig-r16 | OPTIONAL, | -- Need N |
| bh-RLC-ChannelToReleaseList-r16 | SEQUENCE (SIZE(1..maxBH-RLC-ChannelID-r16)) OF BH-RLC-ChannelID-r16 | OPTIONAL, | -- Need N |
| flc-TransferPath-r16 | ENUMERATED {lte, nr, both} | OPTIONAL, | -- Need M |
| simultaneousTCI-UpdateList1-r16 | SEQUENCE (SIZE (1..maxNrofServingCellsTCI-r16)) OF ServCellIndex | OPTIONAL, | -- Need R |
| simultaneousTCI-UpdateList2-r16 | SEQUENCE (SIZE (1..maxNrofServingCellsTCI-r16)) OF ServCellIndex | OPTIONAL, | -- Need R |
| simultaneousSpatial-UpdatedList1-r16 | SEQUENCE (SIZE (1..maxNrofServingCellsTCI-r16)) OF ServCellIndex | OPTIONAL, | -- Need R |
| simultaneousSpatial-UpdatedList2-r16 | SEQUENCE (SIZE (1..maxNrofServingCellsTCI-r16)) OF ServCellIndex | OPTIONAL, | -- Need R |
| uplinkTxSwitchingOption-r16 | ENUMERATED {switchedUL, dualUL} | OPTIONAL, | -- Need R |
| uplinkTxSwitchingPowerBoosting-r16 | ENUMERATED {enabled} | OPTIONAL, | -- Need R |
| ]], | | | |
| [[ | | | |
| reportUplinkTxDirectCurrentTwoCarrier-r16 | ENUMERATED {true} | OPTIONAL, | -- Need N |
| ]], | | | |
| [[ | | | |
| flc-TransferPathNRDC-r17 | ENUMERATED {mcg, scg, both} | OPTIONAL, | -- Need M |
| uplinkTxSwitching-2T-Mode-r17 | ENUMERATED {enabled} | OPTIONAL, | -- Cond 2Tx |
| uplinkTxSwitching-DualUL-TxState-r17 | ENUMERATED {oneT, twoT} | OPTIONAL, | -- Cond 2Tx |
| uu-RelayRLC-ChannelToAddModList-r17 | SEQUENCE (SIZE (1..maxUu-RelayRLC-ChannelID-r17)) OF Uu-RelayRLC-ChannelConfig-r17 | | |
| uu-RelayRLC-ChannelToReleaseList-r17 | | OPTIONAL, | -- Need N |
| uu-RelayRLC-ChannelToReleaseList-r17 | SEQUENCE (SIZE (1..maxUu-RelayRLC-ChannelID-r17)) OF Uu-RelayRLC-ChannelConfig-r17 | | |
| | | OPTIONAL, | -- Need N |
| simultaneousU-TCI-UpdateList1-r17 | SEQUENCE (SIZE (1..maxNrofServingCellsTCI-r16)) OF ServCellIndex | OPTIONAL, | -- Need R |
| simultaneousU-TCI-UpdateList2-r17 | SEQUENCE (SIZE (1..maxNrofServingCellsTCI-r16)) OF ServCellIndex | OPTIONAL, | -- Need R |
| simultaneousU-TCI-UpdateList3-r17 | SEQUENCE (SIZE (1..maxNrofServingCellsTCI-r16)) OF ServCellIndex | OPTIONAL, | -- Need R |
| simultaneousU-TCI-UpdateList4-r17 | SEQUENCE (SIZE (1..maxNrofServingCellsTCI-r16)) OF ServCellIndex | OPTIONAL, | -- Need R |
| rlc-BearerToReleaseListExt-r17 | SEQUENCE (SIZE (1..maxLC-ID)) OF LogicalChannelIdentityExt-r17 | OPTIONAL, | -- Need N |
| iab-ResourceConfigToAddModList-r17 SEQUENCE (SIZE(1..maxNrofIABResourceConfig-r17)) OF IAB-ResourceConfig-r17)) OF IAB-ResourceConfig-r17 | | OPTIONAL, | -- Need N |
| iab-ResourceConfigToReleaseList-r17 SEQUENCE (SIZE(1..maxNrofIABResourceConfig-r17)) OF IAB-ResourceConfig-r17)) OF IAB-ResourceConfigID-r17 | | OPTIONAL, | -- Need N |
| ]], | | | |
| [[ | | | |
| reportUplinkTxDirectCurrentMoreCarrier-r17 | ReportUplinkTxDirectCurrentMoreCarrier-r17 | OPTIONAL, | -- Need N |
| ]]] | | | |
| -- Serving cell specific MAC and PHY parameters for a SpCell: | | | |
| SpCellConfig ::= | SEQUENCE { | | |
| servCellIndex | ServCellIndex | OPTIONAL, | -- Cond SCG |
| reconfigurationWithSync | ReconfigurationWithSync | OPTIONAL, | -- Cond ReconfWithSync |
| rlf-TimersAndConstants | SetupRelease { RLF-TimersAndConstants } | OPTIONAL, | -- Need M |
| rlmInSyncOutOfSyncThreshold | ENUMERATED {n1} | OPTIONAL, | -- Need S |
| spCellConfigDedicated | ServingCellConfig | OPTIONAL, | -- Need M |
| ..., | | | |
| [[ | | | |
| lowMobilityEvaluationConnected-r17 | SEQUENCE { | | |
| s-SearchDeltaP-Connected-r17 | ENUMERATED {dB3, dB6, dB9, dB12, dB15, spare3, spare2, spare1}, | | |
| t-SearchDeltaP-Connected-r17 | ENUMERATED {s5, s10, s20, s30, s60, s120, s180, s240, s300, spare7, spare6, spare5, | | |
| | spare4, spare3, spare2, spare1} | | |
| } | | OPTIONAL, | -- Need R |
| goodServingCellEvaluationRLM-r17 | GoodServingCellEvaluation-r17 | OPTIONAL, | -- Need R |
| goodServingCellEvaluationBFD-r17 | GoodServingCellEvaluation-r17 | OPTIONAL, | -- Need R |
| deactivatedSCG-Config-r17 | SetupRelease { DeactivatedSCG-Config-r17 } | OPTIONAL, | -- Cond SCG-Opt |
| ]], | | | |
| ltmCellSwitchInfo | SetupRelease { LtmCellSwitchInfo } | OPTIONAL, | -- Need M |
| } | | | |
| ReconfigurationWithSync ::= | SEQUENCE { | | |
| spCellConfigCommon | ServingCellConfigCommon | OPTIONAL, | -- Need M |
| newUE-Identity | RNTI-Value, | | |
| t304 | ENUMERATED {ms50, ms100, ms150, ms200, ms500, ms1000, ms2000, ms10000}, | | |
| rach-ConfigDedicated | CHOICE { | | |
| uplink | RACH-ConfigDedicated, | | |
| supplementaryUplink | RACH-ConfigDedicated | | |
| } | | OPTIONAL, | -- Need N |
| ..., | | | |
| [[ | | | |
| smtc | SSB-MTC | OPTIONAL | -- Need S |
| ]], | | | |
| [[ | | | |
| daps-UplinkPowerConfig-r16 | DAPS-UplinkPowerConfig-r16 | OPTIONAL, | -- Need N |
| ]], | | | |
| [[ | | | |
| sl-PathSwitchConfig-r17 | SL-PathSwitchConfig-r17 | OPTIONAL | -- Cond Direct ToIndirect- |
| PathSwitch | | | |
| ]] | | | |
| } | | | |
| DAPS-UplinkPowerConfig-r16 ::= | SEQUENCE { | | |
| p-DAPS-Source-r16 | P-Max, | | |
| p-DAPS-Target-r16 | P-Max, | | |
| uplinkPowerSharingDAPS-Mode-r16 | ENUMERATED { semi-static-model, semi-static-mode2, dynamic } | | |
| } | | | |
| SCellConfig ::= | SEQUENCE { | | |
| sCellIndex | SCellIndex, | | |
| sCellConfigCommon | ServingCellConfigCommon | OPTIONAL, | -- Cond SCellAdd |
| sCellConfigDedicated | ServingCellConfig | OPTIONAL, | -- Cond SCellAddMod |
| ..., | | | |
| [[ | | | |
| smtc | SSB-MTC | OPTIONAL | -- Need S |
| ]], | | | |
| [[ | | | |
| sCellState-r16 | ENUMERATED {activated} | OPTIONAL, | -- Cond SCellAddSync |
| secondaryDRX-GroupConfig-r16 | ENUMERATED {true} | OPTIONAL, | -- Cond DRX-Config2 |
| ]], | | | |
| [[ | | | |
| preConfGapStatus-r17 | BIT STRING (SIZE (maxNrofGapId-r17)) | OPTIONAL, | -- Cond PreConfigMG |
| goodServingCellEvaluationBFD-r17 | GoodServingCellEvaluation-r17 | OPTIONAL, | -- Need R |
| sCellSIB20-r17 | SetupRelease { SCellSIB20-r17 } | OPTIONAL, | -- Need M |
| ]] | | | |
| } | | | |
| SCellSIB20-r17 ::= OCTET STRING (CONTAINING SystemInformation) | | | |
| DeactivatedSCG-Config-r17 ::= | SEQUENCE { | | |
| bfd-and-RLM-r17 | BOOLEAN, | | |
| ... | | | |
| } | | | |
| GoodServingCellEvaluation-r17 ::= | SEQUENCE { | | |
| offset-r17 | ENUMERATED {db2, db4, db6, db8} | OPTIONAL, | -- Need S |
| } | | | |
| SL-PathSwitchConfig-r17 ::= | SEQUENCE { | | |
| targetRelayUE-Identity-r17 | SL-SourceIdentity-r17, | | |
| t420-r17 | ENUMERATED {ms50, ms100, ms150, ms200, ms500, ms1000, ms2000, ms10000}, | | |
| ... | | | |
| } | | | |
| IAB-ResourceConfig-r17 ::= | SEQUENCE { | | |
| iab-ResourceConfigID-r17 | IAB-ResourceConfigID-r17, | | |
| slotList-r17 | SEQUENCE (SIZE (1..5120)) OF INTEGER (0..5119) | OPTIONAL, | -- Need M |
| periodicitySlotList-r17 | ENUMERATED {ms0p5, ms0p625, ms1, ms1p25, ms2, ms2p5, ms5, ms10, ms20, ms40, ms80, ms160} | | OPTIONAL, |
| -- Need M | | | |
| slotListSubcarrierSpacing-r17 | SubcarrierSpacing | OPTIONAL, | -- Need M |
| ... | | | |
| } | | | |
| IAB-ResourceConfigID-r17 ::= | INTEGER(0..maxNrofIABResourceConfig-1-r17) | | |
| ReportUplinkTxDirectCurrentMoreCarrier-r17::= | SEQUENCE (SIZE(1.. maxSimultaneousBands)) OF IntraBandCC-CombinationReqList-r17 | | |
| IntraBandCC-CombinationReqList-r17::= | SEQUENCE { | | |
| servCellIndexList-r17 | SEQUENCE (SIZE (1.. maxNrofServingCells)) OF ServCellIndex, | | |
| cc-CombinationList-r17 | SEQUENCE (SIZE (1.. maxNrofReqComDC-Location-r17)) OF IntraBandCC-Combination-r17 | | |
| } | | | |
| IntraBandCC-Combination-r17::= | SEQUENCE (SIZE (1.. maxNrofServingCells)) OF CC-State-r17 | | |
| CC-State-r17::= | SEQUENCE { | | |
| dlCarrier-r17 | CarrierState-r17 | OPTIONAL, | -- Need N |
| ulCarrier-r17 | CarrierState-r17 | OPTIONAL, | -- Need N |
| } | | | |
| CarrierState-r17::= | CHOICE { | | |
| deActivated-r17 | NULL, | | |
| activeBWP-r17 | INTEGER (0..maxNrofBWPs) | | |
| } | | | |
| LtmCellSwitchInfo-r18 ::= | SEQUENCE { | | |
| spCellConfigCommon | ServingCellConfigCommon | OPTIONAL, | -- Need M |
| newUE-Identity | RNTI-Value, | | |
| rach-ConfigDedicated | CHOICE { | | |
| uplink | RACH-ConfigDedicated, | | |
| supplementaryUplink | RACH-ConfigDedicated | | |
| } | | OPTIONAL, | -- Need N |
| } | | | |
| TAG-CELLGROUPCONFIG-STOP | | | |
| ASN1STOP | | | |

CC-State field descriptions
dlCarrier
Indicates DL carrier activation state for this carrier and the related active BWP Index, if activated.
ulCarrier
Indicates UL carrier activation state for this carrier and the related active BWP Index, if activated.
CellGroupConfig field descriptions
bap-Address
BAP address of the parent node in cell group.
bh-RLC-ChannelToAddModList
Configuration of the backhaul RLC entities and the corresponding MAC Logical Channels to be added and modified.
bh-RLC-ChannelToReleaseList
List of the backhaul RLC entities and the corresponding MAC Logical Channels to be released.
f1c-TransferPath
The F1-C transfer path that an EN-DC IAB-MT should use for transferring F1-C packets to the IAB-donor-CU. If IAB-MT is configured with lte, IAB-MT can only use LTE leg for
F1-C transfer. If IAB-MT is configured with nr, IAB-MT can only use NR leg for F1-C transfer. If IAB-MT is configured with both, it is up to IAB-MT to select an LTE leg or a NR
leg for F1-C transfer. If the field is not configured, the IAB node uses the NR leg as the default one.
f1c-TransferPathNRDC
The F1-C transfer path that an NR-DC IAB-MT should use for transferring F1-C packets to the IAB-donor-CU. If IAB-MT is configured with mcg, IAB-MT can only use the MCG
for F1-C transfer. If IAB-MT is configured with scg, IAB-MT can only use the SCG for F1-C transfer. If IAB-MT is configured with both, it is up to IAB-MT to select the MCG or
the SCG for F1-C transfer.
ItmCellSwitchInfo
This field contains necessary information for the UE to execute an LTM cell switch procedure in case this cell is a LTM target cell.
mac-CellGroupConfig
MAC parameters applicable for the entire cell group.
rlc-BearerToAddModList
Configuration of the MAC Logical Channel, the corresponding RLC entities and association with radio bearers.
reportUplinkTxDirectCurrent
Enables reporting of uplink and supplementary uplink Direct Current location information upon BWP configuration and reconfiguration. This field is only present when the BWP
configuration is modified or any serving cell is added or removed. This field is absent in the IE CellGroupConfig when provided as part of RRCSetup message. If UE is
configured with SUL carrier, UE reports both UL and SUL Direct Current locations.
reportUplinkTxDirectCurrentMoreCarrier
Enables reporting of uplink Direct Current location information when the UE is configured with intra-band CA. This field is absent in the IE CellGroupConfig when provided as
part of RRCSetup message. The UE only reports the uplink Direct Current location information that are related to the indicated cc-CombinationList. The network does not
include carriers which locate in DL only spectrum described in TS 38.101-2 [39], clause 5.3A.4 and defined by Fsd according to Table 5.3A.4-3 in FR2 in the IntraBandCC-
CombinationReqList. I.e. DL-only carrier in FR2 frequency spectrum is not used to calculate the default DC location.
reportUplinkTxDirectCurrentTwoCarrier
Enables reporting of uplink Direct Current location information when the UE is configured with uplink intra-band CA with two carriers. This field is absent in the IE
CellGroupConfig when provided as part of RRCSetup message.
rlc-BearerToReleaseListExt
List of the RLC entities and the corresponding MAC Logical Channels to be released for multicast MRBs.
rlmInSyncOutOfSyncThreshold
BLER threshold pair index for IS/OOS indication generation, see TS 38.133 [14], table 8.1.1-1. n1 corresponds to the value 1. When the field is absent, the UE applies the
value 0. Whenever this is reconfigured, UE resets N310 and N311, and stops T310, if running. Network does not include this field.
sCellSIB20
This field is used to transfer SIB20 of the SCell in order to allow the UE for MBS broadcast reception on SCell. The network configures this field only for a single SCell at a
time.
sCellState
Indicates whether the SCell shall be considered to be in activated state upon SCell configuration. If the field is included for an SCell configured with TRS for fast activation of
the SCell, such TRS is not used for the corresponding SCell.
sCellToAddModList
List of secondary serving cells (SCells) to be added or modified.
sCellToReleaseList
List of secondary serving cells (SCells) to be released.
secondaryDRX-GroupConfig
The field is used to indicate whether the SCell belongs to the secondary DRX group. All serving cells in the secondary DRX group shall belong to one Frequency Range and all
serving cells in the legacy DRX group shall belong to another Frequency Range.
simultaneousSpatial-UpdatedList1, simultaneousSpatial-UpdatedList2
List of serving cells which can be updated simultaneously for spatial relation with a MAC CE. The simultaneousSpatial-UpdatedList1 and simultaneousSpatial-UpdatedList2
shall not contain same serving cells. Network should not configure serving cells that are configured with a BWP with two different values for the coresetPoolIndex in these lists.
simultaneousTCI-UpdateList1, simultaneousTCI-UpdateList2
List of serving cells which can be updated simultaneously for TCI relation with a MAC CE. The simultaneousTCI-UpdateList1 and simultaneous TCI-UpdateList2 shall not
contain same serving cells. Network should not configure serving cells that are configured with a BWP with two different values for the coresetPoolIndex in these lists.
simultaneousU-TCI-UpdateList1, simultaneousU-TCI-UpdateList2, simultaneousU-TCI-UpdateList3, simultaneousU-TCI-UpdateList4
List of serving cells for which the Unified TCI States Activation/Deactivation MAC CE applies simultaneously, as specified in TS 38.321 [3] clause 6.1.3.47. The different lists
shall not contain same serving cells. Network only configures in these lists serving cells that are configured with unifiedTCI-State Type.
spCellConfig
Parameters for the SpCell of this cell group (PCell of MCG or PSCell of SCG).
uplinkTxSwitchingOption
Indicates which option is configured for dynamic UL Tx switching for inter-band UL CA or (NG)EN-DC. The field is set to switchedUL if network configures option 1 as specified
in TS 38.214 [19], or dualUL if network configures option 2 as specified in TS 38.214 [19]. Network always configures UE with a value for this field in inter-band UL CA case
and (NG)EN-DC case where UE supports dynamic UL Tx switching.
uplinkTxSwitchingPowerBoosting
Indicates whether the UE is allowed to enable 3dB boosting on the maximum output power for transmission on carrier2 under the operation state in which 2-port transmission
can be supported on carrier2 for inter-band UL CA case with dynamic UL Tx switching as defined in TS 38.101-1 [15]. Network can only configure this field for dynamic UL Tx
switching in inter-band UL CA case with power Class 3 as defined in TS 38.101-1 [15].
uplinkTxSwitching-2T-Mode
Indicates 2Tx-2Tx switching mode is configured for inter-band UL CA or SUL, in which the switching gap duration for a triggered uplink switching (as specified in TS 38.214
[19]) is equal to the switching time capability value reported for the switching mode.
If this field is absent and uplinkTxSwitching is configured, it is interpreted that 1Tx-2Tx UL Tx switching is configured as specified in TS 38.214 . In this case, there is one
uplink (or one uplink band in case of intra-band) configured with uplinkTxSwitching, on which the maximum number of antenna ports among all configured P-SRS/A-SRS and
activated SP-SRS resources should be 1 and non-codebook based UL MIMO is not configured.
uplinkTxSwitching-DualUL-TxState
Indicates the state of Tx chains if the state of Tx chains after the UL Tx switching is not unique (as specified in TS 38.214 [19]) in case of 2Tx-2Tx switching is configured and
uplinkTxSwitchingOption is set to dualUL. Value oneT indicates 1Tx is assumed to be supported on the carriers on each band, value twoT indicates 2Tx is assumed to be
supported on that carrier.
uu-RelayRLC-ChannelToAddModList
List of the Uu RLC entities and the corresponding MAC Logical Channels to be added or modified.
uu-RelayRLC-ChannelToReleaseList
List of the Uu RLC entities and the corresponding MAC Logical Channels to be released.
DeactivatedSCG-Config field descriptions
bfd-and-RLM
If the field is set to true, the UE shall perform RLM and BFD on the PSCell when the SCG is deactivated and the network ensures that beamFailure-r17 is not configured in the
radioLinkMonitoringConfig of the DL BWP of the PSCell in which the UE performs BFD. If set to false, the UE is not required to perform RLM and BFD on the PSCell when the
SCG is deactivated.
DAPS-UplinkPowerConfig field descriptions
p-DAPS-Source
The maximum total transmit power to be used by the UE in the source cell group during DAPS handover.
p-DAPS-Target
The maximum total transmit power to be used by the UE in the target cell group during DAPS handover.
uplinkPowerSharingDAPS-Mode
Indicates the uplink power sharing mode that the UE uses in DAPS handover (see TS 38.213 [13]).
GoodServingCellEvaluation field descriptions
offset
The parameter “X” (dB) for the good serving cell quality criterion in RRC_CONNECTED, for a cell operating in FR1 and FR2, respectively. If this field is absent, the UE applies
the (default) value of 0 dB for “X”.
IAB-ResourceConfig field descriptions
iab-ResourceConfigID
This ID is used to indicate the specific resource configuration addressed by the MAC CEs specified in TS 38.321 [3].
periodicitySlotList
Indicates the periodicity in ms of the list of slot indexes indicated in slotList.
slotList
Indicates the list of slot indexes to which the information indicated in the specific MAC CE applies to, as specified in TS 38.321 [3]. The values of the entries in the slotList are
strictly less than the value of the periodicitySlotList.
slotListSubcarrierSpacing
Subcarrier spacing used as reference for the slotList configuration.
Only the following values are applicable depending on the used frequency:
FR1: 15 or 30 kHz
FR2-1: 60 or 120 kHz
FR2-2: 120 or 480 kHz
ReconfigurationWithSync field descriptions
rach-ConfigDedicated
Random access configuration to be used for the reconfiguration with sync (e.g. handover). The UE performs the RA according to these parameters in the firstActiveUplinkBWP
(see UplinkConfig).
smtc
The SSB periodicity/offset/duration configuration of target cell for NR PSCell change and NR PCell change. The network sets the periodicityAndOffset to indicate the same
periodicity as ssb-periodicityServingCell in spCellConfigCommon or sets to the same periodicity as ssb-Periodicity-r17 in nonCellDefiningSSB-r17 if the first active DL BWP
included in this RRC message is configured with nonCellDefiningSSB-r17 for RedCap.
For case of NR PCell change, the smtc is based on the timing reference of (source) PCell. For case of NR PSCell change, it is based on the timing reference of source PSCell.
If both this field and targetCellSMTC-SCG are absent, the UE uses the SMTC in the measObjectNR having the same SSB frequency and subcarrier spacing, as configured
before the reception of the RRC message. For a RedCap UE, if the first active DL BWP included in this RRC message is configured with nonCellDefiningSSB-r17, this field
corresponds to the NCD-SSB indicated by nonCellDefiningSSB-r17, otherwise, this field corresponds to the CD-SSB indicated by absoluteFrequencySSB in frequencyInfoDL.
ReportUplinkTxDirectCurrentMoreCarrier field descriptions
IntraBandCC-Combination
Indicates the state of the carriers and BWPs indexes of the carriers in a CC combination, each carrier in this combination corresponds to an entry in servCellIndexList with
same order. This IE shall have the same size as servCellIndexList.
IntraBandCC-CombinationReqList
Indicates the list of the requested carriers/BWPs combinations for an intra-band CA component.
servCellIndexList
indicates the list of cell index for an intra-band CA component.
SCellConfig field descriptions
goodServingCellEvaluationBFD
Indicates the criterion for a UE to detect the good serving cell quality for BFD relaxation in an SCell in RRC_CONNECTED. This field is always configured when the network
enables BFD relaxation for the UE in this SCell. This field is absent if failureDetectionSetN is present for the SCell.
preConfGapStatus
Indicates whether the pre-configured measurement gaps (i.e. the gaps configured with preConfigInd) are activated or deactivated while this SCell is deactivated. If this field is
configured, the UE shall apply network-controlled mechanism for activation and deactivation of the pre-configured measurement gaps, otherwise the UE shall apply the
autonomous activation/deactivation mechanism, as specified in TS 38.133 . The first/leftmost bit corresponds to the measurement gap with gap ID 1, the second bit
corresponds to measurement gap with gap ID 2, and so on. Value 0 indicates that the corresponding pre-configured measurement gap is deactivated while value 1 indicates
that the corresponding pre-configured measurement gap is activated. The UE shall ignore the bit if the corresponding measurement gap is not a pre-configured measurement
gap.
smtc
The SSB periodicity/offset/duration configuration of target cell for NR SCell addition. The network sets the periodicityAndOffset to indicate the same periodicity as ssb-
periodicityServingCell in sCellConfigCommon. The smtc is based on the timing of the SpCell of associated cell group. In case of inter-RAT handover to NR, the timing
reference is the NR PCell. In case of intra-NR PCell change (standalone NR) or NR PSCell change (EN-DC), the timing reference is the target SpCell. If the field is absent, the
UE uses the SMTC in the measObjectNR having the same SSB frequency and subcarrier spacing, as configured before the reception of the RRC message.
SpCellConfig field descriptions
deactivatedSCG-Config
Configuration applicable when the SCG is deactivated. The network always configures this field before or when indicating that the SCG is deactivated in an
RRCReconfiguration, RRCResume, E-UTRA RRCConnectionReconfiguration or E-UTRA RRCConnectionResume message.
goodServingCellEvaluationBFD
Indicates the criterion for a UE to detect the good serving cell quality for BFD relaxation in the SpCell in RRC_CONNECTED. The field is always configured when the network
enables BFD relaxation for the UE in this SpCell. This field is absent if failureDetectionSetN is present for the SpCell.
goodServingCellEvaluationRLM
Indicates the criterion for a UE to detect the good serving cell quality for RLM relaxation in the SpCell in RRC_CONNECTED. The field is always configured when the network
enables RLM relaxation for the UE in this SpCell.
lowMobilityEvaluationConnected
Indicates the criterion for a UE to detect low mobility in RRC_CONNECTED in an SpCell. The s-SearchDeltaP-Connected is the parameter “S_{SearchDeltaP-connected}”. Value dB3
corresponds to 3 dB, dB6 corresponds to 6 dB and so on. The t-SearchDeltaP-Connected is the parameter “T_{SearchDeltaP-Connected}”. Value s5 means 5 seconds, value s10 means
10 seconds and so on. Low mobility criterion is configured in NR PCell for the case of NR SA/ NR CA/ NE-DC/NR-DC, and in the NR PSCell for the case of EN-DC.
reconfigurationWithSync
Parameters for the synchronous reconfiguration to the target SpCell.
rlf-TimersAndConstants
Timers and constants for detecting and triggering cell-level radio link failure. For the SCG, rlf-TimersAndConstants can only be set to setup and is always included at SCG
addition.
servCellIndex
Serving cell ID of a PSCell. The PCell of the Master Cell Group uses ID = 0.
SL-PathSwitchConfig field descriptions
targetRelayUE-Identity
Indicates the L2 source ID of the target L2 U2N Relay UE during path switch.
T420
Indicates the timer value of T420 to be used during path switch.

| Conditional Presence | Explanation | |
|---|---|---|
| 2Tx | The field is optionally present, Need R, if uplinkTxSwitching is configured; otherwise it is absent, Need R. | |
| BWP-Reconfig | The field is optionally present, Need N, if the BWPs are reconfigured or if serving cells are added or removed. Otherwise it is | |
| | absent. | |
| DirectToIndirect-PathSwitch | The field is mandatory present for the L2 U2N remote UE at path switch to the target L2 U2N Relay UE. It is absent | |
| | otherwise. | |
| DRX-Config2 | The field is optionally present, Need N, if drx-ConfigSecondaryGroup is configured. It is absent otherwise. | |
| PreConfigMG | The field is optionally present, Need R, if there is at least one per UE gap configured with preConfigInd or there is at least | |
| | one per FR gap of the same FR which the SCell belongs to and configured with preConfigInd. It is absent, Need R, | |
| | otherwise. | |
| ReconfWithSync | The field is mandatory present in the RRCReconfiguration message: | |
| | - | in each configured CellGroupConfig for which the SpCell changes, |
| | - | in the masterCellGroup: |

| | |
|---|---|
| - | at change of AS security key derived from K_{gNB}, |
| - | in an RRCReconfiguration message contained in a DLInformationTransferMRDC message, |
| - | path switch of L2 U2N remote UE to the target PCell, |
| - | path switch of L2 U2N remote UE to the target L2 U2N Relay UE, |

| | |
|---|---|
| - | in the secondaryCellGroup at: |

| - | PSCell addition, |
|---|---|
| - | SCG resume with NR-DC or (NG)EN-DC, |
| - | update of required SI for PSCell, |
| - | change of AS security key derived from S-K_{gNB} in NR-DC while the UE is configured with at least one radio bearer |
| | with keyToUse set to secondary and that is not released by this RRCReconfiguration message, |
| - | MN handover in (NG)EN-DC. |

| | |
|---|---|
| | Otherwise, it is optionally present, need M. The field is absent in the masterCellGroup in RRCResume and RRCSetup |
| | messages and is absent in the masterCellGroup in RRCReconfiguration messages if source configuration is not released |
| | during DAPS handover. The field is also absent in the masterCellGroup and secondaryCellGroup if the CellGroupConfig IE |
| | is included within ltm-CandidateConfig. |
| SCellAdd | The field is mandatory present upon SCell addition; otherwise it is absent, Need M. |
| SCellAddMod | The field is mandatory present upon SCell addition; otherwise it is optionally present, need M. |
| SCellAddSync | The field is optionally present, Need N: |

| | |
|---|---|
| - | in the masterCellGroup at |

| | |
|---|---|
| - | SCell addition, |
| - | reconfiguration with sync, |
| - | resume of an RRC connection. |

| | |
|---|---|
| - | in the secondaryCellGroup, when the SCG is not indicated as deactivated at: |

| | |
|---|---|
| - | SCG activation while the SCG was previously deactivated, |
| - | SCell addition, |
| - | reconfiguration with sync. |

| | |
|---|---|
| | It is absent otherwise. |
| SCG | The field is mandatory present in an SpCellConfig for the PSCell. It is absent otherwise. |
| SCG-Opt | The field is optionally present, Need M, in an SpCellConfig for the PSCell. It is absent otherwise. |

NOTE:
In case of change of AS security key derived from S-K_{gNB}/S-K_{eNB}, if reconfigurationWithSync is not included in the masterCellGroup, the network releases all existing MCG RLC bearers associated with a radio bearer with keyToUse set to secondary. In case of change of AS security key derived from K_{gNB}/K_{eNB}, if reconfigurationWithSync is not included in the secondaryCellGroup, the network releases all existing SCG RLC bearers associated with a radio bearer with keyToUse set to primary.

The IE LTM-CandidateConfig is used to provide LTM candidate cell configuration.

```
LTM-CandidateConfig information element
-- ASN1START
-- TAG-LTM-CANDIDATECONFIG-START
LTM-CandidateConfig-r18 ::= SEQUENCE {
  lte-ReferenceConfiguration-r18 OCTET STRING (CONTAINING RRCReconfiguration) , OPTIONAL, -- Cond FirstLTM-
Candidate
  ltm-CandidateToReleaseList-r18 LTM-CandidateToReleaseList-r18 OPTIONAL, -- Need N
  ltm-CandidateToAddModList-r18 LTM-CandidateToAddModList-r18 OPTIONAL, -- Need N
  ltm-CandidateResetL2-List-r18 SetupRelease { LTM-CandidateResetL2-List-r18 } OPTIONAL -- Need M
  ...
}
LTM-CandidateToReleaseList-r18 ::= SEQUENCE (SIZE (1..maxNrofCellsLTM-r18) ) OF LTM-CandidateId-r18 OPTIONAL -- Need N
LTM-CandidateToAddModList-r18 ::= SEQUENCE (SIZE (1..maxNrofCellsLTM-r18) ) OF LTM-Candidate-r18
LTM-Candidate-r18 ::= SEQUENCE {
  ltm-CandidateId-r18 LTM-CandidateId-r18,
  ltm-Config-r18 OCTET STRING (CONTAINING RRCReconfiguration) ,
  ltm-ConfigComplete-r18 ENUMERATED { true} OPTIONAL -- Need R
  ...
}
LTM-CandidateResetL2-List-r18 ::= SEQUENCE (SIZE (1..maxNrofCellsLTM-r18) ) OF LTM-CandidateId-r18
Editor's Note: FFS on whether the LTM-CandidateNoResetL2-List field should include separate reset flags for MAC, RLC, and PDCP recovery.
-- TAG-LTM-CANDIDATECONFIG-STOP
-- ASN1STOP
```

LTM-CandidateConfig field descriptions
ltm-Config
This field includes an RRCReconfiguration message used to configure an LTM candidate cell. This field shall include the CellGroupConfig IE,
and it may also include the RadioBearerConfig IE, and MeasConfig IE.
ltm-ConfigComplete
This field indicates whether the LTM candidate cell configuration within ltm-Config is a complete configuration and thus the UE shall not use
the LTM reference configuration within the field lte-ReferenceConfiguration.
Itm-CandidateNoResetL2-List
This field includes a list of LTM candidate cell identifiers for which the full L2 reset is needed upon an LTM cell switch.
ltm-ReferenceConfiguration
This field includes an RRCReconfiguration message used to configure a reference configuration for LTM.

| Conditional Presence | Explanation |
|---|---|
| FirstLTM-Candidate | This field is mandatory present upon the first configuration of LTM-CandidateConfig. Otherwise, the field is optionally |
| | present, Need M. |

### 6.4 RRC Multiplicity and Type Constraint Values

- Multiplicity and type constraint definitions
-- ASN1START
-- TAG-MULTIPLICITY-AND-TYPE-CONSTRAINT-DEFINITIONS-START

| | | |
|---|---|---|
| maxAdditionalRACH-r17 | INTEGER ::= 256 | -- Maximum number of additional RACH configurations. |
| maxAI-DCI-PayloadSize-r16 | INTEGER ::= 128 | -- Maximum size of the DCI payload scrambled with ai-RNTI |
| maxAI-DCI-PayloadSize-1-r16 | INTEGER ::= 127 | -- Maximum size of the DCI payload scrambled with ai-RNTI minus 1 |
| maxBandComb | INTEGER ::= 65536 | -- Maximum number of DL band combinations |
| maxBandsUTRA-FDD-r16 | INTEGER ::= 64 | -- Maximum number of bands listed in UTRA-FDD UE caps |
| maxBH-RLC-ChannelID-r16 | INTEGER ::= 65536 | -- Maximum value of BH RLC Channel ID |
| maxBT-IdReport-r16 | INTEGER ::= 32 | -- Maximum number of Bluetooth IDs to report |
| maxBT-Name-r16 | INTEGER ::= 4 | -- Maximum number of Bluetooth name |
| maxCAG-Cell-r16 | INTEGER ::= 16 | -- Maximum number of NR CAG cell ranges in SIB3, SIB4 |
| maxTwoPUCCH-Grp-ConfigList-r16 | INTEGER ::= 32 | -- Maximum number of supported configuration (s) of {primary |
| | | -- PUCCH group config, secondary PUCCH group config} |
| maxTwoPUCCH-Grp-ConfigList-r17 | INTEGER ::= 16 | -- Maximum number of supported configuration (s) of {primary PUCCH |
| | | -- group config, secondary PUCCH group config} for PUCCH cell |
| | | switching |
| maxCBR-Config-r16 | INTEGER ::= 8 | -- Maximum number of CBR range configurations for sidelink |
| | | -- communication congestion control |
| maxCBR-Config-1-r16 | INTEGER ::= 7 | -- Maximum number of CBR range configurations for sidelink |
| | | --communication congestion control minus 1 |
| maxCBR-Level-r16 | INTEGER ::= 16 | -- Maximum number of CBR levels |
| maxCBR-Level-1-r16 | INTEGER ::= 15 | -- Maximum number of CBR levels minus 1 |
| maxCellExcluded | INTEGER ::= 16 | -- Maximum number of NR exclude-listed cell ranges in SIB3, SIB4 |
| maxCellGroupings-r16 | INTEGER ::= 32 | -- Maximum number of cell groupings for NR-DC |
| maxCellHistory-r16 | INTEGER ::= 16 | -- Maximum number of visited PCells reported |
| maxPSCellHistory-r17 | INTEGER ::= 16 | -- Maximum number of visited PSCells across all reported PCells |
| maxCellInter | INTEGER ::= 16 | -- Maximum number of inter-Freq cells listed in SIB4 |
| maxCellIntra | INTEGER ::= 16 | -- Maximum number of intra-Freq cells listed in SIB3 |
| maxCellMeasEUTRA | INTEGER ::= 32 | -- Maximum number of cells in E-UTRAN |
| maxCellMeasIdle-r16 | INTEGER ::= 8 | -- Maximum number of cells per carrier for idle/inactive measurements |
| maxCellMeasUTRA-FDD-r16 | INTEGER ::= 32 | -- Maximum number of cells in FDD UTRAN |
| maxCellNTN-r17 | INTEGER ::= 4 | -- Maximum number of NTN neighbour cells for which assistance |
| | | -- information is provided |
| maxCarrierTypePairList-r16 | INTEGER ::= 16 | -- Maximum number of supported carrier type pair of (carrier type on |
| | | -- which CSI measurement is performed, carrier type on which CSI |
| | | -- reporting is performed) for CSI reporting cross PUCCH group |
| maxCellAllowed | INTEGER ::= 16 | -- Maximum number of NR allow-listed cell ranges in SIB3, SIB4 |
| maxEARFCN | INTEGER ::= 262143 | -- Maximum value of E-UTRA carrier frequency |
| maxEUTRA-CellExcluded | INTEGER ::= 16 | -- Maximum number of E-UTRA exclude-listed physical cell |
| | | -- identity ranges in SIB5 |
| maxEUTRA-NS-Pmax | INTEGER ::= 8 | -- Maximum number of NS and P-Max values per band |
| maxFeatureCombPreamblesPerRACHResource- | INTEGER ::= 256 | -- Maximum number of feature combination preambles. |
| r17 | | |
| max LogMeasReport-r16 | INTEGER ::= 520 | -- Maximum number of entries for logged measurements |
| maxMultiBands | INTEGER ::= 8 | -- Maximum number of additional frequency bands that a cell belongs to |
| maxNARFCN | INTEGER ::= 3279165 | -- Maximum value of NR carrier frequency |
| maxNR-NS-Pmax | INTEGER ::= 8 | -- Maximum number of NS and P-Max values per band |
| maxFreqIdle-r16 | INTEGER ::= 8 | -- Maximum number of carrier frequencies for idle/inactive measurements |
| maxNrofServingCells | INTEGER ::= 32 | -- Max number of serving cells (SpCells + SCells) |
| maxNrofServingCells-1 | INTEGER ::= 31 | -- Max number of serving cells (SpCells + SCells) minus 1 |
| maxNrofAggregatedCellsPerCellGroup | INTEGER ::= 16 | |
| maxNrofAggregatedCellsPerCellGroupMinus4- | INTEGER ::= 12 | |
| r16 | | |
| maxNrofDUCells-r16 | INTEGER ::= 512 | -- Max number of cells configured on the collocated IAB-DU |
| maxNrofAppLayerMeas-r17 | INTEGER ::= 16 | -- Max number of simultaneous application layer measurements |
| maxNrofAppLayerMeas-1-r17 | INTEGER ::= 15 | -- Max number of simultaneous application layer measurements minus 1 |
| maxNrofAvailabilityCombinationsPerSet-r16 | INTEGER ::= 512 | -- Max number of AvailabilityCombinationId used in the DCI format 2_5 |
| maxNrofAvailabilityCombinationsPerSet-1-r16 | INTEGER ::= 511 | -- Max number of AvailabilityCombinationId used in the DCI format 2_5 |
| | | minus 1 |
| maxNrofIABResourceConfig-r17 | INTEGER ::= 65536 | -- Max number of IAB-ResourceConfigID used in MAC CE |
| maxNrofIABResourceConfig-1-r17 | INTEGER ::= 65535 | -- Max number of IAB-ResourceConfigID used in MAC CE minus 1 |
| maxNrofSCellActRS-r17 | INTEGER ::= 255 | -- Max number of RS configurations per SCell for SCell activation |
| maxNrofSCells | INTEGER ::= 31 | -- Max number of secondary serving cells per cell group |
| maxNrofCellMeas | INTEGER ::= 32 | -- Maximum number of entries in each of the cell lists in a |
| | | measurement object |
| maxNrofCRS-IM-InterfCell-r17 | INTEGER ::= 8 | -- Maximum number of LTE interference cells for CRS-IM per UE |
| maxNrofRelayMeas-r17 | INTEGER ::= 32 | -- Maximum number of L2 U2N Relay UEs to measure for each |
| | | -- measurement object on sidelink frequency |
| maxNrofCG-SL-r16 | INTEGER ::= 8 | -- Max number of sidelink configured grant |
| maxNrofCG-SL-1-r16 | INTEGER ::= 7 | -- Max number of sidelink configured grant minus 1 |
| maxSL-GC-BC-DRX-QoS-r17 | INTEGER ::= 16 | -- Max number of sidelink DRX configurations for NR |
| | | -- sidelink groupcast/broadcast communication |
| maxNrofSL-RxInfoSet-r17 | INTEGER ::= 4 | -- Max number of sidelink DRX configuration sets in sidelink |
| | | -- DRX assistant information |
| maxNrofSS-BlocksToAverage | INTEGER ::= 16 | -- Max number for the (max) number of SS blocks to |
| | | average to determine cell measurement |
| maxNrofCondCells-r16 | INTEGER ::= 8 | -- Max number of conditional candidate SpCells |
| maxNrofCondCells-1-r17 | INTEGER ::= 7 | -- Max number of conditional candidate SpCells minus 1 |
| maxNrofCSI-RS-ResourcesToAverage | INTEGER ::= 16 | -- Max number for the (max) number of CSI-RS to average to |
| | | determine cell measurement |
| maxNrofDL-Allocations | INTEGER ::= 16 | -- Maximum number of PDSCH time domain resource allocations |
| maxNrofDL-AllocationsExt-r17 | INTEGER ::= 64 | -- Maximum number of PDSCH time domain resource allocations for |
| | | --multi-PDSCH scheduling |
| maxNrofPDU-Sessions-r17 | INTEGER ::= 256 | -- Maximum number of PDU Sessions |
| maxNrofSR-ConfigPerCellGroup | INTEGER ::= 8 | -- Maximum number of SR configurations per cell group |
| maxLCG-ID | INTEGER ::= 7 | -- Maximum value of LCG ID |
| maxLCG-ID-IAB-r17 | INTEGER ::= 255 | -- Maximum value of LCG ID for IAB-MT |
| maxLC-ID | INTEGER ::= 32 | -- Maximum value of Logical Channel ID |
| maxLC-ID-Iab-r16 | INTEGER ::= 65855 | -- Maximum value of BH Logical Channel ID extension |
| maxLTE-CRS-Patterns-r16 | INTEGER ::= 3 | -- Maximum number of additional LTE CRS rate matching patterns |
| maxNrofTAGs | INTEGER ::= 4 | -- Maximum number of Timing Advance Groups |
| maxNrofTAGs-1 | INTEGER ::= 3 | -- Maximum number of Timing Advance Groups minus 1 |
| maxNrofBWPs | INTEGER ::= 4 | -- Maximum number of BWPs per serving cell |
| maxNrofCombIDC | INTEGER ::= 128 | -- Maximum number of reported MR-DC combinations for IDC |
| maxNrofSymbols-1 | INTEGER ::= 13 | -- Maximum index identifying a symbol within a slot |
| | | (14 symbols, indexed from 0..13) |
| maxNrofSlots | INTEGER ::= 320 | -- Maximum number of slots in a 10 ms period |
| maxNrofSlots-1 | INTEGER ::= 319 | -- Maximum number of slots in a 10 ms period minus 1 |
| maxNrofPhysicalResourceBlocks | INTEGER ::= 275 | -- Maximum number of PRBs |
| maxNrofPhysicalResourceBlocks-1 | INTEGER ::= 274 | -- Maximum number of PRBs minus 1 |
| maxNrofPhysicalResourceBlocksPlus1 | INTEGER ::= 276 | -- Maximum number of PRBs plus 1 |
| maxNrofControlResourceSets | INTEGER ::= 12 | -- Max number of CoReSets configurable on a serving cell |
| maxNrofControlResourceSets-1 | INTEGER ::= 11 | -- Max number of CoReSets configurable on a serving cell minus 1 |
| maxNrofControlResourceSets-1-r16 | INTEGER ::= 15 | -- Max number of CoReSets configurable on a serving cell extended |
| | | in minus 1 |
| maxNrofCoresetPools-r16 | INTEGER ::= 2 | -- Maximum number of CORESET pools |
| maxCoReSetDuration | INTEGER ::= 3 | -- Max number of OFDM symbols in a control resource set |
| maxNrofSearch Spaces-1 | INTEGER ::= 39 | -- Max number of Search Spaces minus 1 |
| maxNrofSearch SpacesLinks-1-r17 | INTEGER ::= 39 | -- Max number of Search Space links minus 1 |
| maxNrofBFDResourcePerSet-r17 | INTEGER ::= 64 | -- Max number of reference signal in one BFD set |
| maxSFI-DCI-PayloadSize | INTEGER ::= 128 | -- Max number payload of a DCI scrambled with SFI-RNTI |
| maxSFI-DCI-PayloadSize-1 | INTEGER ::= 127 | -- Max number payload of a DCI scrambled with SFI-RNTI minus 1 |
| maxIAB-IP-Address-r16 | INTEGER ::= 32 | -- Max number of assigned IP addresses |
| maxINT-DCI-PayloadSize | INTEGER ::= 126 | -- Max number payload of a DCI scrambled with INT-RNTI |
| maxINT-DCI-PayloadSize-1 | INTEGER ::= 125 | -- Max number payload of a DCI scrambled with INT-RNTI minus 1 |
| maxNrofRateMatchPatterns | INTEGER ::= 4 | -- Max number of rate matching patterns that may be configured |
| maxNrofRateMatchPatterns-1 | INTEGER ::= 3 | -- Max number of rate matching patterns that may be configured minus 1 |
| maxNrofRateMatchPatternsPerGroup | INTEGER ::= 8 | -- Max number of rate matching patterns that may be configured |
| | | in one group |
| maxNrofCSI-ReportConfigurations | INTEGER ::= 48 | -- Maximum number of report configurations |
| maxNrofCSI-ReportConfigurations-1 | INTEGER ::= 47 | -- Maximum number of report configurations minus 1 |
| maxNrofCSI-ResourceConfigurations | INTEGER ::= 112 | -- Maximum number of resource configurations |
| maxNrofCSI-ResourceConfigurations-1 | INTEGER ::= 111 | -- Maximum number of resource configurations minus 1 |
| maxNrofAP-CSI-RS-ResourcesPerSet | INTEGER ::= 16 | |
| maxNrOfCSI-AperiodicTriggers | INTEGER ::= 128 | -- Maximum number of triggers for aperiodic CSI reporting |
| maxNrofReport ConfigPerAperiodicTrigger | INTEGER ::= 16 | -- Maximum number of report configurations per trigger state for aperiodic |
| | | reporting |
| maxNrofNZP-CSI-RS-Resources | INTEGER ::= 192 | -- Maximum number of Non-Zero-Power (NZP) CSI-RS resources |
| maxNrofNZP-CSI-RS-Resources-1 | INTEGER ::= 191 | -- Maximum number of Non-Zero-Power (NZP) CSI-RS resources minus 1 |
| maxNrofNZP-CSI-RS-ResourcesPerSet | INTEGER ::= 64 | -- Maximum number of NZP CSI-RS resources per resource set |
| maxNrofNZP-CSI-RS-ResourceSets | INTEGER ::= 64 | |
| maxNrofNZP-CSI-RS-ResourceSets-1 | INTEGER ::= 63 | -- Maximum number of NZP CSI-RS resource sets per cell minus 1 |
| maxNrofNZP-CSI-RS-ResourceSetsPerConfig | INTEGER ::= 16 | -- Maximum number of resource sets per resource configuration |
| maxNrofNZP-CSI-RS-ResourcesPerConfig | INTEGER ::= 128 | -- Maximum number of resources per resource configuration |
| maxNrofZP-CSI-RS-Resources | INTEGER ::= 32 | -- Maximum number of Zero-Power (ZP) CSI-RS resources |
| maxNrofZP-CSI-RS-Resources-1 | INTEGER ::= 31 | -- Maximum number of Zero-Power (ZP) CSI-RS resources minus 1 |
| maxNrofZP-CSI-RS-ResourceSets-1 | INTEGER ::= 15 | |
| maxNrofZP-CSI-RS-ResourcesPerSet | INTEGER ::= 16 | |
| maxNrofZP-CSI-RS-ResourceSets | INTEGER ::= 16 | |
| maxNrofCSI-IM-Resources | INTEGER ::= 32 | -- Maximum number of CSI-IM resources |
| maxNrofCSI-IM-Resources-1 | INTEGER ::= 31 | -- Maximum number of CSI-IM resources minus 1 |
| maxNrofCSI-IM-ResourcesPerSet | INTEGER ::= 8 | -- Maximum number of CSI-IM resources per set |
| maxNrofCSI-IM-ResourceSets | INTEGER ::= 64 | -- Maximum number of NZP CSI-IM resource sets per cell |
| maxNrofCSI-IM-ResourceSets-1 | INTEGER ::= 63 | -- Maximum number of NZP CSI-IM resource sets per cell minus 1 |
| maxNrofCSI-IM-ResourceSetsPerConfig | INTEGER ::= 16 | -- Maximum number of CSI IM resource sets per resource configuration |
| maxNrofCSI-SSB-ResourcePerSet | INTEGER ::= 64 | -- Maximum number of SSB resources in a resource set |
| maxNrofCSI-SSB-ResourceSets | INTEGER ::= 64 | -- Maximum number of CSI SSB resource sets per cell |
| maxNrofCSI-SSB-ResourceSets-1 | INTEGER ::= 63 | -- Maximum number of CSI SSB resource sets per cell minus 1 |
| maxNrofCSI-SSB-ResourceSetsPerConfig | INTEGER ::= 1 | -- Maximum number of CSI SSB resource sets per resource configuration |
| maxNrofCSI-SSB-ResourceSetsPerConfigExt | INTEGER ::= 2 | -- Maximum number of CSI SSB resource sets per resource configuration |
| | | -- extended |
| maxNrofFailureDetectionResources | INTEGER ::= 10 | -- Maximum number of failure detection resources |
| maxNrofFailureDetectionResources-1 | INTEGER ::= 9 | -- Maximum number of failure detection resources minus 1 |
| maxNrofFailureDetectionResources-1-r17 | INTEGER ::= 63 | -- Maximum number of the enhanced failure detection resources minus 1 |
| maxNrofFreqSL-r16 | INTEGER ::= 8 | -- Maximum number of carrier frequency for NR sidelink communication |
| maxNrofSL-BWPs-r16 | INTEGER ::= 4 | -- Maximum number of BWP for NR sidelink communication |
| maxFreqSL-EUTRA-r16 | INTEGER ::= 8 | -- Maximum number of EUTRA anchor carrier frequency for NR |
| | | sidelink communication |
| maxNrofSL-MeasId-r16 | INTEGER ::= 64 | -- Maximum number of sidelink measurement identity (RSRP) |
| | | per destination |
| maxNrofSL-ObjectId-r16 | INTEGER ::= 64 | -- Maximum number of sidelink measurement objects (RSRP) |
| | | per destination |
| maxNrofSL-ReportConfigId-r16 | INTEGER ::= 64 | -- Maximum number of sidelink measurement reporting configuration |
| | | (RSRP) per destination |
| maxNrofSL-PoolToMeasureNR-r16 | INTEGER ::= 8 | -- Maximum number of resource pool for NR sidelink measurement |
| | | -- to measure for each measurement object (for CBR) |
| maxFreqSL-NR-r16 | INTEGER ::= 8 | -- Maximum number of NR anchor carrier frequency for NR sidelink |
| | | communication |
| maxNrofSL-QFIs-r16 | INTEGER ::= 2048 | -- Maximum number of QoS flow for NR sidelink communication per UE |
| maxNrofSL-QFIsPerDest-r16 | INTEGER ::= 64 | -- Maximum number of QoS flow per destination for NR sidelink |
| | | communication |
| maxNrofObject Id | INTEGER ::= 64 | -- Maximum number of measurement objects |
| maxNrofPageRec | INTEGER ::= 32 | -- Maximum number of page records |
| maxNrofPCI-Ranges | INTEGER ::= 8 | -- Maximum number of PCI ranges |
| maxPLMN | INTEGER ::= 12 | -- Maximum number of PLMNs broadcast and reported by UE |
| | | at establishment |
| maxTAC-r17 | INTEGER ::= 12 | -- Maximum number of Tracking Area Codes to which a cell belongs to |
| maxNrofCSI-RS-ResourcesRRM | INTEGER ::= 96 | -- Maximum number of CSI-RS resources per cell for an RRM |
| | | measurement object |
| maxNrofCSI-RS-ResourcesRRM-1 | INTEGER ::= 95 | -- Maximum number of CSI-RS resources per cell for an RRM |
| | | -- measurement object minus 1. |
| maxNrofMeasId | INTEGER ::= 64 | -- Maximum number of configured measurements |
| maxNrofQuantityConfig | INTEGER ::= 2 | -- Maximum number of quantity configurations |
| maxNrofCSI-RS-CellsRRM | INTEGER ::= 96 | -- Maximum number of cells with CSI-RS resources for an RRM |
| | | measurement object |
| maxNrofSL-Dest-r16 | INTEGER ::= 32 | -- Maximum number of destination for NR sidelink communication and |
| | | discovery |
| maxNrofSL-Dest-1-r16 | INTEGER ::= 31 | -- Highest index of destination for NR sidelink communication |
| | | and discovery |
| maxNrofSLRB-r16 | INTEGER ::= 512 | -- Maximum number of radio bearer for NR sidelink communication per UE |
| maxSL-LCID-r16 | INTEGER ::= 512 | -- Maximum number of RLC bearer for NR sidelink communication per UE |
| maxSL-SyncConfig-r16 | INTEGER ::= 16 | -- Maximum number of sidelink Sync configurations |
| maxNrofRXPool-r16 | INTEGER ::= 16 | -- Maximum number of Rx resource pool for NR sidelink communication |
| | | -- and discovery |
| maxNrofTXPool-r16 | INTEGER ::= 8 | -- Maximum number of Tx resource pool for NR sidelink communication |
| | | -- and discovery |
| maxNrofPoolID-r16 | INTEGER ::= 16 | -- Maximum index of resource pool for NR sidelink communication and |
| | | -- discovery |
| maxNrofSRS-PathlossReferenceRS-r16 | INTEGER ::= 64 | -- Maximum number of RSs used as pathloss reference for SRS |
| | | power control. |
| maxNrofSRS-PathlossReferenceRS-1-r16 | INTEGER ::= 63 | -- Maximum number of RSs used as pathloss reference for SRS |
| | | -- power control minus 1. |
| maxNrofSRS-ResourceSets | INTEGER ::= 16 | -- Maximum number of SRS resource sets in a BWP. |
| maxNrofSRS-ResourceSets-1 | INTEGER ::= 15 | -- Maximum number of SRS resource sets in a BWP minus 1. |
| maxNrofSRS-PosResourceSets-r16 | INTEGER ::= 16 | -- Maximum number of SRS Positioning resource sets in a BWP. |
| maxNrofSRS-PosResourceSets-1-r16 | INTEGER ::= 15 | -- Maximum number of SRS Positioning resource sets in a BWP minus 1. |
| maxNrofSRS-Resources | INTEGER ::= 64 | -- Maximum number of SRS resources. |
| maxNrofSRS-Resources-1 | INTEGER ::= 63 | -- Maximum number of SRS resources minus 1. |
| maxNrofSRS-PosResources-r16 | INTEGER ::= 64 | -- Maximum number of SRS Positioning resources. |
| maxNrofSRS-PosResources-1-r16 | INTEGER ::= 63 | -- Maximum number of SRS Positioning resources minus 1. |
| maxNrofSRS-ResourcesPerSet | INTEGER ::= 16 | -- Maximum number of SRS resources in an SRS resource set |
| maxNrofSRS-TriggerStates-1 | INTEGER ::= 3 | -- Maximum number of SRS trigger states minus 1, i.e., the |
| | | largest code point. |
| maxNrofSRS-TriggerStates-2 | INTEGER ::= 2 | -- Maximum number of SRS trigger states minus 2. |
| maxRAT-CapabilityContainers | INTEGER ::= 8 | -- Maximum number of interworking RAT containers (incl NR and MRDC) |
| max SimultaneousBands | INTEGER ::= 32 | -- Maximum number of simultaneously aggregated bands |
| maxULTxSwitchingBandPairs | INTEGER ::= 32 | -- Maximum number of band pairs supporting dynamic UL Tx switching |
| | | -- in a band combination. |
| maxNrofSlotFormat CombinationsPerSet | INTEGER ::= 512 | -- Maximum number of Slot Format Combinations in a SF-Set. |
| maxNrofSlotFormatCombinationsPerSet-1 | INTEGER ::= 511 | -- Maximum number of Slot Format Combinations in a SF-Set minus 1. |
| maxNrofTrafficPattern-r16 | INTEGER ::= 8 | -- Maximum number of Traffic Pattern for NR sidelink communication. |
| maxNrofPUCCH-Resources | INTEGER ::= 128 | |
| maxNrofPUCCH-Resources-1 | INTEGER ::= 127 | |
| maxNrofPUCCH-ResourceSets | INTEGER ::= 4 | -- Maximum number of PUCCH Resource Sets |
| maxNrofPUCCH-ResourceSets-1 | INTEGER ::= 3 | -- Maximum number of PUCCH Resource Sets minus 1. |
| maxNrofPUCCH-ResourcesPerSet | INTEGER ::= 32 | -- Maximum number of PUCCH Resources per PUCCH-ResourceSet |
| maxNrofPUCCH-P0-PerSet | INTEGER ::= 8 | -- Maximum number of P0-pucch present in a p0-pucch set |
| maxNrofPUCCH-PathlossReferenceRSs | INTEGER ::= 4 | -- Maximum number of RSs used as pathloss reference for PUCCH |
| | | power control. |
| maxNrofPUCCH-PathlossReferenceRSs-1 | INTEGER ::= 3 | -- Maximum number of RSs used as pathloss reference for PUCCH |
| | | -- power control minus 1. |
| maxNrofPUCCH-PathlossReferenceRSs-r16 | INTEGER ::= 64 | -- Maximum number of RSs used as pathloss reference for PUCCH |
| | | -- power control extended. |
| maxNrofPUCCH-PathlossReferenceRSs-1-r16 | INTEGER ::= 63 | -- Maximum number of RSs used as pathloss reference for PUCCH |
| | | -- power control minus 1 extended. |
| maxNrofPUCCH-PathlossReferenceRSs-1-r17 | INTEGER ::= 7 | -- Maximum number of RSs used as pathloss reference for PUCCH |
| | | -- power control minus 1. |
| maxNrofPUCCH-PathlossReferenceRSsDiff-r16 | INTEGER ::= 60 | -- Difference between the extended maximum and the non-extended |
| | | maximum |
| maxNrofPUCCH-ResourceGroups-r16 | INTEGER ::= 4 | -- Maximum number of PUCCH resources groups. |
| maxNrofPUCCH-ResourcesPerGroup-r16 | INTEGER ::= 128 | -- Maximum number of PUCCH resources in a PUCCH group. |
| maxNrofPowerControlSet Infos-r17 | INTEGER ::= 8 | -- Maximum number of PUCCH power control set infos |
| maxNrofMultiplePUSCHs-r16 | INTEGER ::= 8 | -- Maximum number of multiple PUSCHs in PUSCH TDRA list |
| maxNrofP0-PUSCH-AlphaSets | INTEGER ::= 30 | -- Maximum number of P0-pusch-alpha-sets (see TS 38.213 [13], |
| | | clause 7.1) |
| maxNrofP0-PUSCH-AlphaSets-1 | INTEGER ::= 29 | -- Maximum number of P0-pusch-alpha-sets minus 1 (see TS 38.213 [13], |
| | | clause 7.1) |
| maxNrofPUSCH-PathlossReferenceRSs | INTEGER ::= 4 | -- Maximum number of RSs used as pathloss reference for PUSCH |
| | | power control. |
| maxNrofPUSCH-PathlossReferenceRSs-1 | INTEGER ::= 3 | -- Maximum number of RSs used as pathloss reference for PUSCH |
| | | -- power control minus 1. |
| maxNrofPUSCH-PathlossReferenceRSs-r16 | INTEGER ::= 64 | -- Maximum number of RSs used as pathloss reference for PUSCH |
| | | -- power control extended |
| maxNrofPUSCH-PathlossReferenceRSs-1-r16 | INTEGER ::= 63 | -- Maximum number of RSs used as pathloss reference for PUSCH |
| | | -- power control extended minus 1 |
| maxNrofPUSCH-PathlossReferenceRSsDiff-r16 | INTEGER ::= 60 | -- Difference between maxNrofPUSCH-PathlossReferenceRSs-r16 and |
| | | -- maxNrofPUSCH-PathlossReferenceRSs |
| maxNrofPathlossReferenceRSs-r17 | INTEGER ::= 64 | -- Maximum number of RSs used as pathloss reference for PUSCH, |
| | | -- PUCCH, SRS power control for unified TCI state operation |
| maxNrofPathlossReferenceRSs-1-r17 | INTEGER ::= 63 | -- Maximum number of RSs used as pathloss reference for PUSCH, |
| | | -- PUCCH, SRS power control for unified TCI state operation minus 1 |
| maxNrofNAICS-Entries | INTEGER ::= 8 | -- Maximum number of supported NAICS capability set |
| maxBands | INTEGER ::= 1024 | -- Maximum number of supported bands in UE capability. |
| maxBandsMRDC | INTEGER ::= 1280 | |
| maxBandsEUTRA | INTEGER ::= 256 | |
| maxCellReport | INTEGER ::= 8 | |
| maxDRB | INTEGER ::= 29 | -- Maximum number of DRBs (that can be added in DRB-ToAddModList) . |
| maxFreq | INTEGER ::= 8 | -- Max number of frequencies. |
| maxFreqLayers | INTEGER ::= 4 | -- Max number of frequency layers. |
| maxFreqPlus1 | INTEGER ::= 9 | -- Max number of frequencies for Slicing. |
| maxFreqIDC-r16 | INTEGER ::= 128 | -- Max number of frequencies for IDC indication. |
| maxCombIDC-r16 | INTEGER ::= 128 | -- Max number of reported UL CA for IDC indication. |
| maxFreqIDC-MRDC | INTEGER ::= 32 | -- Maximum number of candidate NR frequencies for |
| | | MR ::=DC IDC indication |
| maxNrofCandidateBeams | INTEGER ::= 16 | -- Max number of PRACH-ResourceDedicatedBFR in BFR config. |
| maxNrofCandidateBeams-r16 | INTEGER ::= 64 | -- Max number of candidate beam resources in BFR config. |
| maxNrofCandidateBeamsExt-r16 | INTEGER ::= 48 | -- Max number of PRACH-ResourceDedicatedBFR in the |
| | | CandidateBeamRSListExt |
| maxNrofPCIsPerSMTC | INTEGER ::= 64 | -- Maximum number of PCIs per SMTC. |
| maxNrofQFIs | INTEGER ::= 64 | |
| maxNrofResourceAvailabilityPerCombination-r16 | INTEGER ::= 256 | |
| maxNrOfSemiPersistentPUSCH-Triggers | INTEGER ::= 64 | -- Maximum number of triggers for semi persistent reporting on PUSCH |
| maxNrofSR-Resources | INTEGER ::= 8 | -- Maximum number of SR resources per BWP in a cell. |
| maxNrofSlotFormatsPerCombination | INTEGER ::= 256 | |
| maxNrofSpatialRelationInfos | INTEGER ::= 8 | |
| maxNrofSpatialRelationInfos-plus-1 | INTEGER ::= 9 | |
| maxNrofSpatialRelationInfos-r16 | INTEGER ::= 64 | |
| maxNrofSpatialRelationInfosDiff-r16 | INTEGER ::= 56 | -- Difference between maxNrofSpatialRelationInfos-r16 and |
| | | maxNrofSpatialRelation Infos |
| maxNrofIndexesToReport | INTEGER ::= 32 | |
| maxNrofIndexesToReport2 | INTEGER ::= 64 | |
| maxNrofSSBs-r16 | INTEGER ::= 64 | -- Maximum number of SSB resources in a resource set. |
| maxNrofSSBs-1 | INTEGER ::= 63 | -- Maximum number of SSB resources in a resource set minus 1. |
| maxNrofS-NSSAI | INTEGER ::= 8 | -- Maximum number of S-NSSAI. |
| maxNrofTCI-StatesPDCCH | INTEGER ::= 64 | |
| maxNrofTCI-States | INTEGER ::= 128 | -- Maximum number of TCI states. |
| maxNrofTCI-States-1 | INTEGER ::= 127 | -- Maximum number of TCI states minus 1. |
| maxUL-TCI-r17 | INTEGER ::= 64 | -- Maximum number of TCI states. |
| maxUL-TCI-1-r17 | INTEGER ::= 63 | -- Maximum number of TCI states minus 1. |
| maxNrofAdditionalPCI-r17 | INTEGER ::= 7 | -- Maximum number of additional PCI |
| maxMPE-Resources-r17 | INTEGER ::= 64 | -- Maximum number of pooled MPE resources |
| maxNrofUL-Allocations | INTEGER ::= 16 | -- Maximum number of PUSCH time domain resource allocations. |
| maxQFI | INTEGER ::= 63 | |
| maxRA-CSIRS-Resources | INTEGER ::= 96 | |
| maxRA-OccasionsPerCSIRS | INTEGER ::= 64 | -- Maximum number of RA occasions for one CSI-RS |
| maxRA-Occasions-1 | INTEGER ::= 511 | -- Maximum number of RA occasions in the system |
| maxRA-SSB-Resources | INTEGER ::= 64 | |
| maxSCSs | INTEGER ::= 5 | |
| maxSecondaryCellGroups | INTEGER ::= 3 | |
| maxNrofServingCellsEUTRA | INTEGER ::= 32 | |
| maxMBSFN-Allocations | INTEGER ::= 8 | |
| maxNrofMultiBands | INTEGER ::= 8 | |
| maxCellSFTD | INTEGER ::= 3 | -- Maximum number of cells for SFTD reporting |
| maxReportConfigId | INTEGER ::= 64 | |
| maxNrofCodebooks | INTEGER ::= 16 | -- Maximum number of codebooks supported by the UE |
| maxNrofCSI-RS-ResourcesExt-r16 | INTEGER ::= 16 | -- Maximum number of codebook resources supported by the |
| | | UE for eType2/Codebook |
| maxNrofCSI-RS-ResourcesExt-r17 | INTEGER ::= 8 | -- Maximum number of codebook resources for fetype2R1 and fetype2R2 |
| maxNrofCSI-RS-Resources | INTEGER ::= 7 | -- Maximum number of codebook resources supported by the UE |
| maxNrofCSI-RS-ResourcesAlt-r16 | INTEGER ::= 512 | -- Maximum number of alternative codebook resources supported |
| | | by the UE |
| maxNrofCSI-RS-ResourcesAlt-1-r16 | INTEGER ::= 511 | -- Maximum number of alternative codebook resources supported |
| | | by the UE minus |
| maxNrofSRI-PUSCH-Mappings | INTEGER ::= 16 | |
| maxNrofSRI-PUSCH-Mappings-1 | INTEGER ::= 15 | |
| maxSIB | INTEGER ::= 32 | -- Maximum number of SIBs |
| maxSI-Message | INTEGER ::= 32 | -- Maximum number of SI messages |
| maxSIB-MessagePlus1-r17 | INTEGER ::= 33 | -- Maximum number of SIB messages plus 1 |
| maxP0-perPF | INTEGER ::= 4 | -- Maximum number of paging occasion per paging frame |
| maxPEI-perPF-r17 | INTEGER ::= 4 | -- Maximum number of PEI occasion per paging frame |
| maxAccessCat-1 | INTEGER ::= 63 | -- Maximum number of Access Categories minus 1 |
| maxBarring InfoSet | INTEGER ::= 8 | -- Maximum number of access control parameter sets |
| maxCellEUTRA | INTEGER ::= 8 | -- Maximum number of E-UTRA cells in SIB list |
| maxEUTRA-Carrier | INTEGER ::= 8 | -- Maximum number of E-UTRA carriers in SIB list |
| maxPLMNIdentities | INTEGER ::= 8 | -- Maximum number of PLMN identities in RAN area configurations |
| maxDownlinkFeatureSets | INTEGER ::= 1024 | -- (for NR DL) Total number of FeatureSets (size of the pool) |
| maxUplinkFeatureSets | INTEGER ::= 1024 | -- (for NR UL) Total number of FeatureSets (size of the pool) |
| maxEUTRA-DL-FeatureSets | INTEGER ::= 256 | -- (for E-UTRA) Total number of FeatureSets (size of the pool) |
| maxEUTRA-UL-FeatureSets | INTEGER ::= 256 | -- (for E-UTRA) Total number of FeatureSets (size of the pool) |
| maxFeatureSetsPerBand | INTEGER ::= 128 | -- (for NR) The number of feature sets associated with one band. |
| maxPerCC-FeatureSets | INTEGER ::= 1024 | -- (for NR) Total number of CC-specific FeatureSets (size of the pool) |
| maxFeatureSet Combinations | INTEGER ::= 1024 | -- (for MR-DC/NR) Total number of Feature set combinations |
| | | (size of the pool) |
| maxInterRAT-RSTD-Freq | INTEGER ::= 3 | |
| maxGIN-r17 | INTEGER ::= 24 | -- Maximum number of broadcast GINs |
| maxHRNN-Len-r16 | INTEGER ::= 48 | -- Maximum length of HRNNs |
| maxNPN-r16 | INTEGER ::= 12 | -- Maximum number of NPNs broadcast and reported by UE at |
| | | establishment |
| maxNrOfMinSchedulingOffsetValues-r16 | INTEGER ::= 2 | -- Maximum number of min. scheduling offset (K0/K2) configurations |
| maxK0-SchedulingOffset-r16 | INTEGER ::= 16 | -- Maximum number of slots configured as min. scheduling offset (K0) |
| maxK2-SchedulingOffset-r16 | INTEGER ::= 16 | -- Maximum number of slots configured as min. scheduling offset (K2) |
| maxK0-SchedulingOffset-r17 | INTEGER ::= 64 | -- Maximum number of slots configured as min. scheduling offset (K0) |
| maxK2-SchedulingOffset-r17 | INTEGER ::= 64 | -- Maximum number of slots configured as min. scheduling offset (K2) |
| maxDCI-2-6-Size-r16 | INTEGER ::= 140 | -- Maximum size of DCI format 2-6 |
| maxDCI-2-7-Size-r17 | INTEGER ::= 43 | -- Maximum size of DCI format 2-7 |
| maxDCI-2-6-Size-1-r16 | INTEGER ::= 139 | -- Maximum DCI format 2-6 size minus 1 |
| maxNrofUL-Allocations-r16 | INTEGER ::= 64 | -- Maximum number of PUSCH time domain resource allocations |
| maxNrofP0-PUSCH-Set-r16 | INTEGER ::= 2 | -- Maximum number of P0 PUSCH set (s) |
| maxOnDemandSIB-r16 | INTEGER ::= 8 | -- Maximum number of SIB (s) that can be requested on-demand |
| maxOnDemandPosSIB-r16 | INTEGER ::= 32 | -- Maximum number of posSIB (s) that can be requested on-demand |
| maxCI-DCI-PayloadSize-r16 | INTEGER ::= 126 | -- Maximum number of the DCI size for CI |
| maxCI-DCI-PayloadSize-1-r16 | INTEGER ::= 125 | -- Maximum number of the DCI size for CI minus 1 |
| maxUu-RelayRLC-ChannelID-r17 | INTEGER ::= 32 | -- Maximum value of Uu Relay RLC channel ID |
| maxWLAN-Id-Report-r16 | INTEGER ::= 32 | -- Maximum number of WLAN IDs to report |
| maxWLAN-Name-r16 | INTEGER ::= 4 | -- Maximum number of WLAN name |
| maxRAReport-r16 | INTEGER ::= 8 | -- Maximum number of RA procedures information to be included in |
| | | the RA report |
| maxTxConfig-r16 | INTEGER ::= 64 | -- Maximum number of sidelink transmission parameters configurations |
| maxTxConfig-1-r16 | INTEGER ::= 63 | -- Maximum number of sidelink transmission parameters configurations |
| | | minus 1 |
| maxPSSCH-TxConfig-r16 | INTEGER ::= 16 | -- Maximum number of PSSCH TX configurations |
| maxNrofCLI-RSSI-Resources-r16 | INTEGER ::= 64 | -- Maximum number of CLI-RSSI resources for UE |
| maxNrofCLI-RSSI-Resources-1-r16 | INTEGER ::= 63 | -- Maximum number of CLI-RSSI resources for UE minus 1 |
| maxNrofCLI-SRS-Resources-r16 | INTEGER ::= 32 | -- Maximum number of SRS resources for CLI measurement for UE |
| maxCLI-Report-r16 | INTEGER ::= 8 | |
| maxNrofCC-Group-r17 | INTEGER ::= 16 | -- Maximum number of CC groups for DC location report |
| maxNrofConfiguredGrantConfig-r16 | INTEGER ::= 12 | -- Maximum number of configured grant configurations per BWP |
| maxNrofConfiguredGrantConfig-1-r16 | INTEGER ::= 11 | -- Maximum number of configured grant configurations per BWP minus 1 |
| maxNrofCG-Type2DeactivationState | INTEGER ::= 16 | -- Maximum number of deactivation state for type 2 configured |
| | | grants per BWP |
| maxNrofConfiguredGrantConfigMAC-1-r16 | INTEGER ::= 31 | -- Maximum number of configured grant configurations per MAC |
| | | entity minus 1 |
| maxNrofSPS-Config-r16 | INTEGER ::= 8 | -- Maximum number of SPS configurations per BWP |
| maxNrofSPS-Config-1-r16 | INTEGER ::= 7 | -- Maximum number of SPS configurations per BWP minus 1 |
| maxNrofSPS-DeactivationState | INTEGER ::= 16 | -- Maximum number of deactivation state for SPS per BWP |
| maxNrofPPW-Config-r17 | INTEGER ::= 4 | -- Maximum number of Preconfigured PRS processing windows |
| | | per DL BWP |
| maxNrofPPW-ID-1-r17 | INTEGER ::= 15 | -- Maximum number of Preconfigured PRS processing windows minus 1 |
| maxNrOfTxTEGReport-r17 | INTEGER ::= 256 | -- Maximum number of UE Tx Timing Error Group Report |
| maxNrOfTxTEG-ID-1-r17 | INTEGER ::= 7 | -- Maximum number of UE Tx Timing Error Group ID minus 1 |
| maxNrofDormancyGroups | INTEGER ::= 5 | |
| maxNrofPagingSubgroups-r17 | INTEGER ::= 8 | -- Maximum number of paging subgroups per paging occasion |
| maxNrofPUCCH-ResourceGroups-1-r16 | INTEGER ::= 3 | |
| maxNrofReqComDC-Location-r17 | INTEGER ::= 128 | -- Maximum number of requested carriers/BWPs combinations |
| | | -- for DC location report |
| maxNrofServingCellsTCI-r16 | INTEGER ::= 32 | -- Maximum number of serving cells in simultaneousTCI-UpdateList |
| maxNrofTxDC-TwoCarrier-r16 | INTEGER ::= 64 | -- Maximum number of UL Tx DC locations reported by the UE |
| | | for 2CC uplink CA |
| maxNrofRB-Set Groups-r17 | INTEGER ::= 8 | -- Maximum number of RB set groups |
| maxNrofRB-Sets-r17 | INTEGER ::= 8 | -- Maximum number of RB sets |
| maxNrofEnhType3HARQ-ACK-r17 | INTEGER ::= 8 | -- Maximum number of enhanced type 3 HARQ-ACK codebook |
| maxNrofEnhType3HARQ-ACK-1-r17 | INTEGER ::= 7 | -- Maximum number of enhanced type 3 HARQ-ACK codebook minus 1 |
| maxNrofPRS-ResourcesPerSet-r17 | INTEGER ::= 64 | -- Maximum number of PRS resources for one set |
| maxNrofPRS-ResourcesPerSet-1-r17 | INTEGER ::= 63 | -- Maximum number of PRS resources for one set minus 1 |
| maxNrofPRS-ResourceOffset Value-1-r17 | INTEGER ::= 511 | |
| maxNrofGapId-r17 | INTEGER ::= 8 | -- Maximum number of measurement gap ID is FFS |
| maxNrofPreConfigPosGapId-r17 | INTEGER ::= 16 | -- Maximum number of preconfigured positioning measurement gap |
| maxNrOfGapPri-r17 | INTEGER ::= 16 | -- Maximum number of gap priority level |
| maxCEFReport-r17 | INTEGER ::= 4 | -- Maximum number of CEF reports by the UE |
| maxNrofMultiplePDSCHs-r17 | INTEGER ::= 8 | -- Maximum number of PDSCHs in PDSCH TDRA list |
| maxSliceInfo-r17 | INTEGER ::= 8 | -- Maximum number of NSAGs |
| maxCellSlice-r17 | INTEGER ::= 16 | -- Maximum number of cells supporting the NSAG |
| maxNrofTRS-ResourceSets-r17 | INTEGER ::= 64 | -- Maximum number of TRS resource sets |
| maxNrofSearch SpaceGroups-1-r17 | INTEGER ::= 2 | -- Maximum number of search space groups minus 1 |
| maxNrofRemoteUE-r17 | INTEGER ::= 32 | -- Maximum number of connected L2 U2N Remote UEs |
| maxDCI-4-2-Size-r17 | INTEGER ::= 140 | -- Maximum size of DCI format 4-2 |
| maxFreqMBS-r17 | INTEGER ::= 16 | -- Maximum number of MBS frequencies reported in |
| | | MBSInterestIndication |
| maxNrofDRX-ConfigPTM-r17 | INTEGER ::= 64 | -- Max number of DRX configuration for PTM provided in MBS |
| | | -- broadcast in a cell |
| maxNrofDRX-ConfigPTM-1-r17 | INTEGER ::= 63 | -- Max number of DRX configuration for PTM provided in MBS |
| | | -- broadcast in a cell minus 1 |
| maxNrofMBS-ServiceListPerUE-r17 | INTEGER ::= 16 | -- Maximum number of services which the UE can include in the |
| | | -- MBS interest indication |
| maxNrofMBS-Session-r17 | INTEGER ::= 1024 | -- Maximum number of MBS sessions provided in MBS broadcast in a cell |
| maxNrofMTCH-SSB-MappingWindow-r17 | INTEGER ::= 16 | -- Maximum number of MTCH to SSB beam mapping pattern |
| maxNrofMTCH-SSB-MappingWindow-1-r17 | INTEGER ::= 15 | -- Maximum number of MTCH to SSB beam mapping pattern minus 1 |
| maxNrofMRB-Broadcast-r17 | INTEGER ::= 4 | -- Maximum number of broadcast MRBs configured for one |
| | | MBS broadcast service |
| maxNrofPageGroup-r17 | INTEGER ::= 32 | -- Maximum number of paging groups in a paging message |
| maxNrofPDSCH-ConfigPTM-r17 | INTEGER ::= 16 | -- Maximum number of PDSCH configuration groups for PTM |
| maxNrofPDSCH-ConfigPTM-1-r17 | INTEGER ::= 15 | -- Maximum number of PDSCH configuration groups for PTM minus 1 |
| maxG-RNTI-r17 | INTEGER ::= 16 | -- Maximum number of G-RNTI that can be configured for a UE. |
| maxG-RNTI-1-r17 | INTEGER ::= 15 | -- Maximum number of G-RNTI that can be configured for a UE minus 1. |
| maxG-CS-RNTI-r17 | INTEGER ::= 8 | -- Maximum number of G-CS-RNTI that can be configured for a UE. |
| maxG-CS-RNTI-1-r17 | INTEGER ::= 7 | -- Maximum number of G-CS-RNTI that can be configured for a |
| | | UE minus 1. |
| maxMRB-r17 | INTEGER ::= 32 | -- Maximum number of multicast MRBs (that can be added |
| | | in MRB-ToAddModLIst) |
| maxFSAI-MBS-r17 | INTEGER ::= 64 | -- Maximum number of MBS frequency selection area identities |
| maxNeighCellMBS-r17 | INTEGER ::= 8 | -- Maximum number of MBS broadcast neighbour cells |
| maxNrofPdcch-BlindDetectionMixed-1-r16 | INTEGER ::= 7 | -- Maximum number of combinations of mixed Rel-16 and Rel-15 |
| | | -- PDCCH monitoring capabilities minus 1 |
| maxNrofPdcch-BlindDetection-r17 | INTEGER ::= 16 | -- Maximum number of combinations of PDCCH blind detection |
| | | -- monitoring capabilities |
| maxNrofCellsLTM-r18 | INTEGER ::= 99999 | -- Maximum number of LTM candidate cells |

-- TAG-MULTIPLICITY-AND-TYPE-CONSTRAINT-DEFINITIONS-STOP
-- ASN1STOP
Editor's note: maxK0-SchedulingOffset and maxK0-SchedulingOffset need confirmation by RAN1.

### 7.4 UE Variables

The IE VarLTM-Config is used to store the reference configuration and the LTM candidate cell configurations.

```
VarLTM-Config UE variable
-- ASN1START
-- TAG-VARLTM-CONFIG-START
VarLTM-Config-r18-IEs ::= SEQUENCE {
  ltm-ReferenceConfiguration-r18  OCTET STRING (CONTAINING RRCReconfiguration),
  ltm-CandidateList-r18  LTM-CandidateList-r18
  ltm-CandidateResetL2-List-r18  LTM-CandidateResetL2-List-r18
}
LTM-CandidateList-r18 ::= SEQUENCE (SIZE (1..maxNrofCellsLTM-r18) ) OF LTM-Candidate-r18
LTM-CandidateResetL2-List-r18 ::= SEQUENCE (SIZE (1..maxNrofCellsLTM-r18) ) OF LTM-Candidate-r18
-- TAG-VARLTM-CONFIG-STOP
-- ASN1STOP
```

The IE VarLTM-UE-Config is used to store the generated UE configuration related to the received LTM candidate cell configurations.

```
VarLTM-UE-Config UE variable
-- ASN1START
-- TAG-VARLTM-CONFIG-START
VarLTM-UE-Config-r18-IEs ::= SEQUENCE {
  Ue-ltm-ConfigCandidateList-r18 UE-LTM-ConfigCandidateList-r18
}
UE-LTM-ConfigCandidateList-r18 ::= SEQUENCE (SIZE (1..maxNrofCellsLTM-r18) ) OF UE-LTM-Config-r18
UE-LTM-Candidate-r18 ::=  SEQUENCE {
  ltm-CandidateId-r18 LTM-CandidateId-r18,
  ue-LTM-Config-r18 OCTET STRING,
}
-- TAG-VARLTM-CONFIG-STOP
```

1. A method performed by a user equipment, UE, for a L1/L2-triggered mobility, LTM, cell switch procedure, the method comprising:
receiving LTM reference configuration and LTM candidate cell configuration;
combining the LTM reference configuration and the LTM candidate cell configuration to obtain a complete LTM candidate cell configuration for a LTM candidate cell;
receiving, from a source network node, a LTM cell switch command, wherein the LTM cell switch command comprise at least an indication of a LTM candidate cell configuration;
applying the complete LTM candidate cell configuration of the indicated LTM candidate cell configuration; and
sending an uplink signalling to acknowledge completion of the LTM cell switch procedure.

2. The method of claim 1, wherein the combining the LTM reference configuration and the LTM candidate cell configuration to obtain a complete LTM candidate cell configuration for a LTM candidate cell, comprises:
generating the complete LTM candidate cell configuration responsive to the reception of one of LTM reference configuration and the at least one LTM candidate cell configuration from the source network node following earlier reception of the other one of the LTM reference configuration and the at least one LTM candidate cell configuration from the source network node.

3. The method of claim 1, wherein the combining the LTM reference configuration and the LTM candidate cell configuration to obtain a complete LTM candidate cell configuration for a LTM candidate cell, comprises:
generating the complete LTM candidate cell configuration responsive to the reception of the LTM cell switch command from the source network node.

4. The method of claim 1, wherein the combining the LTM reference configuration and the LTM candidate cell configuration to obtain a complete LTM candidate cell configuration for a LTM candidate cell, comprises:
applying the LTM candidate cell configuration on top of the LTM reference configuration according to one or more of the following:
performing a set of actions that are common for the LTM reference configuration and the LTM candidate cell configuration;
performing a set of actions that are separate for the LTM reference configuration and the LTM candidate cell configuration; and
performing a set of actions for the LTM reference configuration and/or the LTM candidate cell configuration according to a rule or guideline defining handling of ASN.1 structures, fields, or information elements in the LTM reference configuration and the LTM candidate cell configuration.

5. The method of claim 4, wherein the performing a set of actions for the LTM reference configuration and the LTM candidate cell configuration according to a rule or guideline defining handling of ASN.1 structures, fields, or information elements in the LTM reference configuration and the LTM candidate cell configuration, comprises determining from the rule or guideline at least one of:
an operation to use on a value of the ASN.1 structure, field, or information element in the LTM reference configuration and/or the LTM candidate cell configuration;
an operation to use based on a type of the ASN.1 structure, field, or information element in the LTM reference configuration and/or the LTM candidate cell configuration;
an order in which to perform an operation on a value of the ASN.1 structure, field, or information element in the LTM reference configuration and/or the LTM candidate cell configuration;
an operation to use based on a value of the ASN.1 structure, field, or information element in the LTM reference configuration and/or the LTM candidate cell configuration;
an operation to use based on presence of the ASN.1 structure, field, or information element in the LTM reference configuration and/or the LTM candidate cell configuration; and
an operation to use based on a need code of the ASN.1 structure, field, or information element in the LTM reference configuration and/or the LTM candidate cell configuration.

6. The method of claim 1, further comprising:
preparing a part of the complete LTM candidate cell configuration based on reception of an LTM reference configuration and the LTM candidate cell configuration; and
responsive to the reception of a LTM cell switch command, preparing the complete LTM candidate cell configuration based on the part.

7. The method of claim 1, wherein the combining the LTM reference configuration and the LTM candidate cell configuration to obtain a complete LTM candidate cell configuration for a LTM candidate cell, comprises:
defining the LTM candidate cell configuration as the complete LTM candidate cell configuration.

8. The method of claim 1, after receiving the LTM cell switch command and before applying the complete LTM candidate cell configuration, further comprising at least one of:
copying a timer, a counter, and/or a configuration from a current UE configuration to the complete LTM candidate cell configuration;
clearing in the current UE configuration, a dedicated configuration earlier received through dedicated signaling from the source network node;
clearing in the current UE configuration, a common configuration earlier received through system information from the source network node; and
performing an L2 reset.

9. The method of claim 1, after receiving the LTM cell switch command and before applying the complete LTM candidate cell configuration, further comprising at least one of:
applying a default configuration if a dedicated configuration is not present within the complete LTM candidate cell configuration;
applying the complete LTM candidate cell configuration in a target cell; and
sending the uplink signalling to a target network node to acknowledge the completion of the LTM cell switch procedure.

10. A method performed by a source network node for initiating a L1/L2-triggered mobility, LTM, cell switch procedure at a user equipment, UE, the method comprising:
sending a LTM reference configuration and a LTM candidate cell configuration to the UE; and
sending a LTM cell switch command for initiating a LTM cell switch procedure to the UE, wherein the LTM cell switch command comprises an indication of the LTM candidate cell configuration.

11. The method of claim 10, wherein the LTM candidate cell configuration sent to the UE contains an indication of whether the LTM candidate cell configuration is a complete LTM candidate cell configuration.

12. The method of claim 11, wherein the indication of whether the LTM candidate cell configuration is a complete LTM candidate cell configuration is sent to the UE in a message that is not the same as a message in which the LTM candidate cell configuration is transmitted.

13. A method performed by a target network node for a L1/L2-triggered mobility, LTM, cell switch procedure, the method comprising:
initiating configuration of a LTM candidate cell configuration at a user equipment, UE, through another network node; and
receiving a signalling from the UE which indicates that the LTM cell switch procedure has been successfully completed and that the UE is starting to operate with the target network node according to the LTM candidate cell configuration.

14. The method of claim 13, wherein the LTM candidate cell configuration contains an indication of whether the LTM candidate cell configuration is a complete LTM candidate cell configuration.

15. A user equipment for a L1/L2-triggered mobility, LTM, cell switch procedure, comprising:
processing circuitry configured to perform the steps of claim 1; and
power supply circuitry configured to supply power to the processing circuitry.

16. A source network node for a L1/L2-triggered mobility, LTM, cell switch procedure, the source network node comprising:
processing circuitry configured to perform the steps of claim 10;
power supply circuitry configured to supply power to the processing circuitry.

17. A target network node for a L1/L2-triggered mobility, LTM, cell switch procedure, the target network node comprising:
processing circuitry configured to perform the steps of claim 10;
power supply circuitry configured to supply power to the processing circuitry.

18. A user equipment (UE) for a L1/L2-triggered mobility, LTM, cell switch procedure, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform the steps of claim 1;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
